(19) United States
(12) Patent Application Publication
(10) Pub. No.: US 2026/0316351 A1
(43) Pub. Date: Oct. 15, 2026

(54) OAT COMPOSITE ARTICLE, CORRESPONDING USES, METHOD AND KIT

(71) Applicant: Holzmühle Westerkamp GmbH, Visbek (DE)

(72) Inventors: Arnold WESTERKAMP, Visbek (DE); Ute GOOSSENS, Wildeshausen, DE (US)

(21) Appl. No.: 19/116,635

(22) PCT Filed: Oct. 2, 2023
(86) PCT No.: PCT/EP2023/077275

§ 371 Date: Jan. 14, 2026

(30) Foreign Application Priority Data
Sep. 30, 2022 (DE) 10 2022 125 427.5

(51) Int. Cl. B29C 45/00; B29C 45/14; B29C 45/78; B29K 67/00; B29K 105/12; C08L 67/02

(52) U.S. Cl. CPC B29C 45/0005; B29C 45/14; B29C 45/78; C08L 67/02; B29C 2045/14868; B29C 2945/7604; B29C 2945/76347; B29K 2067/04; B29K 2105/122; B29K 2995/006; C08L 2201/06; C08L 2205/16

(57) ABSTRACT

An oat composite article comprising
polymer material
   and
oat fibers,
   wherein the oat composite article is compostable.

The present invention relates to an oat composite article comprising polymer material and oat fibers. Further details of the oat composite article of the invention will be apparent from the appended patent claims and from the description that follows. The present invention additionally relates to the use of an oat composite article for production of an article. The present invention also relates to the use of oat fibers for production of an oat composite article. The present invention additionally relates to the use of a polymer material for production of an oat composite article. The present invention further relates to a process for producing an oat composite article. The present invention additionally relates to a kit for production of an oat composite article. In each case, the details are apparent from the appended patent claims and the description that follows.

The present invention relates to the technical field of biocomposites. Biocomposites are already known in the prior art.

Document EP 3 176 110 A1 discloses a biomaterial or biocomposite based on sunflower seed hulls/husks, wherein sunflower seed hull/husk material is compounded with polymer material.

Document EP 0 976 790 A1 discloses a process for producing a composite material, in which a material comprising vegetable fibers is subjected to at least one pretreatment step and is then used in at least one thermoplastic process step.

Document U.S. Pat. No. 5,663,221 discloses a process for producing medium-density sheets from sunflower seed hulls.

Document EP 3 720 911 B1 discloses a wood-plastic composite composition comprising: at least one wood component, at least one thermoplastic polymer, wax hydrocarbons, oxidized hydrocarbons consisting of (modified) hydrocarbons having at least one of hydroxyl, carbonyl, carboxylate and lactone groups, wherein the mixture consisting of the wax hydrocarbons and the oxidized hydrocarbons is a wax composition having a defined dynamic viscosity, a defined content of molecules in which the hydrocarbon chain is linear, a defined solidification point according to ASTM D 938, a defined content of oxidized hydrocarbons, a defined acid number according to ASTM D 1386, and wherein wax hydrocarbons are a Fischer-Tropsch wax and the oxidized hydrocarbons derive from an oxidation of a Fischer-Tropsch wax.

Document EP 2 621 979 B1 discloses a biocomposite sheet comprising at least one natural fiber and at least one thermoset biopolymer including a furan resin.

The biocomposites known from the prior art have numerous disadvantages and shortcomings that are regularly perceived as being problematic in the field of the present invention.

In the field of the present invention, there is a great need for biocomposites having properties and combinations of properties that are perceived as being advantageous in the field of the present invention, which are produced with maximum conservation of resources and with the use of a minimum amount of energy. There is a need for biocomposites having ingredients that are produced entirely from renewable raw materials and having properties and/or combinations of properties that are perceived as being advantageous in the field of the present invention.

In many cases, there is a particularly high demand for biocomposites that are biodegradable and compostable according to the criteria of DIN EN 13432:2000-12. In many cases, there is a particular need for biocomposites that are industrially compostable, i.e. meet all the TOV AUSTRIA test criteria for certification with the “OK compost INDUSTRIAL (EN 13432)” label. In many cases, there is also a need for biocomposites in the field of the present invention that are home-compostable, i.e. meet all TOV AUSTRIA test criteria for certification with the “OK compost HOME” label. Also desirable in many cases in the field of the present invention are biocomposites that are biodegradable in aquatic ecosystems. In particular, in the field of the present invention, there is a need for compostable biocomposites in which compostability, in particular home compostability, occurs on a timescale that is neither too short nor too long. In many cases, composting degradation times that are too short are responsible for loss of desired properties in articles produced from biocomposite as early as during their intended use; this is regularly undesirable in the field of the present invention. Excessively long composting degradation times are perceived as being disadvantageous in many cases in the field of the present invention. In particular, excessively long degradation times under the conditions of industrial composting are regularly extremely undesirable in the field of the present invention.

Contamination of the environment with microplastics, i.e. solid, insoluble, particulate and non-biodegradable synthetic polymers in a size range of less than 5 millimeters to 1000 nanometers, is extremely undesirable. There is a need for biocomposites that do not contribute to the pollution of the environment by microplastics when released into the environment.

The biocomposites known from the prior art each have colors that are perceived to be esthetically problematic in many cases in the field of the present invention. There is therefore a particular need for biocomposites with a color that is perceived as being esthetically advantageous, in particular also for biocomposites with an advantageous light color and good printability. It is desirable in the field of the present invention that these properties are achieved without the need for complex processing steps and/or without addition of chemicals to the biocomposites and/or treatment with chemicals that are perceived as being of environmental or climatic concern. In particular, there is a need for biocomposites having an advantageous bright color and good printability, which also have individual, several or all of the above-detailed advantages and properties with regard to compostability.

In the field of the present invention, there is additionally a need for biocomposites that are colored with positive results; in particular, there is a need for biocomposites colored in light colors such as yellow. The coloring of biocomposites with light colors such as yellow is not regularly possible with satisfactory results in the field of the present invention.

There is additionally a need in the prior art for biocomposites that are storable in pelletized form over prolonged periods of time, at least over such periods and under such conditions as are common in the field of plastics processing. The biocomposite pellets known from the prior art tend in many cases to form mold in the course of storage under the customary storage conditions in the field of plastics processing; such mold formation is extremely undesirable in the field of the present invention.

In the field of the present invention, there is a need for biocomposites that do not have an unpleasant intrinsic odor. The biocomposites known from the prior art regularly have an intrinsic odor that is perceived as being unpleasant in the field of the present invention. In particular, there is a need for biocomposites that have an intrinsic odor perceived by humans as pleasant, or have no intrinsic odor perceptible by humans.

The biocomposites known from the prior art regularly have unfavorable properties with regard to the following parameters:
melt mass flow rate determined in accordance with ISO 1133-2,
melt volume flow rate determined in accordance with ISO 1133-2,
density determined in accordance with DIN EN ISO 1183-1,
flexural modulus of elasticity, determined by method A of DIN EN ISO 178:2019 with an initial force of 0.1 MPa and a test speed of 2 mm/min,
tensile strength, determined in accordance with DIN EN ISO 527-2,
tensile elongation determined in accordance with DIN EN ISO 527-2,
flexural stress under conventional deflection, determined by method A of DIN EN ISO 178,
flexural strain at flexural strength, determined by method A of DIN EN ISO 178, and
Charpy impact resistance, determined on the unnotched test specimen, determined in accordance with DIN EN ISO 179-1.

In the biocomposites known from the prior art, the combination of some or all of the above parameters is in particular in many cases not sufficiently positive. There is therefore a need for particularly positive expressions of individual, multiple or all of the above parameters in a single biocomposite.

There is additionally a need for biocomposites that are suitable for the packaging and/or processing of foodstuffs and are approved for corresponding use in the European Union. In particular, there is a need for biocomposites that are suitable for packaging and/or processing of foodstuffs and are approved for corresponding use in the European Union, while at the same time meeting some, preferably all, of the abovementioned requirements, particularly with regard to compostability.

In the case of biocomposites known from the prior art, the production process for the biogenic fibers used for production is regularly so time-consuming and/or apparatus-intensive that this is perceived as being disadvantageous in the field of the present invention. There is therefore a need for biocomposites wherein the fiber content can be provided with low apparatus complexity and time demands. In particular, there is also a need for biocomposites wherein the fiber content is provided in an energy-efficient and resource-conserving manner. In particular, there is a need for biocomposites that have no adverse effects on food production in their extraction from natural resources. In the field of the present invention, the use of biogenic fibers whose production requires utilization of areas of land that are then not simultaneously available for food production is increasingly being considered to be problematic.

The biocomposites known from the prior art are frequently unsuitable for use in the customary plants for plastics processing because, for example, they are insufficiently thermally stable and/or their flowability is not within an acceptable range at the customary temperatures in plants for plastics processing. There is therefore a need in the field of the present invention for biocomposites that can be used in the customary plants for plastics processing. In particular, in the field of the present invention, there is a need for biocomposites that can be processed by injection molding methods and/or by the compression molding method. There is a particular need for biocomposites that are suitable for processing in conventional injection molding systems with no need for any apparatus modifications. There is likewise a particular need for biocomposites that are suitable for processing by customary compression molding for plastics with no need for any apparatus modifications. There is additionally a particular need for biocomposites that are suitable for processing in conventional processes for thermoforming of plastics. There is also a particular need for biocomposites that are suitable for processing to films, in particular films that are suitable as packaging films for foodstuffs.

In the field of the present invention, there is a need for biocomposites which have particularly positive properties with regard to oxygen permeability and/or water vapor permeability. In particular, there is a need for biocomposites that have particularly positive properties in terms of both oxygen permeability and water vapor permeability. There is a very particular need for biocomposites that have particularly positive properties in terms of oxygen permeability and water vapor permeability, and at the same time meet as many of the abovementioned requirements as possible, in particular with regard to compostability.

Additionally apparent from the prior art is a need for production processes for biocomposites that meet as many of the abovementioned requirements as possible without the need to add other substances as well as the fiber component and the polymer component in order to meet the aforementioned requirements. In the field of the present technology, the addition of aggregates is frequently associated with an undesirably high degree of complexity and regularly leads to an undesirably high environmental burden, merely by virtue of the production process, the resulting packaging and the resulting transportation of the aggregates. It is regularly the case that the prior art additionally involves use of aggregates that reduce the compostability and/or food compatibility of the resulting biocomposites. This is extremely undesirable in the field of the present invention.

Further underlying objects of the invention and benefits associated with the invention will be apparent from the description that follows and the appended claims.

The invention is defined in the claims and further elucidated by the description, in which preferred embodiments are also defined.

The present invention relates, in its categories, to a cereal composite article, in particular oat composite article, to use of an oat composite article, to use of oat fibers for production of an oat composite article, to use of a polymer material for production of an oat composite article, to a process for producing an oat composite article and a kit for production of an oat composite article.

Embodiments, aspects or properties that are described or described as preferred in connection with one of these categories are also each applicable correspondingly or analogously to the respective other categories, and vice versa.

Unless stated otherwise, preferred aspects or embodiments of the invention and its various categories may be combined with other aspects or embodiments of the invention and its various categories, in particular with other preferred aspects or embodiments. The combination of preferred aspects or embodiments with one another results in turn in preferred aspects or embodiments of the invention.

In a primary aspect of the present invention, the abovementioned problems are solved and objectives are achieved wholly or partly by an oat composite article comprising
polymer material, preferably biopolymer material,
   and
oat fibers.

The term “biocomposite” in the context of the present text means composite materials comprising natural fibers at least as a first material and, bonded thereto by cohesive means or form-fitting or a combination of the two, polymers as a second material. A biocomposite may also additionally include further materials or substances.

The term “composite material” in the context of the present text means, in accordance with the customary understanding of the skilled person, a material consisting of two or more bonded materials, the two or more bonded materials being bonded to one another by cohesive means or form-fitting or a combination of the two.

The term “cereal composite” in the context of the present text refers to composite materials comprising cereal fibers, in particular oat fibers, at least as a first material and, bonded thereto by cohesive means or form-fitting or a combination of the two, polymers as a second material. Cereal composite may also additionally include further materials or substances. In the context of the present text, the term “cereal composite” is included in the term “biocomposite”.

The term “oat composite” in the context of the present text means composite materials comprising oat fibers at least as a first material and, bonded thereto by cohesive means or form-fitting or a combination of the two, polymers as a second material. Oat composite may also additionally include further materials or substances. In the context of the present text, the term “oat composite” is included in the term “biocomposite”. In the context of the present text, the term “oat composite” is included in the term “cereal composite”.

The term “pelletized cereal composite” in the context of the present text means a multitude of particles consisting of cereal composite, the individual particles of the pelletized cereal composite having an average diameter in the range from a few millimeters to a few centimeters. A pelletized cereal composite is pourable. If the “pelletized cereal composite” is subjected to a drying process after production thereof, the result is a “dried pelletized cereal composite”. A dried pelletized cereal composite is also pourable.

The term “pelletized oat composite” in the context of the present text means a multitude of particles consisting of oat composite, the individual particles of the pelletized oat composite having an average diameter in the range from a few millimeters to a few centimeters. A pelletized oat composite is pourable. If the “pelletized oat composite” is subjected to a drying process after production thereof, the result is a “dried pelletized oat composite”. A dried pelletized oat composite is also pourable.

The term “cereal composite article” in the context of the present invention encompasses the terms “cereal composite”, “pelletized cereal composite”, “dried pelletized cereal composite” and “cereal composite molding”, and also, in particular, the term “oat composite article” and hence the terms “oat composite”, “pelletized oat composite”, “dried pelletized oat composite” and “oat composite molding”.

In the context of the present invention, the “cereal composite article” is more preferably an oat composite article.

In the context of the present invention, the term “oat composite article” includes the terms “oat composite”, “pelletized oat composite”, “dried pelletized oat composite” and “oat composite molding”.

In the context of the present invention, it is particularly preferable in very many cases that an oat composite article, aside from oat fibers, does not include any fibers of other cereal types.

The term “polymer” in the context of the present invention, in accordance with the customary understanding of the skilled person, means a molecule having high relative molecular mass, the structure of which essentially comprises the multiple repetition of molecular units derived conceptually or actually from molecules of lower relative molecular mass. In the context of the present invention, molecules with a high relative molecular mass mean those molecules in which the addition or removal of one of the aforementioned units has no relevant effect on molecular behavior.

The term “biopolymer” in the context of the present invention refers to polymers produced from renewable raw materials.

The term “polymer material” in the context of the present invention means a material consisting essentially of polymer and/or biopolymer.

The term “biopolymer material” in the context of the present invention means a material consisting essentially of biopolymer.

The term “compounding” in the context of the present text means combining, cohesively or by form-fitting or a combination of the two, a polymer material on the one hand and natural fibers on the other hand. In the course of compounding, other substances may also be present as aggregates (e.g. fillers and/or additives).

The term “cereals” refers to the usually annual plants of the family of the sweet grasses (“Poaceae”) and their grains, which are cultivated for their grains; in particular, plants and grains of the husk cereals einkorn, emmer, Kamut, barley, millet, spelt and oats are referred to as cereals in the context of the present invention.

The term “oats” in the context of the present invention refers to plants of the plant genus “Avena” from the family of the “sweet grasses” (“Poaceae”).

The term “cereal fibers” in the context of the present invention refers to fibers that are produced by a comminution process from parts of cereals, in particular the husk cereals einkorn, emmer, Kamut, barley, millet, spelt and/or oats. The term “cereal fibers” in the context of the present invention encompasses the terms “cereal husk fibers” and “cereal hull fibers”, and in particular also the terms “oat husk fibers” and “oat hull fibers”.

The term “oat fibers” in the context of the present invention refers to fibers that are obtained from parts of the oat by a comminution process. The term “oat fibers” in the context of the present invention encompasses the terms “oat husk fibers” and “oat hull fibers”.

The term “cereal husk fibers” in the context of the present text refers to a product consisting predominantly of parts of lemmas (“Palea inferior”) of cereals, in particular oats, and parts of paleas (“Palea superior”) of cereals, in particular oats.

The term “oat husk fibers” in the context of the present text refers to a product consisting predominantly of parts of lemmas (“Palea inferior”) of oats, and parts of paleas (“Palea superior”) of oats.

The term “cereal hull fibers” in the context of the present text refers to a product consisting predominantly of parts of the epidermis, fruit hull, seed hull and aleurone layer of cereals, in particular oats.

The term “oat hull fibers” in the context of the present text refers to a product consisting predominantly of parts of the epidermis, fruit hull, seed hull and aleurone layer of oats.

In many cases, it is preferable when the cereal composite article of the invention, in particular oat composite article, consists exclusively of polymer material and cereal fibers, in particular oat fibers. In other cases, it is likewise preferable when the cereal composite article, in particular oat composite article, contains further substances in addition to the polymer material constituents and cereal fiber, in particular oat fiber, constituents.

In many cases, cereal fibers used are oat fibers, preferably oat husk fibers and/or oat hull fibers, more preferably oat husk fibers and oat hull fibers.

The cereal composite article of the invention, in particular oat composite article, is notable in particular for the advantageous combination of properties with regard to melt mass flow rate, determined in accordance with ISO 1133-2, flexural modulus of elasticity, determined by method A of DIN EN ISO 178:2019 with an initial force of 0.1 MPa and a test speed of 2 mm/min, tensile elongation, determined in accordance with DIN EN ISO 527-2, and Charpy impact resistance, determined on the unnotched test specimen, determined in accordance with DIN EN ISO 179-1.

The present invention, with its various aspects, relates in particular and with preference to an oat composite article (as described above, preferably as described above as preferred), wherein the oat composite article is compostable, preferably industrially compostable and/or home-compostable.

In the field of the present invention, it is regularly particularly preferred that the oat composite article is home-compostable.

What is meant by the oat composite article's being compostable is that it is biodegradable and compostable, according to the criteria of DIN EN 13432:2000-12.

What is meant by the oat composite article's being industrially compostable is that a test specimen of the material of the oat composite article with a maximum wall thickness of 0.5 mm meets all the TOV Austria test criteria for certification with the “OK compost INDUSTRIAL EN 13432” label.

In some cases, it is preferable when oat composite articles that are industrially compostable include polylactides (PLA) as polymer material.

In some cases, it is particularly preferable when oat composite articles that are industrially compostable comprise polylactides (PLA) as the sole polymer material. What is meant by the oat composite article's being home-compostable is that a test specimen of the material of the oat composite article with a maximum wall thickness of 0.5 mm meets all the TOV Austria test criteria for certification with the “OK compost HOME” label.

In some cases, it is preferable when oat composite articles that are home-compostable comprise, as polymer material, polybutylene succinate and/or polybutylene succinate-co-adipate and/or polyhydroxyalkanoate.

In some cases, it is preferable when oat composite articles that are home-compostable comprise polybutylene succinate as the sole polymer material.

In some cases, it is preferable when oat composite articles that are home-compostable comprise polybutylene succinate-co-adipate as the sole polymer material.

In some cases, it is preferable when oat composite articles that are home-compostable comprise polyhydroxyalkanoate as the sole polymer material.

In many cases, it is also particularly preferable when a test specimen of the material of the oat composite article with a maximum wall thickness of 0.5 mm is marine-compostable, which means that it meets all the TOV Austria test criteria for certification with the “OK biodegradable MARINE” label.

In many cases, it is also particularly preferable when a test specimen of the material of the oat composite article with a maximum wall thickness of 0.5 mm meets all the TOV Austria test criteria for certification with the “OK biodegradable SOIL” label.

In many cases, it is also particularly preferable when a test specimen of the material of the oat composite article with a maximum wall thickness of 0.5 mm meets all the TOV Austria test criteria for certification with the “OK biodegradable WATER” label.

Compostability of the oat composite article of the invention requires that the oat composite article contain a compostable polymer material as a polymer material in addition to the oat fibers. The skilled person is aware of such compostable polymer materials, and they will select appropriate compostable polymer materials from the compostable polymer materials known to them independently according to the requirements of the individual case.

Oat composite articles that are compostable, especially oat composite articles that are home-compostable, in many cases do not contribute to contamination of the environment with microplastics when released intentionally and/or unintentionally into the environment.

If a test specimen made of the material of the oat composite article is marine-compostable with a maximum wall thickness of 0.5 mm, these oat composite articles will not contribute to contamination of the environment with microplastics when released intentionally and/or unintentionally into the environment.

The present invention, with its various aspects, relates in particular and with preference to an oat composite article (as described above, preferably as described above as preferred), wherein the oat composite article is recyclable, preferably 100% recyclable.

An oat composite article is recyclable if a recyclate is producible therefrom by recycling, and the latter is capable of equivalent replacement of a virgin product, material or substance in a production process. In particular, an oat composite article is recyclable even when it is usable in an equivalent manner together with virgin material in a production process; in this case, the oat composite article replaces a proportion of virgin material.

An oat composite article is 100% recyclable when a recyclate is producible from 100% by weight of its constituents, and the latter is capable of equivalent replacement of a virgin product, material and/or substance in a production process. In particular, an oat composite article is 100% recyclable even when 100% by weight thereof is usable in an equivalent manner together with virgin material in a production process; in this case, the oat composite article replaces a proportion of virgin material.

In many cases, in the recycling of oat composite articles, it is preferable when around 20% to 30% by weight of oat composite articles are recycled together with pure plastics so as to result in a joint recycled product.

In many cases, preference is given to an oat composite article (as described above, preferably as described above as preferred), wherein the oat composite article is compostable, preferably industrially compostable and/or home-compostable

and
wherein the oat composite article is recyclable, preferably 100% recyclable.

The present invention, with its various aspects, relates in particular and with preference to an oat composite article (as described above, preferably as described above as preferred), wherein the polymer material is selected from the group consisting of:
polyhydroxyalkanoate,
polybutylene succinate,
polybutylene succinate-co-adipate,
natural resins,
starch,
cellulose with a lignin content of less than 5% by weight,
polybutylene adipate terephthalate,
polycaprolactone,
polylactides,
cellulose acetate,
waxes
   and
mixtures thereof;
   the polymer material preferably being selected from the group consisting of:
polyhydroxyalkanoate,
polybutylene succinate,
polybutylene succinate-co-adipate
   and
mixtures thereof;
   the polymer material more preferably being selected from the group consisting of:
polyhydroxyalkanoate,
polybutylene succinate-co-adipate
   and
mixtures thereof;
   the polymer material most preferably being selected from the group consisting of:
polyhydroxyalkanoate
   and
polybutylene succinate-co-adipate.

The most preferred polymer material selected is a polyhydroxyalkanoate.

In many cases, it is particularly preferable when the polymer material selected is a biopolymer material.

With the aforementioned polymer materials, the oat composite articles each have particularly positive properties depending on the needs of the individual case and each constitute particularly advantageous solutions for the aforementioned problems and objectives. In the case of individual polymer materials defined above, the skilled person is aware that they are used in order to achieve particularly positive properties as a mixture with one or more other polymer materials defined above.

In many cases, it is preferable that the oat composite article of the invention comprises polyhydroxyalkanoate, polybutylene succinate or polybutylene succinate-co-adipate as polymer material. In many cases, it is preferable when the oat composite article of the invention comprises a mixture of polyhydroxyalkanoate and polybutylene succinate or a mixture of polyhydroxyalkanoate and polybutylene succinate-co-adipate or a mixture of polybutylene succinate and polybutylene succinate-co-adipate. Depending on the requirements of the individual case, the skilled person will choose whether the abovementioned polymer materials are used individually or in one of the abovementioned combinations. If the skilled person decides to use one of the abovementioned combinations as a polymer material in the oat composite article, they will determine the mixing ratio independently according to the respective requirements of the individual case. In order to select the mixing ratios, the skilled person may conduct simple optimization tests, as is customary in the field of the present invention.

In many cases, the oat composite article has particularly positive properties, in particular a particularly advantageous surface structure, when the polymer material chosen is a mixture comprising, preferably consisting of, polybutylene adipate terephthalate (PBAT) and polylactic acid (PLA).

In many cases, a preferred oat composite article is one having a wall thickness in the range from 0.5 mm to 3 mm, more preferably in the range from 0.7 mm to 2.7 mm, most preferably in the range from 0.8 mm to 2.5 mm.

With the wall thicknesses defined above, in many cases, the effects and benefits elucidated in association with the oat composite article of the invention, especially in each case in combination with good compostability, preferably home compostability, are achieved to a particularly positive degree.

Oat composite articles comprising the polymer materials mentioned have particularly positive properties and combinations of properties with regard to compostability, good printability and a Charpy impact resistance perceived as being advantageous, as determined on the unnotched test specimen according to DIN EN ISO 179-1. In addition, corresponding oat composite articles have a color that is perceived as being particularly advantageous in terms of esthetics. In particular, corresponding oat composite articles have thermal stabilities and flow capabilities that make them suitable for processing in conventional plants for plastics processing, in particular also in injection molding processes and in compression molding processes.

The present invention, with its various aspects, relates in particular and with preference to an oat composite article (as described above, preferably as described above as preferred),
wherein the oat fibers present in the oat composite article have a proportion of lignocellulose in the range from 60% by weight to 90% by weight, preferably in the range from 70% by weight to 88% by weight, more preferably in the range from 75% by weight to 87% by weight, most preferably in the range from 81% by weight to 86% by weight, based in each case on the dry matter of the oat fibers present in the oat composite article,
   and/or, preferably “and”
wherein the oat fibers present in the oat composite article have a proportion of lignin in the range from 10% by weight to 30% by weight, preferably in the range from 11% by weight to 27.5% by weight, more preferably in the range from 12% by weight to 26% by weight, most preferably in the range from 22% by weight to 25% by weight, based in each case on the dry matter of the oat fibers present in the oat composite article,
   and/or, preferably “and”
wherein the oat fibers present in the oat composite article have a proportion of hemicellulose in the range from 20% by weight to 40% by weight, preferably in the range from 22% by weight to 38% by weight, more preferably in the range from 23.5% by weight to 37.0% by weight, most preferably in the range from 31.5% by weight to 36.0% by weight, based in each case on the dry matter of the oat fibers present in the oat composite article,
   and/or, preferably “and”
wherein the hemicellulose present in the oat composite article has a proportion of xylose in the range from 15% by weight to 31% by weight, preferably in the range from 17% by weight to 30% by weight, more preferably in the range from 22% by weight to 29.9% by weight, most preferably in the range from 27.3% by weight to 28.9% by weight, based in each case on the dry matter of the hemicellulose present in the oat composite article,
   and/or, preferably “and”
wherein the hemicellulose present in the oat composite article has a proportion of arabinose in the range from 2.6% by weight to 4.0% by weight, preferably in the range from 3.1% by weight to 3.9% by weight, more preferably in the range from 3.2% by weight to 3.8% by weight, based in each case on the dry matter of the hemicellulose present in the oat composite article,
   and/or, preferably “and”
wherein the hemicellulose present in the oat composite article has a ratio of arabinose to xylose in the range from 0.05 to 0.5, preferably in the range from 0.09 to 0.3, more preferably in the range from 0.1 to 0.2,
   and/or, preferably “and”
wherein the hemicellulose present in the oat composite article has a proportion of mannose of less than 0.03% by weight, preferably of less than 0.02% by weight, more preferably of less than 0.01% by weight, based in each case on the dry matter of the hemicellulose present in the oat composite article,
   and/or, preferably “and”
wherein the oat fibers present in the oat composite article have a proportion of p-hydroxybenzaldehyde in the range from 50 μg·g⁻¹ to 250 μg·g⁻¹, preferably in the range from 60 μg·g⁻¹ to 220 μg·g⁻¹, more preferably in the range from 65 μg·g⁻¹ to 216 μg·g⁻¹, most preferably in the range from 190 μg·g⁻¹ to 215 μg·g⁻¹, based in each case on the dry matter of the oat fibers present in the oat composite article,
   and/or, preferably “and”
wherein the oat fibers present in the oat composite article have a proportion of ferulic acid in the range from 1000 μg·g⁻¹ to 3000 μg·g⁻¹, preferably in the range from 1100 μg·g⁻¹ to 2800 μg·g⁻¹, more preferably in the range from 1300 μg·g⁻¹ to 2700 μg·g⁻¹, most preferably in the range from 2300 μg·g⁻¹ to 2600 μg·g⁻¹, based in each case on the dry matter of the oat fibers present in the oat composite article,
   and/or, preferably “and”
wherein the oat fibers present in the oat composite article have a proportion of proteins of less than 3% by weight, preferably less than 2% by weight, more preferably a proportion of proteins in the range from 1.2% by weight to 1.6% by weight, based in each case on the dry matter of the oat fibers present in the oat composite article,
   and/or, preferably “and”
wherein the oat fibers present in the oat composite article have a proportion of lipids of less than 2% by weight, preferably less than 1.5% by weight, more preferably a proportion of lipids in the range from 0.8% by weight to 1.0% by weight, based in each case on the dry matter of the oat fibers present in the oat composite article.

What is meant by the text “and/or, preferably “and”” in the present text is that there is either an “AND” linkage or an “OR” linkage, although it is preferable in each case that there is an “AND” linkage.

The dry matter of the oat fibers present in the oat composite article is the total dry matter of all oat fibers present in the respective oat composite article.

In many cases it is preferable that the hemicellulose in the oat fibers used for production of the oat composite article contains no mannose at all.

A proportion of p-hydroxybenzaldehyde of 1 μg·g⁻¹ means that one microgram of p-hydroxybenzaldehyde is present per gram of dry matter of the oat fibers used.

In many cases, a proportion of lignocellulose in the range from 81% by weight to 86% by weight is particularly preferred, since in that case the properties, in particular the combinations of properties, of the resulting oat composite article are perceived as being particularly positive in many cases.

The use of fibers with a lipid content of more than 2% by weight in the production of biocomposite regularly leads to properties of the biocomposite that are perceived as being disadvantageous in the field of the present invention.

Very particular preference is given to an oat composite article,
wherein the oat fibers present in the oat composite article have a proportion of lignocellulose in the range from 81% by weight to 86% by weight, based on the dry matter of the oat fibers used,
   and
wherein the oat fibers present in the oat composite article have a proportion of lignin in the range from 22% by weight to 25% by weight, based on the dry matter of the oat fibers used,
   and
wherein the oat fibers present in the oat composite article have a proportion of hemicellulose in the range from 31.5% by weight to 36.0% by weight, based on the dry matter of the oat fibers used,
   and
wherein the hemicellulose present in the oat composite article has a proportion of xylose in the range from 27.3% by weight to 29.9% by weight, based on the dry matter of the hemicellulose present in the oat composite article,
   and
wherein the hemicellulose present in the oat composite article has a proportion of arabinose in the range from 3.2% by weight to 3.8% by weight, based on the dry matter of the hemicellulose present in the oat composite article,
   and
wherein the hemicellulose present in the oat composite article has a ratio of arabinose to xylose in the range from 0.1 to 0.2,
   and
wherein the hemicellulose present in the oat composite article has a proportion of mannose in the region of less than 0.01% by weight, based on the dry matter of the hemicellulose present in the oat composite article,
   and
wherein the oat fibers present in the oat composite article have a proportion of p-hydroxybenzaldehyde in the range from 190 μg·g⁻¹ to 215 μg·g⁻¹, based on the dry matter of the oat fibers present in the oat composite article,
   and
wherein the oat fibers present in the oat composite article have a proportion of ferulic acid in the range from 2300 μg·g⁻¹ to 2600 μg·g⁻¹, based on the dry matter of the oat fibers present in the oat composite article,
   and
wherein the oat fibers present in the oat composite article have a proportion of proteins in the range from 1.2% by weight to 1.6% by weight, based on the dry matter of the oat fibers present in the oat composite article,
   and
wherein the oat fibers present in the oat composite article have a proportion of lipids in the range from 0.8% by weight to 1.0% by weight, based on the dry matter of the oat fibers used.

Oat composite articles comprising the above-defined substances in the respectively above-defined amounts have combinations of properties that are perceived as being particularly advantageous in many cases in the field of the present invention.

In many cases, preference is given to oat composite articles
wherein the oat fibers present in the oat composite article have a proportion of hemicellulose in the range from 31.5% by weight to 36.0% by weight, based on the dry matter of the oat fibers used,
   and
wherein the hemicellulose present in the oat composite article has a proportion of xylose in the range from 27.3% by weight to 29.9% by weight, based on the dry matter of the hemicellulose present in the oat composite article,
   and
wherein the hemicellulose present in the oat composite article has a proportion of arabinose in the range from 3.2% by weight to 3.8% by weight, based on the dry matter of the hemicellulose present in the oat composite article,
   and
wherein the hemicellulose present in the oat composite article has a ratio of arabinose to xylose in the range from 0.1 to 0.2.

In particular, it has been found in in-house tests on such oat composite articles that they have particularly positive properties with regard to melt mass flow rate, determined in accordance with ISO 1133-2 using method B and using parameters of 190° C. and 5 kg, and melt volume flow rate, determined in accordance with ISO 1133-2 using method B and using parameters of 190° C. and 5 kg, in combination with a particularly advantageous flexural strain at flexural strength, determined by method A of DIN EN ISO 178 with an initial force of 0.1 MPa and a test speed of 2 mm/min.

Oat composite articles comprising lignocellulose, lignin, hemicellulose, p-hydrobenzalde-hyde, ferulic acid, proteins and lipids in the ranges specified above as preferred have particularly good properties on compounding with polymer materials and lead to a compound of oat fibers and polymers which is perceived as being particularly positive in the field of the present invention.

Oat composite articles comprising the abovementioned substances in the abovementioned quantities are particularly preferred in many cases since many of the above-described effects and benefits of the present invention are achieved to a particular degree when they are present in the oat composite article.

The present invention, with its various aspects, relates in particular and with preference to an oat composite article (as described above, preferably as described above as preferred),
wherein the oat fibers present in the oat composite article have a number-weighted average length in the range from 100 μm to 300 μm, preferably in the range from 120 μm to 250 μm, more preferably in the range from 150 μm to 220 μm, preferably in the range from 190 μm to 200 μm,
   and/or, preferably “and”
wherein the oat fibers present in the oat composite article have a number-weighted average thickness in the range from 30 μm to 200 μm, preferably in the range from 50 μm to 150 μm, more preferably in the range from 90 μm to 130 μm, preferably in the range from 105 μm to 120 μm,
   and/or, preferably “and”
wherein the oat fibers present in the oat composite article have a number-weighted average convexity in the range from 0.6 to 0.95, preferably in the range from 0.65 to 0.90, more preferably in the range from 0.7 to 0.85,
   and/or, preferably “and”
wherein the oat fibers present in the oat composite article have a number-weighted average form factor in the range from 1.0 to 1.5, preferably in the range from 1.03 to 1.4, more preferably in the range from 1.05 to 1.35,
   and/or, preferably “and”
wherein the oat fibers present in the oat composite article have a number-weighted average Feret aspect ratio in the range from 0.3 to 0.7, preferably in the range from 0.4 to 0.6, more preferably in the range from 0.45 to 0.58.

The term “μm” means micrometers, one millionth of one meter.

In many cases, particular preference is given to oat composite articles
wherein the oat fibers present in the oat composite article have a number-weighted average length in the range from 100 μm to 300 μm, preferably in the range from 120 μm to 250 μm, more preferably in the range from 150 μm to 220 μm, preferably in the range from 190 μm to 200 μm,
   and
wherein the oat fibers present in the oat composite article have a number-weighted average thickness in the range from 30 μm to 200 μm, preferably in the range from 50 μm to 150 μm, more preferably in the range from 90 μm to 130 μm, preferably in the range from 105 μm to 120 μm,
   and
wherein the oat fibers present in the oat composite article have a number-weighted average convexity in the range from 0.6 to 0.95, preferably in the range from 0.65 to 0.90, more preferably in the range from 0.7 to 0.85,
   and
wherein the oat fibers present in the oat composite article have a number-weighted average form factor in the range from 1.0 to 1.5, preferably in the range from 1.03 to 1.4, more preferably in the range from 1.05 to 1.35,
   and
wherein the oat fibers present in the oat composite article have a number-weighted average Feret aspect ratio in the range from 0.3 to 0.7, preferably in the range from 0.4 to 0.6, more preferably in the range from 0.45 to 0.58.

In-house studies on oat composite articles, by way of example for other cereal composite articles, have shown that oat composite articles in which the oat fibers have a number-weighted average length as defined above and at the same time a number-weighted average thickness as defined above have particularly positive properties and combinations of properties with respect to the following parameters: tensile strength, determined in accordance with DIN EN ISO 527-2, flexural stress under conventional deflection, determined by method A of DIN EN ISO 178:2019 with an initial force of 0.1 MPa and a test speed of 2 mm/min, and flexural strain at flexural strength, determined by method A of DIN EN ISO 178:2019 with an initial force of 0.1 MPa and a test speed of 2 mm/min.

In many cases, particular preference is given to such oat composite articles
wherein the oat fibers present in the oat composite article have a number-weighted average length in the range of 190 μm to 200 μm,
   and
wherein the oat fibers present in the oat composite article have a number-weighted average thickness in the range from 105 μm to 120 μm,
   and
wherein the oat fibers present in the oat composite article have a number-weighted average convexity in the range from 0.7 to 0.85,
   and
wherein the oat fibers present in the oat composite article have a number-weighted average form factor in the range from 1.05 to 1.35,
   and
wherein the oat fibers present in the oat composite article have a number-weighted average Feret aspect ratio in the range from 0.45 to 0.58.

Oat composite articles in which the oat fibers present have the combinations of properties defined above lead to particularly preferred properties and combinations of properties that are perceived as being particularly positive in particular for compostable oat composite articles in the field of the present invention.

The present invention, with its various aspects, relates in particular and with preference to an oat composite article (as described above, preferably as described above as preferred),
wherein the proportion of oat fibers in the oat composite article is in the range from 5% by weight to 45% by weight, preferably in the range from 10% by weight to 42% by weight, more preferably in the range from 20% by weight to 40% by weight, most preferably in the range from 30% by weight to 35% by weight, based in each case on the total mass of the oat composite article.

In-house studies on oat composite articles, by way of example for other cereal composite articles, have shown that oat composite articles having a proportion of oat fibers as defined above in many cases have particularly advantageous combinations of properties. However, depending on the requirements of the individual case, the skilled person will also be able to identify proportions of oat fibers in the oat composite article that are outside the ranges defined here and lead to positive combinations of properties in the individual case in question.

The above-described effects and benefits of the oat composite articles of the invention are achieved to a particular degree in many cases with the proportions of oat fibers specified here.

The present invention, with its various aspects, relates in particular and with preference to an oat composite article (as described above, preferably as described above as preferred) additionally comprising one, two, three or more substances, preferably in a combined total proportion of 2% to 5% by weight based on the total mass of the oat composite article, which are preferably selected independently of one another from the group consisting of:
sugar, preferably glucose, sucrose and/or starch, especially preferably glucose, sucrose and/or starch in a proportion of 3% by weight to 5% by weight, based on the total mass of the resulting oat composite article,
fertilizer, preferably fertilizer in a proportion of 2% by weight to 5% by weight based on the total mass of the resulting oat composite article, especially preferably guano in a proportion of 2% by weight to 5% by weight based on the total mass of the resulting oat composite article,
auxiliaries for improving the flow properties of the molten polymer material, preferably biobased and biodegradable auxiliaries for improving the flow properties of the molten polymer material, more preferably biobased and biodegradable auxiliaries for improving the flow properties of the molten polymer material in a proportion of 1% by weight to 3% by weight, based on the total mass of the resulting cereal composite article,
dyes, preferably food dyes, more preferably natural food dyes, most preferably natural food dyes selected from the group consisting of: carotenoids, berry dyes, beet dyes, carmine, paprika extract and curcumin.

In many cases, a preferred proportion of dyes in the oat composite article is one within the range from 2% by weight to 7% by weight, more preferably in the range from 3% by weight to 6% by weight, most preferably in the range from 4% by weight to 5% by weight, based in each case on the total mass of the oat composite article.

In some cases, formation of streaks on the surface of the oat composite articles (which is frequently undesirable in the field of the present invention for visual reasons) can be concealed by the addition of dyes.

In many cases it is also preferable to use as the dye the blue dye with the “MB UN BLUE” product name and the “UN5002” product code, which is commercially available from the manufacturer “Color Service GmbH & Co. KG”; it is preferably used in the amounts specified above.

In many cases it is also preferable to use as the dye the pink dye with the “MB UN PINK” product name and the “UN33656” product code, which is commercially available from the manufacturer “Color Service GmbH & Co. KG”; it is preferably used in the amounts specified above.

In many cases it is also preferable to use as the dye the yellow dye with the “MB UN YELLOW” product name and the “UN1057” product code, which is commercially available from the manufacturer “Color Service GmbH & Co. KG”; it is preferably used in the amounts specified above.

In many cases it is also preferable to use as the dye the green dye with the “MB UN GREEN” product name and the “UN67054” product code, which is commercially available from the manufacturer “Color Service GmbH & Co. KG”; it is preferably used in the amounts specified above.

The above-specified dyes in the amounts stated above as preferred give particularly positive color impressions of the colored oat composite article. The result is a positively homogeneous color impression. The result is a positively bright color impression. In particular, the bright yellow dye also results in an extremely positive color impression. In-house comparative tests have shown that other biocomposites (especially biocomposites comprising sunflower hulls or parts of sunflower hulls for example) with the yellow dye cannot be stained with a satisfactory result.

In many cases, the color impression is even more positive when the dye used is talc and/or when talc is used in addition to other dyes (preferably as described above as preferred).

In many cases, it is preferable when the oat composite article of the invention comprises one, two, three or more additional substances in addition to the polymer material on the one hand and the oat fibers on the other hand. In many cases, it is preferable when the oat composite article comprises the abovementioned substances as aggregates.

When the oat composite article comprises sugars in addition to the sugars present in the oat fibers, the compostability of the oat composite article is improved in many cases. In particular, such an oat composite article in many cases has faster compostability than an oat composite article which, in an otherwise identical composition, does not contain sugar molecules aside from the sugar molecules present in the oat fibers.

When the polymer material selected in the oat composite article is not “starch”, it is in many cases preferable when the total proportion of starch in the oat composite article is 8% by weight or less, preferably 5% by weight or less, especially preferably 3% by weight or less, based in each case on the total mass of the oat composite article.

A distinction between starch present in oat fibers and starch present outside oat fibers is known in the field of the present invention; corresponding analytical methods are known to the skilled person.

In many cases, it is preferable when the oat composite article contains fertilizer; this is especially the case, for example, if the oat composite article is compostable and is designed as a planter, since plant shock can be avoided with appropriate planters.

Auxiliaries for improving the flow properties of the molten polymer material are known to the skilled person; they will use, for example, erucamide, as commercially available under the “LOXIOL® E SPEZIAL” trade name from Emrey Oleochemicals GmbH in Dusseldorf; they will additionally or alternatively use polyol partial esters as commercially available under the “LOXIOL® P 728 BEADS” trade name from Emrey Oleochemicals GmbH in Dusseldorf; they will additionally or alternatively use compositions as commercially available under the “CITROFOL AI” trade name from Jungbunzlauer Ladenburg GmbH in Ladenburg; in some cases, the skilled person will also use inert polymers as commercially available under the “BIOSTRENGTH® 150” trade name from ARKEMA GmbH in Dusseldorf; at least the latter are nonbiodegradable and are therefore only used in the case of correspondingly low demands on biodegradability of the oat composite article. In many cases, it is preferable when the auxiliaries used for improving the flow properties of the molten polymer material are selected such that they are classified as not hazardous in accordance with “Regulation (EC) No 1272/2008 of the European Parliament and of the Council of 16 Dec. 2008 on classification, labelling and packaging of substances and mixtures, amending and repealing Directives 67/548/EEC and 1999/45/EC, and amending Regulation (EC) No 1907/2006”.

In many cases, it is preferable in the context of the present invention when the oat composite article does not contain any auxiliaries for improving the flow properties.

The term “dye” is used in the context of the present text to refer to chemical compounds that have the property of coloring other materials.

In the context of the present invention, the term “food colorants” refers in particular to food additives which have the property of coloring other materials and which are authorized in accordance with the provisions of “Regulation (EC) No 1333/2008 of the European Parliament and of the Council of 16 Dec. 2008 on food additives”.

Particular preference is given in the context of the present invention to using natural food dyes, i.e. food dyes that can be obtained from plants or animals. Examples of natural food dyes that are used in the oat composite article of the invention are: carotenoids (E 160a), berry dyes (anthocyanins, E 163), beet dyes (betanine, E 162), carmine (E 120), paprika extract (E 160c) and curcumin (E 100).

Coloring plant or fruit extracts, such as the extracts of beet, spinach, elderberry, saffron and turmeric, are also natural food dyes. Squid ink or sepia is also a natural food dye.

The present invention, with its various aspects, relates in particular and with preference to an oat composite article (as described above, preferably as described above as preferred), preferably to an oat composite molding,
wherein the oat composite article, preferably the oat composite molding, has a melt mass flow rate, determined in accordance with ISO 1133-2 using method B and using parameters of 190° C. and 5 kg, in the range from 15 g/10 min to 25 g/10 min, preferably in the range from 16 g/10 min to 24 g/10 min, more preferably in the range from 16.5 g/10 min to 23.8 g/10 min,
   and/or, preferably “and”
wherein the oat composite article, preferably the oat composite molding, has a melt volume flow rate, determined in accordance with ISO 1133-2 using method B and using parameters of 190° C. and 5 kg, in the range from 10 cm³/10 min to 105 cm³/10 min, preferably in the range from 12 cm³/10 min to 104 cm³/10 min, more preferably in the range from 13 cm³/10 min to 102 cm³/10 min,
   and/or, preferably “and”
wherein the oat composite article, preferably the oat composite molding, has a density, determined by method A of DIN EN ISO 1183-1:2019, in the range from 1.2 g·cm⁻³ to 1.5 g·cm⁻³, preferably in the range from 1.26 g·cm⁻³ to 1.4 g·cm⁻³, more preferably in the range from 1.28 g·cm⁻³ to 1.39 g-cm-3,
   and/or, preferably “and”
wherein the oat composite article, preferably the oat composite molding, has a flexural modulus of elasticity, determined by method A of DIN EN ISO 178:2019 with an initial force of 0.1 MPa and a test speed of 2 mm/min, in the range from 1500 MPa to 5000 MPa, preferably in the range from 1600 MPa to 4500 MPa, more preferably in the range from 1640 MPa to 4300 MPa,
   and/or, preferably “and”
wherein the oat composite article, preferably the oat composite molding, has a tensile strength, determined in accordance with DIN EN ISO 527-2:2012, in the range from 15 MPa to 30 MPa, preferably in the range from 18 MPa to 27 MPa, more preferably in the range from 19 MPa to 26 MPa,
   and/or, preferably “and”
wherein the oat composite article, preferably the oat composite molding, has a tensile elongation, determined in accordance with DIN EN ISO 527-2, in the range from 0.7% to 3.0%, preferably in the range from 0.8% to 2.8%, more preferably in the range from 0.81% to 2.79%,
   and/or, preferably “and”
wherein the oat composite article, preferably the oat composite molding, has a flexural stress under conventional deflection, determined by method A of DIN EN ISO 178, with an initial force of 0.1 MPa and a test speed of 2 mm/min, in the range from 30 MPa to 40 MPa, preferably in the range from 34 MPa to 39 MPa, more preferably in the range from 36 MPa to 38 MPa,
   and/or, preferably “and”
wherein the oat composite article, preferably the oat composite molding, has a flexural strain at flexural strength, determined by method A of DIN EN ISO 178, with an initial force of 0.1 MPa and a test speed of 2 mm/min, in the range from 0.5% to 6%, preferably in the range from 1.0% to 5.0%, more preferably in the range from 1.4% to 4.5%,
   and/or, preferably “and”
wherein the oat composite article, preferably the oat composite molding, has a Charpy impact resistance of the unnotched test specimen, determined in accordance with DIN EN ISO 179-1:2010 by the method of ISO 179-1/1eU, in the range from 4 kJ·m⁻² to 20 kJ·m⁻², preferably in the range from 4.1 kJ·m⁻² to 12 kJ·m⁻², more preferably in the range from 4.2 kJ·m⁻² to 11.5 kJ·m⁻².

The unit of pressure MPa here and hereinafter means “megapascal”, i.e. one million pascal.

The unit “kJ·m⁻²” means kilojoules per square meter.

Depending on the requirements of the individual case, the skilled person will choose oat composite articles having individual, several or all of the above properties. In some cases, it is also preferable to select properties that are outside the ranges defined above. The skilled person will recognize these cases on the basis of the requirements of the specific individual case.

Oat composite articles, in particular oat composite moldings having the above-defined properties within the above-defined ranges, depending on their use or planned use, are particularly preferred in many cases since their properties are perceived as being particularly positive in the field of the present invention. In particular, the above-defined properties in the above-defined ranges are preferred when the oat composite article, in particular the oat composite molding, contains a biopolymer material as polymer material.

The present invention, with its various aspects, relates in particular and with preference to an oat composite article (as described above, preferably as described above as preferred), preferably oat composite molding (as described above, preferably as described above as preferred), wherein
the oat composite article, preferably the oat composite molding, has an intrinsic odor of roasted aromas.

Biocomposites as known from the prior art in many cases have an intrinsic odor which is perceived as unpleasant and prevents commercial use, or makes it less advantageous.

The addition of fragrances for masking an intrinsic odor which is perceived as being unpleasant or for creating an intrinsic odor which is perceived as being pleasant is regularly undesirable in the field of the present invention.

In many cases, it is therefore extremely preferable when the oat composite article, preferably the oat composite molding, has an intrinsic odor of roasted aromas. An intrinsic odor of roasted aromas is perceived as being particularly advantageous in the field of the present invention for commercial use. The skilled person will identify these cases on the basis of the requirements of the specific individual case.

The other effects and benefits described above are achieved to a particular degree here too.

It is also regularly particularly preferable when the oat composite article, preferably the oat composite molding, has a light color which is perceived as being advantageous and is additionally printable by the methods customary in the field of the present invention.

The present invention, with its various aspects, relates in particular and with preference to an oat composite article (as described above, preferably as described above as preferred), preferably an oat composite molding (as described above, preferably as described above as preferred), wherein
the oat composite article, preferably the oat composite molding, complies with the requirements of Commission Regulation (EU) No 10/2011 of 14 Jan. 2011 on plastic materials and articles intended to come into contact with food.

Biocomposites as known from the prior art in many cases have an intrinsic odor which is perceived as unpleasant and in particular prevents commercial use involving food contact, or makes it less advantageous. In many cases, it is therefore extremely preferable when the oat composite article, preferably the oat composite molding, has an intrinsic odor of roasted aromas and at the same time meets the requirements of Commission Regulation (EU) No 10/2011 of 14 Jan. 2011 on plastic materials and articles intended to come into contact with food. This combination is regularly perceived as being extremely positive in the field of the present invention.

In many cases, it is preferable when the oat composite article, preferably the oat composite molding, is suitable for use in the packaging and/or processing of foods; in particular, in many cases it is preferable when the oat composite article is also approved for this purpose in the European Union. Against this background, the skilled person will identify suitable polymer materials that may be present in a food-grade oat composite article from their knowledge in the art.

In many cases, it is preferable in particular when the oat composite article, preferably the oat composite molding, has been heat-treated and/or is free of harmful substances. Preferably, the oat composite article, preferably the oat composite molding, is food-grade, pollutant-free and heat-treated.

In many cases, it is additionally preferable when the food-grade oat composite article, preferably the food-grade oat composite molding, is compostable, preferably industrially compostable, especially preferably home-compostable.

The other effects and benefits described above are achieved to a particular degree here too.

The present invention, with its various aspects, relates in particular and with preference to an oat composite article (as described above, preferably as described above as preferred), wherein the oat composite article is storable without mold formation at temperatures in the range between 0° C. and 25° C., preferably between 1° C. and 23° C., more preferably between 4° C. and 20° C., and also at a defined humidity in the range from 0% to 10% relative humidity, preferably in the range from 1% to 9% relative humidity, more preferably in the range from 1% to 8% relative humidity, over a period of at least 12 months, preferably of at least 18 months, more preferably of at least 24 months, most preferably of at least 36 months.

Particularly advantageous storability is possessed by oat composite articles having a moisture content in the range from 0% by weight to 10% by weight, preferably in the range from 3% by weight to 9% by weight, more preferably in the range from 6% by weight to 8% by weight. If necessary, the skilled person will dry the oat composite articles prior to storage; in this case, they will choose the appropriate drying method independently from the drying methods known to them according to the requirements of the individual case.

In the field of the present invention, the oat composite articles are frequently stored at temperatures and humidities within the specified ranges. Especially when the oat composite article is a pelletized oat composite or a dried pelletized oat composite, there is regularly intermediate storage prior to further processing steps, for example injection molding or compression molding. In this case, mold formation during storage is regularly undesirable in the field of the present invention. Oat composite articles that are storable at the above-specified temperatures and humidities at least over a period of time as defined above are extremely preferred in many cases in the field of the present invention.

In-house studies have shown that, in the field of the present invention, there is regularly extremely unwanted mold formation in the course of the storage of biocomposite materials as known from the prior art. Such mold formation does not take place in the course of proper storage of oat composite articles of the invention under the abovementioned conditions.

The present invention also relates to the use of an oat composite article, preferably a compostable oat composite article, more preferably an industrially compostable oat composite article, most preferably a home-compostable oat composite article, selected from the group consisting of:
oat composite,
pelletized oat composite,
dried pelletized oat composite
   and
oat composite molding,
   for production of an article, preferably for production of an article selected from the group consisting of:
garden articles, agricultural articles and/or forestry articles, preferably in particular plant pots, silage films, plant fixing clips and growth covers, in particular bite guards, weed barriers and covers to protect against frost,
signage, in particular signage not designed for use for more than 2 months,
disposable tableware and cutlery, preferably in particular disposable trays, disposable plates, lids for disposable coffee cups, disposable vessels, preferably disposable cups, for cold drinks, disposable vessels, preferably disposable cups, for hot drinks, disposable knives, disposable forks, disposable spoons, disposable teaspoons, disposable stirrers, disposable chopsticks,
disposable straws,
reusable tableware and cutlery, preferably in particular reusable trays, reusable plates, lids for reusable coffee cups, reusable vessels, preferably reusable cups, for cold drinks, reusable vessels, preferably reusable cups, for hot drinks, reusable knives, reusable forks, reusable spoons, reusable teaspoons, reusable stirrers, reusable chopsticks,
reusable straws,
beach toys
carrier bags, in particular shopping bags and waste bags,
flocculants, wet wipes, bristles for sweepers, mowing threads, mulch films, binder twine, foils for dishwasher tabs, flower foam, chewing gum, dirt erasers, microcomposite particles for cosmetics, fishery products, pellets for transport purposes, in particular for the transport of stone slabs and/or concrete slabs, bird rings, components of fireworks, dolly ropes, seed coating
   and
disposable packaging, preferably disposable packaging for food, especially coffee capsules, teabags and films for packaging fruit.

In particular, the above-specified articles are produced using an oat composite article of the invention in a particularly positive configuration and with properties or combinations of properties which are perceived as being particularly positive in the field of the present invention. In many cases, the particular production process is implemented in a particularly efficient and/or resource-conserving manner through the use of an oat composite article of the invention.

The present invention also relates to the use of oat fibers for production of an oat composite article, preferably as described above, preferably as described above as preferred.

In many cases, oat husk fibers and/or oat hull fibers are preferably used for production of an oat composite article, more preferably oat husk fibers and oat hull fibers.

The effects and benefits described above in association with oat composite articles of the invention are achieved when using oat fibers for production of an oat composite article, preferably as described above, preferably as described above as preferred.

The present invention also relates to use of a polymer material selected from the group consisting of:
polyhydroxyalkanoate,
polybutylene succinate,
polybutylene succinate-co-adipate,
natural resins,
starch,
cellulose with a lignin content of less than 5% by weight,
polybutylene adipate terephthalate,
polycaprolactone,
polylactides,
cellulose acetate,
waxes
   and
mixtures thereof;
   preferably selected from the group consisting of:
polyhydroxyalkanoate,
polybutylene succinate,
polybutylene succinate-co-adipate
   and
mixtures thereof;
   more preferably selected from the group consisting of:
polyhydroxyalkanoate,
polybutylene succinate-co-adipate,
   and
mixtures thereof;
   most preferably selected from the group consisting of:
polyhydroxyalkanoate
   and
polybutylene succinate-co-adipate
   for production of an oat composite article, preferably as described above, preferably as described above as preferred.

The effects and benefits described above in association with oat composite articles of the invention are achieved in a particularly positive manner in many cases when using the polymer materials specified above, preferably the biopolymer materials specified above, for production of an oat composite article, preferably as described above, preferably as described above as preferred.

The present invention also relates to a process for producing an oat composite article, preferably as described above, preferably as described above as preferred, selected from the group consisting of:
oat composite
pelletized oat composite
dried pelletized oat composite
   and
oat composite molding,
   comprising the following steps for production of the article:
producing or providing
   a polymer material,
   wherein the polymer material is selected from the group consisting of:
      polyhydroxyalkanoate,
      polybutylene succinate,
      polybutylene succinate-co-adipate,
      natural resins,
      starch,
      cellulose with a lignin content of less than 5% by weight,
      polybutylene adipate terephthalate,
      polycaprolactone,
      polylactides,
      cellulose acetate,
      waxes
   and
      mixtures thereof;
   preferably selected from the group consisting of:
      polyhydroxyalkanoate,
      polybutylene succinate,
      polybutylene succinate-co-adipate
         and
      mixtures thereof;
   more preferably selected from the group consisting of:
      polyhydroxyalkanoate,
      polybutylene succinate-co-adipate,
   and
      mixtures thereof;
   most preferably selected from the group consisting of:
      polyhydroxyalkanoate
   and
      polybutylene succinate-co-adipate;
   and, spatially separately therefrom,
      oat fibers, preferably oat husk fibers and/or oat hull fibers, more preferably oat husk fibers and oat hull fibers,
melting the polymer material produced or provided so as to result in a molten polymer material,
compounding the molten polymer material with at least the oat fibers produced or provided in a predetermined quantitative ratio so as to result in the oat composite.

The process of the invention achieves the properties described above in association with oat composite articles of the invention to a particularly positive extent. The effects and benefits described above in connection with oat composite articles of the invention and uses of the invention are achieved to a particular degree in the process of the invention.

Methods of melting polymer material and methods of compounding molten polymer material are known to the skilled person in the field of the present invention. Correspondingly required parameters are identified by them independently according to the needs of the individual case.

The present invention, with its various aspects, relates in particular and with preference to a process for producing an oat composite article (as described above, preferably as described above as preferred) selected from the group consisting of:
pelletized oat composite
dried pelletized oat composite
   and
oat composite molding,
   comprising the following steps for production of the article:
producing an oat composite by a process as described above, preferably as described above as preferred,
pelletizing the oat composite so as to result in pelletized oat composite.

Methods of pelletization are known to the person skilled in the art in the field of the present invention. Correspondingly required parameters are identified by them independently according to the needs of the individual case.

The present invention, with its various aspects, relates in particular and with preference to a process for producing an oat composite article (as described above, preferably as described above as preferred) selected from the group consisting of:
dried pelletized oat composite
   and
oat composite molding,
   comprising the following steps for production of the article:
producing a pelletized oat composite by a process as described above, preferably as described above as preferred,
drying the pelletized oat composite so as to result in dried pelletized oat composite, preferably dried pelletized oat composite having a moisture content of less than 12%, more preferably dried pelletized oat composite with a moisture content of less than 10%, most preferably dried pelletized oat composite with a moisture content of less than 9%.

Methods of drying pellets are known to the person skilled in the art in the field of the present invention. Correspondingly required parameters are identified by them independently according to the needs of the individual case. Before drying, the pelletized oat composite regularly has a moisture content of about 35% when it has been produced using a water bath with downstream extrudate pelletization.

By drying the pelletized oat composite so as to result in dried pelletized oat composite, it is advantageously possible to increase storability of the pellets without mold formation; the dried pelletized oat composite has an advantageously longer storability without mold formation compared to the undried pelletized oat composite.

The present invention, with its various aspects, relates in particular and with preference to a process for producing an oat composite article (as described above, preferably as described above as preferred),

comprising the following steps for production of the article:
producing a pelletized oat composite by a process as described above, preferably as described above as preferred, and/or producing a dried pelletized oat composite by a process as described above, preferably as described above as preferred, preferably producing a dried pelletized oat composite by a process as described above, preferably as described above as preferred;
melting the pelletized oat composite and/or the dried pelletized oat composite, preferably melting the dried pelletized oat composite so as to result in molten oat composite;
injection molding the molten oat composite so as to result in an oat composite molding.

Methods of injection molding of pelletized biocomposite are known to the skilled person in the field of the present invention. Correspondingly required parameters are identified by them independently according to the needs of the individual case.

In many cases, especially when the polymer material selected is not “starch”, the skilled person will reduce the total proportion of starch in the oat composite article in order to improve the properties of the oat composite articles.

The present invention, with its various aspects, relates in particular and with preference to a process for producing an oat composite article (as described above, preferably as described above as preferred),

comprising the following steps for production of the article:
producing a pelletized oat composite by a process as described above, preferably as described above as preferred, and/or producing a dried pelletized oat composite by a process as described above, preferably as described above as preferred, preferably producing a dried pelletized oat composite by a process as described above, preferably as described above as preferred;
compression molding the oat composite so as to result in an oat composite molding.

The present invention, with its various aspects, relates in particular and with preference to a process for producing an oat composite article (as described above, preferably as described above as preferred),

with the following step for production of the article:
thermoforming the oat composite so as to result in an oat composite molding.

The procedural details of the thermoforming of polymers and composite materials are known to the skilled person.

The present invention, with its various aspects, relates in particular and with preference to a process for producing an oat composite article (as described above, preferably as described above as preferred), wherein the resulting oat composite article is in the form of a film,

with the following step for production of the article:
extrusion, casting, calendering or blow molding, preferably blow molding and/or extrusion, more preferably blow molding of the oat composite, so as to result in an oat composite article in the form of a film.

The procedural details of extrusion, casting, calendering and blow molding are known to the skilled person.

Methods of compression molding of pelletized biocomposite are known to the skilled person in the field of the present invention. Correspondingly required parameters are identified by them independently according to the needs of the individual case.

The present invention, with its various aspects, relates in particular and with preference to a process for producing an oat composite article (as described above, preferably as described above as preferred), preferably for producing an oat composite molding (as described above, preferably as described above as preferred), wherein
the compounding is effected within a temperature range from 180° C. to 230° C., preferably within a temperature range from 185° C. to 220° C., more preferably within a temperature range from 188° C. to 215° C., most preferably within a temperature range from 190° C. to 210° C.,
   and/or, preferably “and”,
wherein the polymer material is selected from the group consisting of:
   polyhydroxyalkanoate,
   polybutylene succinate,
   polybutylene succinate-co-adipate,
   natural resins,
   starch,
   cellulose with a lignin content of less than 5% by weight,
   polybutylene adipate terephthalate,
   polycaprolactone,
   polylactides,
   cellulose acetate,
   waxes
and
   mixtures thereof;
preferably selected from the group consisting of:
   polyhydroxyalkanoate,
   polybutylene succinate,
   polybutylene succinate-co-adipate
and
   mixtures thereof;
more preferably selected from the group consisting of:
   polyhydroxyalkanoate,
   polybutylene succinate-co-adipate,
and
   mixtures thereof;
most preferably selected from the group consisting of:
   polyhydroxyalkanoate
and
   polybutylene succinate-co-adipate.

In particular, when the process of the invention is being used to produce industrially compostable oat composite articles, it is preferable in some cases to select polylactides as polymer material. In many cases, polylactides can be provided in a particularly simple and inexpensive way with regard to environmental and economic aspects.

In particular, when the process of the invention is being used to produce home-compostable oat composite articles, it is preferable in many cases to select polybutylene succinate and/or polybutylene succinate-co-adipate as polymer material. Both polybutylene succinate and polybutylene succinate-co-adipate polylactides are in many cases used with particular preference in the process of the invention with regard to their advantageous ecological aspects in particular.

In other cases, in particular when the process of the invention is being used to produce home-compostable oat composite articles, polyhydroxyalkanoate is preferably selected as polymer material. In many cases, polyhydroxyalkanoate is additionally preferably selected as polymer material when marine-compostable oat composite articles are produced by the process of the invention. When polyhydroxyalkanoate is used, a particularly high proportion of oat fiber can additionally be used in the process of the invention.

The present invention, with its various aspects, relates in particular and with preference to a process for producing an oat composite molding (as described above, preferably as described above as preferred), wherein
the melting and processing in the injection molding operation continues until immediately prior to contact with a casting mold and/or a water bath within a temperature range from 80° C. to 230° C., preferably within a temperature range from 100° C. to 220° C., more preferably within a temperature range from 110° C. to 210° C., most preferably within a temperature range from 120° C. to 200° C., preferably within a temperature range from 150° C. to 180° C.,
   and/or, preferably “and”,
the casting mold in the injection molding operation immediately prior to contact with the molten oat composite is at a temperature in the range from 15° C. to 50° C., preferably a temperature in the range from 20° C. to 40° C., more preferably a temperature in the range from 25° C. to 38° C., most preferably a temperature in the range from 30° C. to 35° C.

With the parameters defined above, the process of the invention in many cases affords oat composite moldings having particularly positive properties and/or combinations of properties in a particularly efficient manner.

In many cases, it is particularly preferable that the casting mold in injection molding is a cold runner mold.

In many cases, it is preferable in injection molding, especially in cases where the casting mold in the injection molding operation is a cold runner mold, that the pelletized oat composite is dried prior to injection molding to a moisture content of 0.6% by weight or less, more preferably of 0.5% by weight or less, most preferably of 0.4% by weight or less. In this way, better results are obtained in many cases, especially in cases where the casting mold in the injection molding operation is a cold runner mold. The likelihood of occurrence of defects that can occur in the resulting casting in the injection molding operation is reduced in this way.

The present invention, with its various aspects, relates in particular and with preference to a process for producing an oat composite article (as described above, preferably as described above as preferred), comprising the following steps:
providing oat hulls and/or oat husks;
cleaning the oat hulls and/or oat husks so as to result in cleaned oat hulls and/or cleaned oat husks;
drying the cleaned oat hulls and/or the cleaned oat husks so as to result in dried cleaned oat hulls and/or dried cleaned oat husks;
grinding the dried cleaned oat hulls and/or dried cleaned oat husks so as to result in ground oat hulls and/or ground oat husks;
screening the ground oat hulls and/or the ground oat husks so as to result in oat fibers and a residue on the screen.

In many cases, preference is given to a process for producing an oat composite article (as described above, preferably as described above as preferred) comprising the following steps:
providing oat hulls and oat husks;
cleaning the oat hulls and oat husks so as to result in cleaned oat hulls and cleaned oat husks;
drying the cleaned oat hulls and the cleaned oat husks so as to result in dried cleaned oat hulls and dried cleaned oat husks;
grinding the dried cleaned oat hulls and dried cleaned oat husks so as to result in ground oat hulls and ground oat husks;
screening the ground oat hulls and the ground oat husks so as to result in oat fibers and a residue on the screen.

Performance of a process of the invention for producing an oat composite article comprising the steps defined above affords oat composite articles having particularly positive properties. Especially when the oat composite articles that result from the process are intended for food contact, it is regularly preferable to perform the process steps defined above on performance of the process of the invention.

The present invention, with its various aspects, relates in particular and with preference to a process for producing an oat composite article (as described above, preferably as described above as preferred), wherein
the oat hulls and/or oat husks are cleaned at least in part by boiling in water at 100° C., followed by squeezing, preferably by squeezing with a Pondorf screw press,
   and/or, preferably “and”
wherein the drying is conducted in the form of an indirect drying operation, preferably in the form of an indirect drying operation on a belt dryer or in a drying cabinet, preferably on a belt dryer,
   and/or, preferably “and”
wherein the drying is conducted in such a way that the resulting dried cleaned oat hulls and/or dried cleaned oat husks have a water content of less than 7% by weight, preferably less than 6% by weight, more preferably less than 5% by weight, most preferably less than 4% by weight,
   and/or, preferably “and”
wherein the dried cleaned oat hulls and/or dried cleaned oat husks used in the grinding operation have a water content at the start of grinding of less than 7% by weight, preferably less than 6% by weight, more preferably less than 5% by weight, most preferably less than 4% by weight,
   and/or, preferably “and”
wherein the grinding is conducted with an impact disk mill, preferably with an impact disk mill at a temperature of 75° C., more preferably at a temperature of 75° C. and with a residence time of 1 minute,
   and/or, preferably “and”
wherein, in the screening of the ground oat hulls and/or the ground oat husks so as to result in oat fibers and a residue on the screen, a screen with a mesh size of 300 micrometers or less, preferably of 200 micrometers or less, more preferably of 160 micrometers or less, most preferably of 120 micrometers is used.

Performance of the above-defined process steps, preferably performance of all the above-defined process steps, affords oat composite articles that are particularly advantageously storable for long periods without mold formation. Both cleaning of the oat hulls as described above and drying with the specified drying times and temperatures increase storability without mold formation. In many cases, it is preferable when the oat fibers resulting from the screening of the ground oat hulls are a biological product within the meaning of Regulation (EU) 2018/848 of the European Parliament and of the Council of 30 May 2018 on organic production and labelling of organic products and repealing Council Regulation (EC) No 834/2007.

In many cases, it is preferable when the oat fibers resulting from the screening of the ground oat hulls are vegan.

In many cases, it is preferable when the cleaning of the oat hulls so as to result in cleaned oat hulls is performed by the method described in document WO 2020/192981, preferably by the method described in Example IV of document WO 2020/192981.

The conditions described above in the cleaning of the oat hulls result in oat hulls that are particularly suitable for use in oat composite articles, preferably in oat composite moldings, that meet the requirements of EU Regulation No 10/2011 of the Commission of 14 Jan. 2011 on plastic materials and articles intended to come into contact with food.

In many cases, it is preferable when the drying of the cleaned oat hulls so as to result in dried cleaned oat hulls comprises a drying step wherein the cleaned oat hulls are subjected to a temperature of 90° C. to 100° C. for 20 minutes. In many cases, it is preferable to select the duration of drying the cleaned oat hulls so as to result in dried cleaned oat hulls such that the resulting dried cleaned oat hulls have a moisture content of 6%. If the drying is conducted in this way, the resulting dried cleaned oat hulls have particularly low contamination with bacteria and fungi, in particular molds. The conditions described above in the drying of the cleaned oat hulls result in dried cleaned oat hulls that are particularly suitable for use in oat composite articles, preferably in oat composite moldings, that meet the requirements of EU Regulation No 10/2011 of the Commission of 14 Jan. 2011 on plastic materials and articles intended to come into contact with food.

In many cases, indirect drying is preferred, where contact with smoke and the pollutants regularly present in the smoke is avoided. Appropriate indirect drying is chosen especially when the aim is a low pollutant load of the resulting dried cleaned oat hulls.

In many cases, preference is given to squeezing with a Pondorf screw press, in many cases, particularly positive results are achieved in this way.

In many cases, oat fibers are produced by an economically and environmentally particularly advantageous production process compared to other natural fibers. Especially in the case of processing of the respective starting materials for the fibers in mills, oat fibers give rise to a particularly advantageous low level of abrasion and a particularly advantageous low level of corrosion properties compared to processing of other starting materials, for example wood or sunflower hulls.

When the screening of the ground oat hulls so as to result in oat fibers and a residue on the screen is effected with larger mesh sizes than 300 micrometers, the result is regularly oat fibers that are more difficult to dose and lead to less advantageous results when used in a process (as described above, preferably as described above as preferred), or when used for production of an oat composite article (as described above, preferably as described above as preferred).

In many cases, in the field of the present invention, consumers desire maximum sustainability and maximum conservation of the environment in performance of processes for producing biocomposites. Preferably, therefore, a process of the invention for producing an oat composite article is performed in such a way that the energy used for generation of heat is effected by the burning of biomass. Preferably, a process of the invention for producing an oat composite article is performed in such a way that energy used for purposes other than generation of heat comes from heat recovery and/or from renewable energy sources such as photovoltaics, the burning of biomass and/or wind energy.

The present invention, with its various aspects, relates in particular and with preference to a process for producing an oat composite article (as described above, preferably as described above as preferred), wherein:
the compounding is effected exclusively between the polymer material and the oat fibers without addition of any further substances, such that the resulting oat composite consists exclusively of the polymer material produced or provided and the oat fibers produced or provided,
   or
in addition to the oat fibers produced or provided, further substances are added to the molten polymer material as additives, preferably in a combined total content of 2% to 5% by weight, based on the total mass of all substances used in the compounding, and these are also present in the course of subsequent compounding, where these further substances as additive are preferably selected from the group consisting of:
   sugar, preferably glucose, sucrose and/or starch, especially preferably glucose, sucrose and/or starch in a proportion of 3% by weight to 5% by weight, based on the total mass of all substances used in the compounding,
   fertilizer, preferably fertilizer in a proportion of 2% by weight to 5% by weight based on the total mass of the resulting oat composite article, especially preferably guano in a proportion of 2% by weight to 5% by weight based on the total mass of all substances used in the compounding,
   auxiliaries for improving the flow properties of the molten polymer material, preferably biobased and biodegradable auxiliaries for improving the flow properties of the molten polymer material, more preferably biobased and biodegradable auxiliaries for improving the flow properties of the molten polymer material in a proportion of 1% by weight to 3% by weight, based on the total mass of the resulting cereal composite article,
   dyes, preferably food dyes, more preferably natural food dyes, most preferably natural food dyes selected from the group consisting of: carotenoids, berry dyes, beet dyes, carmine, paprika extract and curcumin.

The skilled person will select suitable fertilizers from the known fertilizers for garden and balcony plants independently according to the requirements of the individual case. For example, in cases where guano is not to be used, or not to be used on its own, the skilled person may make use of the following commercially available fertilizers, but may also select other fertilizers not listed here:
nitrogen fertilizer, such as calcium ammonium nitrate, urea, Piagran pro, Alzon neo-N and ammonium nitrate-urea solution
nitrogen fertilizer with sulfur, for example ammonium sulfate nitrate, Piamon S, Domogran, Piasan-S, Domamon L 26,
nitrogen-phosphorus fertilizer, for example DAP 18/46 and NP 10/34,
phosphorus fertilizer, for example triple superphosphate, P40 and Dolophos,
   and
potassium fertilizer, for example 60% potash, cereal potash, polysulfate.

In many cases, it is preferable when no auxiliaries for improving flow properties are used in the process of the invention for producing an oat composite article.

The present invention, with its various aspects, relates in particular and with preference to a process for producing an oat composite article (as described above, preferably as described above as preferred), wherein:
the compounding is effected exclusively between the polymer material and the oat fibers without addition of any further substances, such that the resulting oat composite consists exclusively of the polymer material produced or provided and the oat fibers produced or provided,
   and
in the compounding of the molten polymer material with the oat fibers produced or provided in a predetermined quantitative ratio so as to result in the oat composite,
   the predetermined quantitative ratio is selected such that it corresponds to a proportion of oat fibers of 5% by weight to 45% by weight, preferably a proportion of oat fibers of 10% by weight to 42% by weight, more preferably a proportion of 20% by weight to 40% by weight, most preferably a proportion of 30% by weight to 35% by weight, based in each case on the combined total mass of the molten polymer material used in the compounding operation and the oat fibers used in the compounding operation.

This means that, at a quantitative ratio corresponding to a proportion of oat fibers of 30% by weight, based on the combined total mass of the molten polymer material used in the compounding operation and the oat fibers used in the compounding operation: 70 g of polymer material and 30 g of oat fibers are used per 100 g of combined total mass of polymer material and oat fibers.

The present invention, with its various aspects, relates in particular and with preference to a process for producing an oat composite article (as described above, preferably as described above as preferred), wherein:
in addition to the oat fibers produced or provided, one, two, three or more further substances are added to the molten polymer material as additive, and these are also present in the course of subsequent compounding, where these one, two, three or more further substances as additive are preferably selected from the group consisting of:
   sugar, preferably glucose, sucrose and/or starch, especially preferably glucose, sucrose and/or starch in a proportion of 3% by weight to 5% by weight, based on the total mass of the resulting oat composite article,
   fertilizer, preferably fertilizer in a proportion of 2% by weight to 5% by weight, based on the total mass of the resulting oat composite article, especially preferably guano in a proportion of 2% by weight to 5% by weight, based on the total mass of the resulting oat composite article,
   auxiliaries for improving the flow properties of the molten polymer material, preferably biobased and biodegradable auxiliaries for improving the flow properties of the molten polymer material, more preferably biobased and biodegradable auxiliaries for improving the flow properties of the molten polymer material in a proportion of 1% by weight to 3% by weight, based on the total mass of the resulting cereal composite article,
dyes, preferably food dyes, more preferably natural food dyes, most preferably natural food dyes selected from the group consisting of: carotenoids, berry dyes, beet dyes, carmine, paprika extract and curcumin; preferably in an amount of 2% by weight to 7% by weight, preferably in an amount of 3% by weight to 6% by weight, more preferably in an amount of 4% by weight to 5% by weight, based in each case on the total mass of the oat composite article,
   and
in the compounding of the molten polymer material with at least the oat fibers produced or provided in a predetermined quantitative ratio so as to result in the oat composite, the predetermined quantitative ratio is selected such that it corresponds to a proportion of oat fibers of 5% by weight to 45% by weight, preferably a proportion of oat fibers of 10% by weight to 42% by weight, more preferably a proportion of 20% by weight to 40% by weight, most preferably a proportion of 30% by weight to 35% by weight, based in each case on the combined total mass of the molten polymer material used in the compounding operation and the oat fibers used in the compounding operation.

This means that, at a quantitative ratio corresponding to a proportion of oat fibers of 30% by weight and a proportion of an additive of 2% by weight, based in each case on the combined total mass of the molten polymer material used in the compounding operation, the oat fibers used in the compounding operation and the additive used in the compounding operation: 68 g of polymer material and 30 g of oat fibers and 2 g of additive are used per 100 g of combined total mass of polymer material and oat fibers and additive.

The use of the specified sugars does not conflict with the requirements of Commission Regulation (EU) No 10/2011 of 14 Jan. 2011 on plastic materials and articles intended to come into contact with food.

The present invention, with its various aspects, relates in particular and with preference to a process for producing an oat composite article (as described above, preferably as described above as preferred), wherein the polymer material used for production of an oat composite article has
a density determined by method A of ISO 1183-1 in the range from 1 g·cm³ to 2 g·cm³, preferably a density in the range from 1.0 g·cm³ to 1.6 g·cm³, more preferably a density in the range from 1.1 g·cm³ to 1.3 g·cm³, most preferably a density in the range from 1.23 g·cm³ to 1.26 g·cm³,
   and/or, preferably “and”
a melt mass flow rate, determined in accordance with ISO 1133-2 using method B and using parameters of 190° C. and 5 kg, in the range from 2 g/10 min to 50 g/10 min, preferably in the range from 2.5 g/10 min to 35 g/10 min, more preferably in the range from 3.0 g/10 min to 32 g/10 min, most preferably in the range from 3.8 g/10 min to 30 g/10 min,
   and/or, preferably “and”
a melting point, determined in accordance with ISO 3146, in the range from 70° C. to 140° C., preferably in the range from 75° C. to 120° C., more preferably in the range from 78° C. to 88° C., most preferably in the range from 83° C. to 85° C.

The use of polymer materials having the above-specified properties in the process of the invention leads in many cases to particularly positive properties or combinations of properties of the resulting oat composite article.

The present invention, with its various aspects, relates in particular and with preference to a process for producing an oat composite article (as described above, preferably as described above as preferred),
wherein the oat fibers used for production of the oat composite article have a proportion of lignocellulose in the range from 60% by weight to 90% by weight, preferably in the range from 70% by weight to 88% by weight, more preferably in the range from 75% by weight to 87% by weight, most preferably in the range from 81% by weight to 86% by weight, based in each case on the dry matter of the oat fibers used,
   and/or, preferably “and”
wherein the oat fibers used for production of the oat composite article have a proportion of lignin in the range from 10% by weight to 30% by weight, preferably in the range from 11% by weight to 27.5% by weight, more preferably in the range from 12% by weight to 26% by weight, most preferably in the range from 22% by weight to 25% by weight, based in each case on the dry matter of the oat fibers used,
   and/or, preferably “and”
wherein the oat fibers used for production of the oat composite article have a proportion of hemicellulose in the range from 20% by weight to 40% by weight, preferably in the range from 22% by weight to 38% by weight, more preferably in the range from 23.5% by weight to 37.0% by weight, most preferably in the range from 31.5% by weight to 36.0% by weight, based in each case on the dry matter of the oat fibers used,
   and/or, preferably “and”
wherein the hemicellulose in the oat fibers used for production of the oat composite article has a proportion of xylose in the range from 15% by weight to 31% by weight, preferably in the range from 17% by weight to 30% by weight, more preferably in the range from 22% by weight to 29.9% by weight, most preferably in the range from 27.3% by weight to 28.9% by weight, based in each case on the dry matter of the hemicellulose present in the oat fibers used,
   and/or, preferably “and”
wherein the hemicellulose in the oat fibers used for production of the oat composite article has a proportion of arabinose in the range from 2.6% by weight to 4.0% by weight, preferably in the range from 3.1% by weight to 3.9% by weight, more preferably in the range from 3.2% by weight to 3.8% by weight, based in each case on the dry matter of the hemicellulose present in the oat fibers used,
   and/or, preferably “and”
wherein the ratio of arabinose to xylose in the hemicellulose in the oat fibers used for production of the oat composite article is in the range from 0.05 to 0.5, preferably in the range from 0.09 to 0.3, more preferably in the range from 0.1 to 0.2,
   and/or, preferably “and”
wherein the hemicellulose in the oat fibers used for production of the oat composite article has a proportion of mannose of less than 0.03% by weight, preferably of less than 0.02% by weight, more preferably of less than 0.01% by weight, based in each case on the dry matter of the hemicellulose present in the oat fibers used,
   and/or, preferably “and”
wherein the oat fibers used for production of the oat composite article have a proportion of p-hydroxybenzaldehyde in the range from 50 μg·g⁻¹ to 250 μg·g⁻¹, preferably in the range from 60 μg·g⁻¹ to 220 μg·g⁻¹, more preferably in the range from 65 μg·g⁻¹ to 216 μg·g⁻¹, most preferably in the range from 190 μg·g⁻¹ to 215 μg·g⁻¹, based in each case on the dry matter of the oat fibers used,
   and/or [description: preferably “and” ]
wherein the oat fibers used for production of the oat composite article have a proportion of ferulic acid in the range from 1000 μg·g⁻¹ to 3000 μg·g⁻¹, preferably in the range from 1100 μg·g⁻¹ to 2800 μg·g⁻¹, more preferably in the range from 1300 μg-g¹ to 2700 μg·g⁻¹, most preferably in the range from 2300 μg·g⁻¹ to 2600 μg·g⁻¹, based in each case on the dry matter of the oat fibers used,
   and/or, preferably “and”
wherein the oat fibers used for production of the oat composite article have a proportion of proteins of less than 3% by weight, preferably less than 2% by weight, more preferably a proportion of proteins in the range from 1.2% by weight to 1.6% by weight, based in each case on the dry matter of the oat fibers used,
   and/or, preferably “and”
wherein the oat fibers used for production of the oat composite article have a proportion of lipids of less than 2% by weight, preferably less than 1.5% by weight, more preferably a proportion of lipids in the range from 0.8% by weight to 1.0% by weight, based in each case on the dry matter of the oat fibers used.

What is meant here by a proportion of p-hydroxybenzaldehyde of 1 μg·g⁻¹ is that one microgram of p-hydroxybenzaldehyde is present per gram of dry matter of the oat fibers used.

In many cases it is also preferable that the hemicellulose in the oat fibers used for production of the oat composite article contains no mannose at all.

In many cases, a proportion of lignocellulose in the range from 81% to 86% by weight is particularly preferred, since in that case the properties of the resulting oat composite article are perceived as being particularly positive in many cases.

The use of fibers with a lipid content of more than 2% by weight in the production of biocomposite regularly leads to properties of the biocomposite that are perceived as being disadvantageous in the field of the present invention.

The use of oat fibers having the above-specified properties in the process of the invention leads in many cases to particularly positive properties or combinations of properties of the resulting oat composite article.

The present invention, with its various aspects, relates in particular and with preference to a process for producing an oat composite article (as described above, preferably as described above as preferred),
wherein the oat fibers used for production of the oat composite article have a number-weighted average length in the range from 100 μm to 300 μm, preferably in the range from 120 μm to 250 μm, more preferably in the range from 150 μm to 220 μm, preferably in the range from 190 μm to 200 μm,
   and/or, preferably “and”
wherein the oat fibers used for production of the oat composite article have a number-weighted average thickness in the range from 30 μm to 200 μm, preferably in the range from 50 μm to 150 μm, more preferably in the range from 90 μm to 130 μm, preferably in the range from 105 μm to 120 μm,
   and/or, preferably “and”
wherein the oat fibers used for production of the oat composite article have a number-weighted average convexity in the range from 0.6 to 0.95, preferably in the range from 0.65 to 0.90, more preferably in the range from 0.7 to 0.85,
   and/or, preferably “and”
wherein the oat fibers used for production of the oat composite article have a number-weighted average form factor in the range from 1.0 to 1.5, preferably in the range from 1.03 to 1.4, more preferably in the range from 1.05 to 1.35,
   and/or, preferably “and”
wherein the oat fibers used for production of the oat composite article have a number-weighted average Feret aspect ratio in the range from 0.3 to 0.7, preferably in the range from 0.4 to 0.6, more preferably in the range from 0.45 to 0.58.

The use of oat fibers having the above-specified properties in the process of the invention leads in many cases to particularly positive properties or combinations of properties of the resulting oat composite article. The present invention also relates to a kit for production of an oat composite article, at least comprising, in the form of spatially separate components:
a polymer material,
preferably a polymer material selected from the group consisting of:
   polyhydroxyalkanoate
   polybutylene succinate
   polybutylene succinate-co-adipate
   natural resins
   starch
   cellulose with a lignin content of less than 5% by weight
   polybutylene adipate terephthalate
   polycaprolactone
   polylactides
   cellulose acetate
   waxes
and
   mixtures thereof,
preferably selected from the group consisting of:
   polyhydroxyalkanoate
   polybutylene succinate
   polybutylene succinate-co-adipate
and
   mixtures thereof,
more preferably selected from the group consisting of:
   polyhydroxyalkanoate
   polybutylene succinate-co-adipate
and
   mixtures thereof,
most preferably selected from the group consisting of:
   polyhydroxyalkanoate
and
   polybutylene succinate-co-adipate
and, spatially separately therefrom,
   oat fibers, preferably oat husk fibers and/or oat hull fibers, more preferably oat husk fibers and oat hull fibers,

The kit of the invention is particularly suitable for performance of processes of the invention by which oat composite articles are produced.

The performability of the invention is elucidated in detail hereinafter, using oat fibers as an example of other cereal fibers. Grain fibers from other cereals, in particular from the husk cereals einkorn, emmer, Kamut, barley, millet and spelt, can also be produced and used in an equivalent manner.

### EXAMPLE B1: PRODUCTION OF OAT FIBERS

The selection of materials in this example is merely illustrative. In particular, according to the procedure described in this example, it is possible to produce either oat fibers from oat husks, called “oat husk fibers”, and oat fibers from oat hulls, called “oat hull fibers”. In accordance with the procedure described in this example, oat fibers can additionally be produced collectively from oat husks and oat hulls.

Oat husks have been used as an example. The oat husks were blown loose into a silo, then removed from the silo, mixed with water and cleaned on a washer line as described hereinafter. The oat husks blended with water were kept at a temperature of 100° C. for 40 minutes. Subsequently, the boiled oat husks were reduced to a water content of 35% by means of a Pondorf screw press, so as to result in the pollutant-containing pressing water and cleaned oat husks. The cleaned oat husks were dried to a moisture content of 6% with a belt dryer with heat recovery of the Stela RECU DRY—BTU RecuDry 1-6200-19.5 type, built in 2020, at 90° C. for 20 min so as to result in dried cleaned oat husks. The dried cleaned oat husks were then ground with a Herbold impact disk mill of the PU 1250 GR type, built in 2018, so as to result in ground oat husks. The ground oat husks were screened to a mesh size of 120 μm on a plane sifter of the Ruter Crossyoke-Plansifter 1500 type with a turntable distributor so as to result in oat fibers and a residue on the screen. The resulting oat fibers were transported into a silo with compressed air and stored intermediately therein.

### EXAMPLE B2: ANALYSIS OF THE OAT FIBERS

The length and thickness of oat fibers produced according to example B1 above has been analyzed—together with other parameters—by way of example using the commercially available FibreShape method as described below, in addition to the FibreShape method, the skilled person is also familiar with other methods by which they can determine the length and thickness—and other parameters—of oat fibers, for example using a microscope and a suitable scale. The measurement parameters used in the FibreShape method are listed in table 1.

TABLE 1
Measurement parameters of the FibreShape method

| Parameter | Value |
|---|---|
| Quality | Medium long fib |
| Application | Fibres 1200 dpi |
| Measurement mask | 1 |
| Review | Example wood shred 1200 dpi Epson |
| Resolution | 1200 |
| Grain size limits | 40.00-100000.00 μm |

First of all, a suitable amount of oat fibers produced according to the above example B1 was introduced into a 1 L plastic bag and carefully mixed in that bag. Subsequently, a suitable amount of sample was taken from the bag with a brush, applied to a slide (4.9×4.9 cm) and distributed over the area thereof. In order to fix the oat fibers distributed over the area, another slide was placed on as a cover slip and the two slides were fixed to each other with a strip of adhesive tape. Then the thus mutually connected slides with the oat fibers trapped between them were placed into a film guide and then scanned in with a Dimage Scan Elite 5400 II slide scanner (from Konica Minolta). The chosen resolution of the slide scanner was 1200 dpi, which corresponds to a lower resolution limit of 5 μm. The image evaluation was effected with the “FibreShape” analysis software from IST AG, St. Gallen, Switzerland, with the parameters specified in table 1.

An average of the fiber length, weighted by number, of 194.38 μm with a standard deviation of 281.88 μm was determined.

In addition to fiber length, with the same weighting, convexity, form factor and Feret aspect ratio were also determined by the FibreShape method: the mean convexity was 0.8260 with a standard deviation of 0.1024; the mean form factor was 1.0740 with a standard deviation of 0.2221; the mean Feret aspect ratio was 0.5737 with a standard deviation of 0.1535.

The percentiles ascertained for the fiber lengths are given in table 2. A 0% percentile indicates that no fiber is shorter than the corresponding value reported. A 10% percentile indicates that 10% of the fibers are shorter than the corresponding value reported. A 50% percentile indicates that 50% of the fibers are shorter than the corresponding value reported, and a 100% percentile indicates that no fiber is longer than the corresponding value reported, meaning that 100% of the fibers analyzed are shorter than this value.

TABLE 2
Length distribution of the oat fibers

| Percentile [%] | Fiber length [μm] |
|---|---|
| 0 | 41.5 |
| 5 | 41.5 |
| 10 | 45.7 |
| 50 | 90.2 |
| 90 | 449.6 |
| 95 | 693.1 |
| 100 | 6756.9 |

An average fiber thickness, weighted by length, of 110.01 μm with a standard deviation of 55.55 μm was obtained.

In addition to fiber thickness, with the same weighting, convexity, form factor and Feret aspect ratio were also determined by the FibreShape method: the mean convexity was 0.7344 with a standard deviation of 0.1446; the mean form factor was 1.3447 with a standard deviation of 0.4076; the mean Feret aspect ratio was 0.4892 with a standard deviation of 0.1822.

The corresponding percentiles for the measurements of fiber thickness are reported in table 3 analogously to the percentiles of fiber length reported in table 2.

TABLE 3
Percentiles for the measurements of fiber thickness

| Percentile [%] | Fiber length [μm] |
|---|---|
| 0 | 40.0 |
| 5 | 41.5 |
| 10 | 44.5 |
| 50 | 68.8 |
| 90 | 141.7 |
| 95 | 176.1 |
| 100 | 804.1 |

### EXAMPLE B2-1: ANALYSIS OF OAT FIBER CONSTITUENTS

Oat fibers produced according to example B1 above were analyzed as described below.

Minerals and trace elements were determined in accordance with DIN EN 15621:2017-10. The measurement results are reported in simplified form in table 4 in accordance with DIN EN ISO/IEC 17025:2018, Section 7.8.1.3.

TABLE 4
Results of the determination of minerals and trace
elements according to DIN EN 15621: 2017-10

| Mineral/trace element | Result | Unit |
|---|---|---|
| Sodium | <0.01 | % |
| Potassium | 0.23 | % |
| Magnesium | 0.05 | % |
| Calcium | 0.11 | % |
| Phosphorus | 0.09 | % |
| Copper | 1.69 | mg/kg |
| Iron | 214 | mg/kg |
| Zinc | 38.3 | mg/kg |
| Manganese | 26.0 | mg/kg |

The results of the determination of vitamins and the method of determination used in each case are shown in table 5. The measurement results are reported in simplified form in table 5 in accordance with DIN EN ISO/IEC 17025:2018, Section 7.8.1.3.

TABLE 5
Results of the determination of vitamins

| Vitamin | Result | Unit | Measurement method |
|---|---|---|---|
| Vitamin B1 (expressed | 0.38 | mg/kg | DIN EN 14122: 2014-08 |
| as thiamine chloride- | | | |
| HCl) | | | |
| Vitamin B2 (HPLC, | <0.50 | mg/kg | DIN EN 14152: 2014-08 |
| expressed as | | | |
| riboflavin) | | | |
| Vitamin B6 (expressed | 1.93 | mg/kg | DIN EN 14663: 2006-03 |
| as pyridoxine-HCl) | | | |
| Vitamin B12 | <3.00 | μg/kg | USP 39, method 171: |
| (cyanocobalamin) | | | 2016 |
| Niacin (expressed as | 31.8 | mg/kg | USP 34, method 441: |
| nicotinic acid) | | | 2011 |
| Biotin | 66.4 | μg/kg | USP 21, 3. suppl, |
| | | | method 88: 1986 |
| Pantothenic acid | 2.88 | mg/kg | USP 39, method 91: 2016 |
| (expressed as D- | | | |
| pantothenic acid) | | | |
| Folic acid | 286 | μg/kg | DIN EN 14131: 2003-09 |
| Vitamin A (retinol) | <1000 | IU/kg | REG(EC) 152/2009, IV, A: |
| | | | 2009-02 |
| Vitamin D3 | <1000 | IU/kg | VDLUFA III, 13.8.1: 2007 |
| Vitamin E (expressed | <3.00 | mg/kg | REG(EC) 152/2009, IV, B: |
| as DL-α-tocopherol) | | | 2009-02 |
| Vitamin E (expressed | <3.30 | | REG(EC) 152/2009, IV, B: |
| as DL-α-tocopherol | | | 2009-02 |
| acetate) | | | |
| Vitamin K1 | <20.0 | mg/kg | QMP_504_KI_52_028: |
| | | | 2020-06 (HPLC) |
| Vitamin C (L-ascorbic | <10.0 | μg/kg | QMP_504_KI_52_020: |
| acid) | | | 2018-02 (HPLC) |
| Vitamin D2 | <1000 | mg/kg | VDLUFA III, 13.8.1: 2007 |
| Vitamin K3 | <1.0 | IU/kg | QMP_504_KI_52_022: |
| (menadione) | | | 2017-12 (HPLC) |

Further in-house studies on oat fibers produced according to the above example B1 have shown that oat fibers with a content of minerals, trace elements and vitamins as listed above in table 4 and table 5 result in particularly advantageous properties of oat composite articles produced therefrom with regard to industrial compostability and home compostability.

The proportion of dietary fiber was determined in accordance with AOAC 991.43 and AOAC 2009.1; the proportion of high molecular weight dietary fiber, HMWDF, and the proportion of soluble dietary fiber, SDF, were determined in accordance with AOAC 991.43, and the total amount of dietary fiber, TDF, was determined in accordance with AOAC 2009.1.

The proportion of high molecular weight dietary fiber, HMWDF, determined in accordance with AOAC 991.43, was 84.10 g/100 g of sample. The amount of soluble dietary fiber, SDFS, determined in accordance with AOAC 991.43, was below the determination limit of 0.50 g/100 g of sample. The total amount of dietary fiber, TDF, determined in accordance with AOAC 2009.1, was 84.60 g/100 g of sample.

In addition, Enterobacteriaceae were determined in accordance with ISO 21528-2: 2017-06 in oat fibers produced according to example B1 above; the result was a value of 230 cfu/g.

The two mycotoxins “deoxynivalenol” and “zearalenone” were determined by HPLC MS/MS in oat fibers produced according to example B1 above. Both values were below the respective determination limit of 100 μg/kg for deoxynivalenol and 5 μg/kg for zearalenone.

### EXAMPLE B2-2: ANALYSIS OF SPELT FIBER CONSTITUENTS

According to the procedure in example B1 above, spelt fibers were produced from spelt husks and analyzed. The respective measurement methods and results used are listed in table 6; the measurement results are listed in simplified form in table 6 in accordance with DIN EN ISO/IEC 17025:2018, Section 7.8.1.3.

TABLE 6
Analysis results for spelt fibers produced according to example B1.

| | Proportion | |
|---|---|---|
| | [g/100 g of | |
| Constituent | sample] | Measurement method |
| Protein (N × 6.25) | 6.44 | §64 LFGB L 17.00-15: 2013 August |
| Fructose | <0.10 | DIN 10758: 1997 May |
| Glucose | <0.10 | DIN 10758: 1997 May |
| Lactose | <0.10 | DIN 10758: 1997 May |
| Maltose | <0.10 | DIN 10758: 1997 May |
| Sucrose | 0.24 | DIN 10758: 1997 May |
| Sugar | 0.24 | Calculated |
| Total fat | 0.98 | §64 LFGB L 17.00-4: 2017 October |
| Raw ash | 3.87 | §64 LFGB L 17.00-3: 2002 December |
| Water | 6.79 | §64 LFGB L 17.00-1: 2002 December |

### EXAMPLE B3: COMPOUNDING

The selection of the oat fibers in this example is merely an example; it is equally possible to use oat fibers produced from oat hulls. In particular, compound materials can also be produced in an equivalent manner by the procedure described in this example using cereal fibers that are not oat fibers. The selection of polymer materials in this example is likewise merely illustrative. The person skilled in the art, depending on the requirements of each individual case, will also independently choose other suitable polymer materials and conduct appropriate compounding.

### B3-1: EXAMPLE SAMPLES

TABLE 7
Formulations R1, R2, R3, R4, R5, R6, R7, R8 and
R9 for oat composite articles of the invention

| | Polymer material | | Natural fiber | |
|---|---|---|---|---|
| | | Proportion | | Proportion |
| Formulation | Name | [% by wt.] | Name | [% by wt.] |
| R1 | PBS^{[T7-3]} | 70.00 | Oat fiber^{[T7-1]} | 30.00 |
| R2 | PBS^{[T7-3]} | 65.00 | Oat fiber^{[T7-1]} | 35.00 |
| R3 | PHA^{[T7-4]} | 70.00 | Oat fiber^{[T7-1]} | 30.00 |
| R4 | PHA^{[T7-4]} | 65.00 | Oat fiber^{[T7-1]} | 35.00 |
| R5 | PBAT-PLA^{[T7-5]} | 90.00 | Oat fiber^{[T7-2]} | 10.00 |
| R6 | PBAT-PLA^{[T7-5]} | 85.00 | Oat fiber^{[T7-2]} | 15.00 |
| R7 | PBAT-PLA^{[T7-5]} | 80.00 | Oat fiber^{[T7-2]} | 20.00 |
| R8 | PBAT-PLA^{[T7-5]} | 80.00 | Oat fiber^{[T7-2]} | 5.00 |
| | | | Softwood fiber^{[T7-6]} | 15.00 |
| R9 | PBSA^{[T7-7]} | 50.00 | Oat fiber^{[T7-8]} | 50.00 |

^{[T7-1]}Commercially available as O120 from Westfiber
^{[T7-2]}Commercially available as O400 from Westfiber
^{[T7-3]}Commercially available as PBS Regiogradable from Biovox
^{[T7-4]}Commercially available as PHI 002 from NaturePlast
^{[T7-5]}Commercially available as ecovio ® from BASF
^{[T7-6]}Commercially available as C120 from Westerkamp
^{[T7-7]}Commercially available as BioPBS ™ FD92PM from Mitsubishi Chemical Performance Polymers, Inc.
^{[T7-8]}The oat fibers used here were oat fibers having a proportion of bran (oat hull bran); the oat fibers used in formulation R9 had a sugar content (expressed as sucrose) of 0.60% by weight and a proportion of starch (polar) of 12.00% by weight, based in each case on the total mass of the oat fibers used in formulation R9.

Oat fibers produced by the above example B1 were compounded according to the compositions given in table 7 respectively with
polybutylene succinate (PBS),
polyhydroxyalkanoate (PHA),
the polymerization product of succinic acid, butane-1,4-diol and adipic acid (PBSA)
   or
a mixture comprising polybutylene adipate terephthalate (PBAT) and polylactic acid (PLA).

The mixture comprising polybutylene adipate terephthalate (PBAT) and polylactic acid (PLA) is also abbreviated hereinafter as PBAT-PLA.

The polybutylene succinate (PBS) used was “PBS Regiogradable”, commercially available from the manufacturer “Biovox”.

The polyhydroxyalkanoate (PHA) used was “PHI 002”, commercially available from the manufacturer “NaturePlast”.

The PBSA used was BioPBS™ FD92PM, commercially available from the manufacturer “Mitsubishi Chemical Performance Polymers, Inc.”.

The PBAT-PLA used was “Ecovio®”, commercially available from the manufacturer “BASF”.

In each case, according to the formulations R1 to R9 (R1, R2, R3, R4, R5, R6, R7, R8 and R9) specified in table 7, compounding with subsequent extrudate pelletization was conducted in a co-rotating twin-screw extruder (ZE 42 Basic (×46D) type from KraussMaffei Extrusion) at 225 revolutions per minute and with the SK ZW40-MB extruder head, and a perforated nozzle for extrudate pelletization with dimensions of 9 mm×4.0 mm, so as to result in pelletized oat composite.

The processing temperatures in the device zones zone 1 to zone 8 were each chosen as follows: zone 1=25° C., zone 2=210° C., zone 3=210° C., zone 4=190° C., zone 5=190° C., zone 6=190° C., zone 7=205° C. and zone 8=205° C. The compounded extrudates were cooled at 15° C. to 20° C. in a water bath with downstream extrudate pelletization.

### B3-2: REFERENCE SAMPLES

TABLE 8
Comparison formulations VR1, VR2, VR3, VR4, VR5
and VR6 for noninventive comparative pellets

| | Polymer material | | Natural fiber | |
|---|---|---|---|---|
| Comparison | | Proportion | | Proportion |
| formulation | Name | [% by wt.] | Name | [% by wt.] |
| VR1 | PBS^{[T8-1]} | 70.00 | Birch | 30.00 |
| | | | bark fiber^{[T8-3]} | |
| VR2 | PBS^{[T8-1]} | 75.00 | Birch | 25.00 |
| | | | bark fiber^{[T8-3]} | |
| VR3 | PBS^{[T8-1]} | 70.00 | Softwood fiber^{[T8-4]} | 30.00 |
| VR4 | PBAT-PLA^{[T8-2]} | 80.00 | Sunflower | 20.00 |
| | | | hull fiber^{[T8-5]} | |
| VR5 | PBAT-PLA^{[T8-2]} | 85.00 | Sunflower | 15.00 |
| | | | hull fiber^{[T8-5]} | |
| VR6 | PBAT-PLA^{[T8-2]} | 90 | Sunflower | 10.00 |
| | | | hull fiber^{[T8-5]} | |

^{[T8-1]}Commercially available as PBS Regiogradable from Biovox
^{[T8-2]}Commercially available as ecovio ® from BASF
^{[T8-3]}Commercially available as B120 from Westfiber GmbH
^{[T8-4]}Commercially available as C120 from Westerkamp GmbH
^{[T8-5]}Ground sunflower hulls obtained by preliminary crushing and subsequent grinding on an impact disk mill and screening on a plane sifter to 120 μm.

In each case, according to the formulations VR1 to VR4 specified in table 8, compounding with subsequent extrudate pelletization was conducted in a co-rotating twin-screw extruder (ZE 42 Basic (×46D) type from KraussMaffei Extrusion) at 225 revolutions per minute and with the SK ZW40-MB extruder head, and a perforated nozzle for extrudate pelletization with dimensions of 9 mm×4.0 mm, so as to result in noninventive comparative pellets.

The processing temperatures in the device zones zone 1 to zone 8 were each chosen as follows: zone 1=25° C., zone 2=210° C., zone 3=210° C., zone 4=190° C., zone 5=190° C., zone 6=190° C., zone 7=205° C. and zone 8=205° C. The compounded extrudates were cooled at 15° C. to 20° C. in a water bath with downstream extrudate pelletization.

### EXAMPLE B4: RESIDUAL MATERIAL MOISTURE CONTENT

According to the formulations R1, R2, R3, R4, R5, R6, R7, R8 and R9 in table 7 above, pelletized oat composites were each produced according to the procedure in the above example B3, section 3-1.

Formulation R1 afforded a pelletized oat composite from which a sample P1-B4 was taken; formulation R2 afforded a pelletized oat composite from which a sample P2-B4 was taken; formulation R3 afforded a pelletized oat composite from which a sample P3-B4 was taken; formulation R4 afforded a pelletized oat composite from which a sample P4-B4 was taken; formulation R5 afforded a pelletized oat composite from which a sample P5-B4 was taken; formulation R6 afforded a pelletized oat composite from which a sample P6-B4 was taken; formulation R7 afforded a pelletized oat composite from which a sample P7-B4 was taken; formulation R8 afforded a pelletized oat composite from which a sample P8-B4 was taken; formulation R9 afforded a pelletized oat composite from which a sample P9-B4 was taken.

In each case, the samples were taken immediately after pelletization and then transferred immediately to a drying cabinet.

According to comparative formulations VR1, VR2, VR3, VR4, VR5 and VR6 in table 8 above, comparative pellets were produced in each case according to the procedure in the above example B3, section 3-2.

Comparative formulation VR1 afforded comparative pellets from which a comparative sample VP1-B4 was taken; comparative formulation VR2 afforded comparative pellets from which a comparative sample VP2-B4 was taken; comparative formulation VR3 afforded comparative pellets from which a comparative sample VP3-B4 was taken; comparative formulation VR4 afforded comparative pellets from which a comparative sample VP4-B4 was taken; comparative formulation VR5 afforded comparative pellets from which a comparative sample VP5-B4 was taken; comparative formulation VR6 afforded comparative pellets from which a comparative sample VP6-B4 was taken.

In each case, the comparative samples were taken immediately after pelletization and then transferred immediately to a drying cabinet.

Samples P1-B4, P2-B4, P3-B4, P4-B4, P5-B4, P6-B4, P7-B4, P8-B4 and P9-B4 and comparative samples VP1-B4, VP2-B4, VP3-B4, VP4-B4, VP5-B4 and VP6-B4 were dried at 80° C. in a drying cabinet over a period of 16 h. Immediately thereafter, the residual material moisture content was determined in accordance with DIN EN ISO 15512:2019, method E, using an Aquatrac-V analyzer from Brabender®.

The residual material moisture content of samples P1-B4, P2-B4, P3-B4 and P4-B4 was in the range from 0.49% to 0.56%.

The residual material moisture content of samples P5-B4, P6-B4 and P7-B4 was in the range from 0.037% to 0.087%.

The residual material moisture content of sample P8-B4 was 0.081%.

The residual material moisture content of comparative samples VP1-B4 and VP2-B4 was in the range from 0.18% to 0.375%.

The residual material moisture content of comparative sample VP3-B4 was 1.33%.

The residual material moisture content of comparative sample VP4-B4 was 0.141%.

The residual material moisture content of comparative sample VP5-B4 was 0.123%.

The residual material moisture content of comparative sample VP6-B4 was 0.098%.

### EXAMPLE B5: INJECTION MOLDING

According to formulations R1, R2, R3, R4, R5, R6, R7, R8 and R9 in table 7 above, pelletized oat composite was produced in each case according to the procedure in the above example B3, section 3-1.

Formulation R1 afforded a pelletized oat composite G1-B5; formulation R2 afforded a pelletized oat composite G2-B5; formulation R3 afforded a pelletized oat composite G3-B5; formulation R4 afforded a pelletized oat composite G4-B5; formulation R5 afforded a pelletized oat composite G5-B5; formulation R6 afforded a pelletized oat composite G6-B5; formulation R7 afforded a pelletized oat composite G7-B5; formulation R8 afforded a pelletized oat composite G8-B5; formulation R9 afforded a pelletized oat composite G9-B5.

In each case, the pelletized oat composites were transferred to a drying cabinet immediately after pelletization, where they were dried at 80° C. over a period of 16 h. They were then taken from the drying cabinet and immediately thereafter processed in a KraussMaffei KM 50-180 AX injection molding machine to give type A test specimens standardized in accordance with DIN EN ISO 3167, and also to give staircase plaques and to give plaques (test plaques) having a thickness of 0.4 mm and a length and width of at least 2.5 cm each. The staircase plaques had a width of 56 mm and a length of 90 mm, with material thicknesses arranged in staircase form over the full width, graduated from 3 mm to 2 mm to 1 mm. The individual steps each had surface dimensions of 56 mm by 30 mm in top view.

The processing target temperatures present in the injection molding operation are listed in table 9.

TABLE 9
Processing target temperatures in the injection molding operation
with the Krauss-Maffei KM 50-180 AX injection molding machine

| | Temperature [°C] | | | | | | | |
|---|---|---|---|---|---|---|---|---|
| Polymer | | Zone | Zone | Zone | Zone | Zone | Zone | |
| material | Flange | 1 | 2 | 3 | 4 | 11 | 13 | Mold |
| PBS^{[T9-1]} | 35 | 120 | 145 | 160 | 180 | 200 | — | 35 |
| PHA^{[T9-2]} | 35 | 120 | 130 | 140 | 180 | 190 | — | 35 |
| PBAT- | 60 | 150 | 160 | 170 | 180 | 190 | 195 | 25 |
| PLA^{[T9-3]} | | | | | | | | |

^{[T9-1]}Commercially available as PBS Regiogradable from Biovox
^{[T9-2]}Commercially available as PHI 002 from NaturePlast
^{[T9-3]}Commercially available as ecovio ® from BASF

According to comparative formulations VR1, VR2, VR3, VR4, VR5 and VR6 in table 8 above, comparative pellets were produced in each case according to the procedure in the above example B3, section 3-2.

Comparative formulation VR1 afforded comparative pellets VG1-B5; comparative formulation VR2 afforded comparative pellets VG2-B5; comparative formulation VR3 afforded comparative pellets VG3-B5; comparative formulation VR4 afforded comparative pellets VG4-B5; comparative formulation VR5 afforded comparative pellets VG5-B5; comparative formulation VR6 afforded comparative pellets VG6-B5.

In each case, the pellets were transferred to a drying cabinet immediately after pelletization, where they were dried at 80° C. over a period of 16 h. They were then taken from the drying cabinet and immediately thereafter processed in a KraussMaffei KM 50-180 AX injection molding machine to give type A comparative test specimens standardized in accordance with DIN EN ISO 3167, and also to give comparative staircase plaques and to give plaques (test plaques) having a thickness of 0.4 mm and a length and width of at least 2.5 cm each. The processing target temperatures present in the injection molding operation are listed in table 9.

Pelletized oat composite G1-B5 afforded test specimens of the PK1-B5 type and staircase plaques of the TP1-B5 type and test plaques of the TESTPLATTE1-B5 type; pelletized oat composite G2-B5 afforded test specimens of the PK2-B5 type and staircase plaques of the TP2-B5 type and test plaques of the TESTPLATTE2-B5 type; pelletized oat composite G3-B5 afforded test specimens of the PK3-B5 type and staircase plaques of the TP3-B5 type and test plaques of the TESTPLATTE3-B5 type; pelletized oat composite G4-B5 afforded test specimens of the PK4-B5 type and staircase plaques of the TP4-B5 type and test plaques of the TESTPLATTE4-B5 type; pelletized oat composite G5-B5 afforded test specimens of the PK5-B5 type and staircase plaques of the TP5-B5 type and test plaques of the TESTPLATTE5-B5 type; pelletized oat composite G6-B5 afforded test specimens of the PK6-B5 type and staircase plaques of the TP6-B5 type and test plaques of the TESTPLATTE6-B5 type; pelletized oat composite G7-B5 afforded test specimens of the PK7-B5 type and staircase plaques of the TP7-B5 type and test plaques of the TESTPLATTE7-B5 type; pelletized oat composite G8-B5 afforded test specimens of the PK8-B5 type and staircase plaques of the TP8-B5 type and test plaques of the TESTPLATTE8-B5 type; pelletized oat composite G9-B5 afforded test specimens of the PK9-B5 type and staircase plaques of the TP9-B5 type and test plaques of the TESTPLATTE9-B5 type.

Comparative pellets VG1-B5 afforded comparative test specimens of the VPK1-B5 type and comparative staircase test specimens of the VTP1-B5 type; comparative pellets VG2-B5 afforded comparative test specimens of the VPK2-B5 type and comparative staircase test specimens of the VTP2-B5 type; comparative pellets VG3-B5 afforded comparative test specimens of the VPK3-B5 type and comparative staircase test specimens of the VTP3-B5 type; comparative pellets VG4-B5 afforded comparative test specimens of the VPK4-B5 type and comparative staircase test specimens of the VTP4-B5 type; comparative pellets VG5-B5 afforded comparative test specimens of the VPK5-B5 type and comparative staircase test specimens of the VTP5-B5 type; comparative pellets VG6-B5 afforded comparative test specimens of the VPK6-B5 type and comparative staircase test specimens of the VTP6-B5 type.

### EXAMPLE B5A: INJECTION MOLDING R9

According to formulation R9 in table 7 above, pelletized oat composite was produced according to the procedure in the above example B3, section 3-1.

Formulation R9 afforded a pelletized oat composite G9-B5.

The resultant pelletized oat composite G9-B5 was transferred to a drying cabinet immediately after pelletization, where it was dried at 80° C. over a period of 16 h. It was then taken from the drying cabinet and immediately thereafter processed in a KraussMaffei KM 50-180 AX injection molding machine to give type A test specimens standardized in accordance with DIN EN ISO 3167, and also to give staircase plaques and to give plaques (test plaques) having a thickness of 0.4 mm and a length and width of at least 2.5 cm each.

The staircase plaques had a width of 56 mm and a length of 90 mm, with material thicknesses arranged in staircase form over the full width, graduated from 3 mm to 2 mm to 1 mm. The individual steps each had surface dimensions of 56 mm by 30 mm in top view.

Pelletized oat composite G9-B5 afforded test specimens of the PK9-B5 type, staircase plaques of the TP9-B5 type and test plaques of the TESTPLATTE9-B5 type.

### EXAMPLE B6: ODOR ASSESSMENT

In accordance with the procedure in the above example B5, staircase plaques of the TP1-B5 type were produced, namely staircase plaques TP1-B6-01, TP1-B6-02, TP1-B6-03, TP1-B6-04, TP1-B6-05, TP1-B6-06, TP1-B6-07, TP1-B6-08, TP1-B6-09 and TP1-B6-10. In accordance with the procedure in the above example B5, staircase plaques of the TP2-B5 type were produced, namely staircase plaques TP2-B6-01, TP2-B6-02, TP2-B6-03, TP2-B6-04, TP2-B6-05, TP2-B6-06, TP2-B6-07, TP2-B6-08, TP2-B6-09 and TP2-B6-10. In accordance with the procedure in the above example B5, staircase plaques of the TP3-B5 type were produced, namely staircase plaques TP3-B6-01, TP3-B6-02, TP3-B6-03, TP3-B6-04, TP3-B6-05, TP3-B6-06, TP3-B6-07, TP3-B6-08, TP3-B6-09 and TP3-B6-10. In accordance with the procedure in the above example B5, staircase plaques of the TP4-B5 type were produced, namely staircase plaques TP4-B6-01, TP4-B6-02, TP4-B6-03, TP4-B6-04, TP4-B6-05, TP4-B6-06, TP4-B6-07, TP4-B6-08, TP4-B6-09 and TP4-B6-10. In accordance with the procedure in the above example B5, staircase plaques of the TP5-B5 type were produced, namely staircase plaques TP5-B6-01, TP5-B6-02, TP5-B6-03, TP5-B6-04, TP5-B6-05, TP5-B6-06, TP5-B6-07, TP5-B6-08, TP5-B6-09 and TP5-B6-10. In accordance with the procedure in the above example B5, staircase plaques of the TP6-B5 type were produced, namely staircase plaques TP6-B6-01, TP6-B6-02, TP6-B6-03, TP6-B6-04, TP6-B6-05, TP6-B6-06, TP6-B6-07, TP6-B6-08, TP6-B6-09 and TP6-B6-10. In accordance with the procedure in the above example B5, staircase plaques of the TP7-B5 type were produced, namely staircase plaques TP7-B6-01, TP7-B6-02, TP7-B6-03, TP7-B6-04, TP7-B6-05, TP7-B6-06, TP7-B6-07, TP7-B6-08, TP7-B6-09 and TP7-B6-10.

In accordance with the procedure in the above example B5, staircase plaques of the TP8-B5 type were produced, namely staircase plaques TP8-B6-01, TP8-B6-02, TP8-B6-03, TP8-B6-04, TP8-B6-05, TP8-B6-06, TP8-B6-07, TP8-B6-08, TP8-B6-09 and TP8-B6-10. In accordance with the procedure in the above example B5A, staircase plaques of the TP9-B5 type were produced, namely staircase plaques TP9-B6-01, TP9-B6-02, TP9-B6-03, TP9-B6-04, TP9-B6-05, TP9-B6-06, TP9-B6-07, TP9-B6-08, TP9-B6-09 and TP9-B6-10.

In accordance with the procedure in the above example B5, comparative staircase plaques of the VTP1-B5 type were produced, namely comparative staircase plaques VTP1-B6-01, VTP1-B6-02, VTP1-B6-03, VTP1-B6-04, VTP1-B6-05, VTP1-B6-06, VTP1-B6-07, VTP1-B6-08, VTP1-B6-09 and VTP1-B6-10. In accordance with the procedure in the above example B5, comparative staircase plaques of the VTP2-B5 type were produced, namely comparative staircase plaques VTP2-B6-01, VTP2-B6-02, VTP2-B6-03, VTP2-B6-04, VTP2-B6-05, VTP2-B6-06, VTP2-B6-07, VTP2-B6-08, VTP2-B6-09 and VTP2-B6-10. In accordance with the procedure in the above example B5, comparative staircase plaques of the VTP3-B5 type were produced, namely comparative staircase plaques VTP3-B6-01, VTP3-B6-02, VTP3-B6-03, VTP3-B6-04, VTP3-B6-05, VTP3-B6-06, VTP3-B6-07, VTP3-B6-08, VTP3-B6-09 and VTP3-B6-10. In accordance with the procedure in the above example B5, comparative staircase plaques of the VTP4-B5 type were produced, namely comparative staircase plaques VTP4-B6-01, VTP4-B6-02, VTP4-B6-03, VTP4-B6-04, VTP4-B6-05, VTP4-B6-06, VTP4-B6-07, VTP4-B6-08, VTP4-B6-09 and VTP4-B6-10. In accordance with the procedure in the above example B5, comparative staircase plaques of the VTP5-B5 type were produced, namely comparative staircase plaques VTP5-B6-01, VTP5-B6-02, VTP5-B6-03, VTP5-B6-04, VTP5-B6-05, VTP5-B6-06, VTP5-B6-07, VTP5-B6-08, VTP5-B6-09 and VTP5-B6-10. In accordance with the procedure in the above example B5, comparative staircase plaques of the VTP6-B5 type were produced, namely comparative staircase plaques VTP6-B6-01, VTP6-B6-02, VTP6-B6-03, VTP6-B6-04, VTP6-B6-05, VTP6-B6-06, VTP6-B6-07, VTP6-B6-08, VTP6-B6-09 and VTP6-B6-10.

All the staircase plaques and comparative staircase plaques produced in example B6 were dried in a drying cabinet at 80° C. over a period of 16 h.

The staircase plaques and comparative staircase plaques were then cooled to room temperature under ambient air. Then one staircase plaque of each type and one comparative staircase plaque of each type were submitted to a member of an untrained sensory panel consisting of ten evaluation testers. In the blind test, all members of the sensory panel evaluated intrinsic odor.

The intrinsic odor of the staircase plaques of the TP1-B5, TP2-B5, TP3-B5, TP4-B5, TP5-B5, TP6-B5, TP7-B5, TP8-B5 and TP9-B5 types were rated significantly more positively than the intrinsic odor of the staircase plaques of the VTP1-B5, VTP2-B5, VTP3-B5, VTP4-B5, VTP5-B5 and VTP6-B5 types. The intrinsic odor of the staircase plaques of the VTP4-B5, VTP5-B5 and VTP6-B5 types was rated as the least positive.

### EXAMPLE B7: COLOR EVALUATION AFTER INJECTION MOLDING

In accordance with the procedure in the above example B5, staircase plaques of the TP1-B5 type were produced, namely staircase plaques TP1-B7-01, TP1-B7-02, TP1-B7-03, TP1-B7-04, TP1-B7-05, TP1-B7-06, TP1-B7-07, TP1-B7-08, TP1-B7-09 and TP1-B7-10. In accordance with the procedure in the above example B5, staircase plaques of the TP2-B5 type were produced, namely staircase plaques TP2-B7-01, TP2-B7-02, TP2-B7-03, TP2-B7-04, TP2-B7-05, TP2-B7-06, TP2-B7-07, TP2-B7-08, TP2-B7-09 and TP2-B7-10. In accordance with the procedure in the above example B5, staircase plaques of the TP3-B5 type were produced, namely staircase plaques TP3-B7-01, TP3-B7-02, TP3-B7-03, TP3-B7-04, TP3-B7-05, TP3-B7-06, TP3-B7-07, TP3-B7-08, TP3-B7-09 and TP3-B7-10. In accordance with the procedure in the above example B5, staircase plaques of the TP4-B5 type were produced, namely staircase plaques TP4-B7-01, TP4-B7-02, TP4-B7-03, TP4-B7-04, TP4-B7-05, TP4-B7-06, TP4-B7-07, TP4-B7-08, TP4-B7-09 and TP4-B7-10. In accordance with the procedure in the above example B5, staircase plaques of the TP5-B5 type were produced, namely staircase plaques TP5-B7-01, TP5-B7-02, TP5-B7-03, TP5-B7-04, TP5-B7-05, TP5-B7-06, TP5-B7-07, TP5-B7-08, TP5-B7-09 and TP5-B7-10. In accordance with the procedure in the above example B5, staircase plaques of the TP6-B5 type were produced, namely staircase plaques TP6-B7-01, TP6-B7-02, TP6-B7-03, TP6-B7-04, TP6-B7-05, TP6-B7-06, TP6-B7-07, TP6-B7-08, TP6-B7-09 and TP6-B7-10. In accordance with the procedure in the above example B5, staircase plaques of the TP7-B5 type were produced, namely staircase plaques TP7-B7-01, TP7-B7-02, TP7-B7-03, TP7-B7-04, TP7-B7-05, TP7-B7-06, TP7-B7-07, TP7-B7-08, TP7-B7-09 and TP7-B7-10. In accordance with the procedure in the above example B5, staircase plaques of the TP8-B5 type were produced, namely staircase plaques TP8-B7-01, TP8-B7-02, TP8-B7-03, TP8-B7-04, TP8-B7-05, TP8-B7-06, TP8-B7-07, TP8-B7-08, TP8-B7-09 and TP8-B7-10. In accordance with the procedure in the above example B5A, staircase plaques of the TP9-B5 type were produced, namely staircase plaques TP9-B7-01, TP9-B7-02, TP9-B7-03, TP9-B7-04, TP9-B7-05, TP9-B7-06, TP9-B7-07, TP9-B7-08, TP9-B7-09 and TP9-B7-10.

In accordance with the procedure in the above example B5, comparative staircase plaques of the VTP1-B5 type were produced, namely comparative staircase plaques VTP1-B7-01, VTP1-B7-02, VTP1-B7-03, VTP1-B7-04, VTP1-B7-05, VTP1-B7-06, VTP1-B7-07, VTP1-B7-08, VTP1-B7-09 and VTP1-B7-10. In accordance with the procedure in the above example B5, comparative staircase plaques of the VTP2-B5 type were produced, namely comparative staircase plaques VTP2-B7-01, VTP2-B7-02, VTP2-B7-03, VTP2-B7-04, VTP2-B7-05, VTP2-B7-06, VTP2-B7-07, VTP2-B7-08, VTP2-B7-09 and VTP2-B7-10. In accordance with the procedure in the above example B5, comparative staircase plaques of the VTP3-B5 type were produced, namely comparative staircase plaques VTP3-B7-01, VTP3-B7-02, VTP3-B7-03, VTP3-B7-04, VTP3-B7-05, VTP3-B7-06, VTP3-B7-07, VTP3-B7-08, VTP3-B7-09 and VTP3-B7-10. In accordance with the procedure in the above example B5, comparative staircase plaques of the VTP4-B5 type were produced, namely comparative staircase plaques VTP4-B7-01, VTP4-B7-02, VTP4-B7-03, VTP4-B7-04, VTP4-B7-05, VTP4-B7-06, VTP4-B7-07, VTP4-B7-08, VTP4-B7-09 and VTP4-B7-10. In accordance with the procedure in the above example B5, comparative staircase plaques of the VTP5-B5 type were produced, namely comparative staircase plaques VTP5-B7-01, VTP5-B7-02, VTP5-B7-03, VTP5-B7-04, VTP5-B7-05, VTP5-B7-06, VTP5-B7-07, VTP5-B7-08, VTP5-B7-09 and VTP5-B7-10. In accordance with the procedure in the above example B5, comparative staircase plaques of the VTP6-B5 type were produced, namely comparative staircase plaques VTP6-B7-01, VTP6-B7-02, VTP6-B7-03, VTP6-B7-04, VTP6-B7-05, VTP6-B7-06, VTP6-B7-07, VTP6-B7-08, VTP6-B7-09 and VTP6-B7-10.

All the staircase plaques and comparative staircase plaques produced in example B7 were dried in a drying cabinet at 80° C. over a period of 16 h.

The staircase plaques and comparative staircase plaques were then cooled to room temperature under ambient air. Then one staircase plaque of each type and one comparative staircase plaque of each type were submitted to a member of an untrained panel consisting of ten evaluation testers. In the blind test, the lightness of the color impression, which is frequently desired in the field of the present invention and is perceived as being positive, was evaluated.

The lightness of the color impression of the inventive staircase plaques of the types TP1-B5, TP2-B5, TP3-B5, TP4-B5, TP5-B5, TP6-B5, TP7-B5, TP8-B5 and TP9-B5 was rated significantly more positively on average than that of the comparative staircase plaques of the VTP1-B5, VTP2-B5, VTP3-B5, VTP5-B5 and VTP6-B5 types.

The lightness of the color impression of the staircase plaques of the TP1-B5, TP2-B5, TP3-B5 and TP4-B5 types was rated the most positively by all members of the panel.

In addition, in-house tests have shown that the inventive staircase plaques of the TP1-B5, TP2-B5, TP3-B5, TP4-B5, TP5-B5, TP6-B5, TP7-B5, TP8-B5 and TP9-B5 types were printable both with brown and black ink with very good contrast by conventional printing methods. The best results were achieved with the staircase plaques of the TP1-B5, TP2-B5, TP3-B5, TP4-B5 types. Tests of the printability of the comparative staircase plaques produced led to less advantageous results in all cases.

### EXAMPLE B8—DETERMINATION OF MELT MASS FLOW RATE (MFR) AND MELT VOLUME FLOW RATE (MVR)

According to the formulations R1, R2, R3 and R4 in table 7 above, pelletized oat composites were each produced according to the procedure in the above example B3, section 3-1.

Formulation R1 afforded a pelletized oat composite G1-B8; the formulation R2 afforded a pelletized oat composite G2-B8; the formulation R3 afforded a pelletized oat composite G3-B8; the formulation R4 afforded a pelletized oat composite G4-B8.

In each case, the pelletized oat composites were transferred to a drying cabinet immediately after pelletization, where they were dried at 80° C. over a period of 16 h. They were then taken from the drying cabinet and immediately thereafter processed in a KraussMaffei KM 50-180 AX injection molding machine to give type A test specimens standardized in accordance with DIN EN ISO 3167, and also to give staircase plaques. The processing target temperatures present in the injection molding operation are listed in table 9.

According to the comparative formulations VR1, VR2 and VR3 in table 8 above, comparative pellets were each produced according to the procedure in the above example B3, section 3-2.

Comparative formulation VR1 afforded comparative pellets VG1-B8; comparative formulation VR2 afforded comparative pellets VG2-B8; comparative formulation VR3 afforded comparative pellets VG3-B8.

In each case, the pelletized oat composites and the comparative pellets were transferred to a drying cabinet immediately after pelletization, where they were dried at 80° C. over a period of 16 h.

For pelletized oat composites produced in example B8 and for comparative pellets produced in example B8, melt mass flow rate (MFR) and melt volume flow rate (MVR) were determined in accordance with method B of DIN EN ISO 1133-1:2011; a load of 5 kg and a test temperature of 190° C. were chosen in each case. A specified piston travel of 2 mm was chosen in each case for method B of DIN EN ISO 1133-1:2011 in the context of point 12 g).

The results of the respective determinations are listed in tables 10 to 16.

In each of tables 10 to 16:

MFR means melt mass flow rate in accordance with DIN EN ISO 1133-1:2011. MFR denotes the mean of the melt mass flow rate values obtained from a cylinder filling in accordance with point 12 h) of DIN EN ISO 1133-1:2011. MFR means melt volume flow rate in accordance with DIN EN ISO 1133-1:2011. MVR denotes the mean of the melt volume flow rate values obtained from a cylinder filling in accordance with point 12 h) of DIN EN ISO 1133-1:2011. The term “measurement time” denotes the duration of the measurement in the context of point 12 g) for method B of DIN EN ISO 1133-1:2011. The travel of the piston in the context of point 12 g) for method B of DIN EN ISO 1133-1:2011 is found from the difference between the respective piston positions at the start and end of the measurement.

TABLE 10
Measurement results for pellets G1-B8

| | | | | | | | Piston | Piston |
|---|---|---|---|---|---|---|---|---|
| | Index | | | | | | position | position |
| Cylinder | number | | | | | Measurement | at start of | at end of |
| filling | of the | MFRₙ | M̅F̅R̅ | MVRₙ | M̅V̅R̅ | time | measurement | measurement |
| no. | measurement | [g/10 min] | [g/10 min] | [cm³/10 min] | [cm³/10 min] | [s] | [mm] | [mm] |
| 1 | 1 | 23.41 | 23.53 | 19.08 | 19.10 | 4.48 | 47.82 | 45.79 |
| | 2 | 23.48 | | 19.18 | | 4.45 | 45.79 | 43.83 |
| | 3 | 23.43 | | 19.11 | | 4.47 | 43.83 | 41.82 |
| | 4 | 23.61 | | 19.04 | | 4.48 | 41.82 | 39.81 |
| | 5 | 23.60 | | 19.14 | | 4.47 | 39.81 | 37.84 |
| | 6 | 23.36 | | 19.02 | | 4.49 | 37.84 | 35.83 |
| | 7 | 23.62 | | 19.16 | | 4.46 | 35.83 | 33.82 |
| | 8 | 23.54 | | 19.03 | | 4.498 | 33.82 | 31.81 |
| | 9 | 23.56 | | 19.05 | | 4.49 | 31.81 | 29.79 |
| | 10 | 23.69 | | 19.21 | | 4.45 | 29.79 | 27.81 |
| 2 | 1 | 23.94 | 23.76 | 19.65 | 19.31 | 1.22 | 49.16 | 47.18 |
| | 2 | 23.75 | | 19.26 | | 1.23 | 47.18 | 45.16 |
| | 3 | 23.88 | | 19.33 | | 1.24 | 45.16 | 43.16 |
| | 4 | 23.89 | | 19.70 | | 1.21 | 43.16 | 41.18 |
| | 5 | 23.77 | | 19.22 | | 1.24 | 41.18 | 39.15 |
| | 6 | 23.54 | | 19.22 | | 1.22 | 39.15 | 37.18 |
| | 7 | 23.69 | | 19.23 | | 1.23 | 37.18 | 35.19 |
| | 8 | 23.74 | | 19.43 | | 1.22 | 35.19 | 33.20 |
| | 9 | 23.73 | | 18.80 | | 1.26 | 33.20 | 31.16 |
| | 10 | 23.67 | | 19.25 | | 1.23 | 31.16 | 29.17 |

TABLE 11
Measurement results for pellets G2-B8

| | | | | | | | Piston | Piston |
|---|---|---|---|---|---|---|---|---|
| | Index | | | | | | position | position |
| Cylinder | number | MFRₙ | M̅F̅R̅ | MVRₙ | M̅V̅R̅ | Measurement | at start of | at end of |
| filling | of the | [g/10 | [g/10 | [cm³/10 | [cm³/10 | time | measurement | measurement |
| no. | measurement | min] | min] | min] | min] | [s] | [mm] | [mm] |
| 1 | 1 | 16.24 | 16.79 | 13.06 | 13.48 | 6.54 | 54.43 | 52.44 |
| | 2 | 16.61 | | 13.32 | | 6.41 | 52.44 | 50.45 |
| | 3 | 16.74 | | 13.45 | | 6.35 | 50.45 | 48.43 |
| | 4 | 16.85 | | 13.52 | | 6.32 | 48.43 | 46.43 |
| | 5 | 16.80 | | 13.50 | | 6.33 | 46.43 | 44.44 |
| | 6 | 16.86 | | 13.54 | | 6.31 | 44.44 | 42.45 |
| | 7 | 17.06 | | 13.73 | | 6.21 | 42.45 | 40.45 |
| | 8 | 16.94 | | 13.59 | | 6.29 | 40.45 | 38.45 |
| | 9 | 16.91 | | 13.58 | | 6.29 | 38.45 | 36.44 |
| | 10 | 16.85 | | 13.53 | | 6.31 | 36.44 | 34.45 |
| 2 | 1 | 15.92 | 17.10 | 12.80 | 13.73 | 6.67 | 47.79 | 45.78 |
| | 2 | 16.46 | | 13.29 | | 6.43 | 45.78 | 43.80 |
| | 3 | 16.64 | | 13.32 | | 6.41 | 43.80 | 41.79 |
| | 4 | 16.75 | | 13.49 | | 6.33 | 41.79 | 39.80 |
| | 5 | 17.12 | | 13.68 | | 6.24 | 39.80 | 37.79 |
| | 6 | 17.50 | | 14.06 | | 6.07 | 37.79 | 35.78 |
| | 7 | 17.41 | | 13.96 | | 6.12 | 35.78 | 33.78 |
| | 8 | 17.79 | | 14.27 | | 5.99 | 33.78 | 31.78 |
| | 9 | 17.71 | | 14.19 | | 6.02 | 31.78 | 29.78 |
| | 10 | 17.74 | | 14.25 | | 5.99 | 29.78 | 27.78 |

TABLE 12
Measurement results for pellets G3-B8

| | | | | | | | Piston | Piston |
|---|---|---|---|---|---|---|---|---|
| | Index | | | | | | position | position |
| Cylinder | number | MFRₙ | M̅F̅R̅ | MVRₙ | M̅V̅R̅ | Measurement | at start of | at end of |
| filling | of the | [g/10 | [g/10 | [cm³/10 | [cm³/10 | time | measurement | measurement |
| no. | measurement | min] | min] | min] | min] | [s] | [mm] | [mm] |
| 1 | 1 | — | — | 99.83 | 103.23 | 0.86 | 62.68 | 60.77 |
| | 2 | — | | 110.97 | | 0.77 | 60.77 | 58.71 |
| | 3 | — | | 102.65 | | 0.83 | 58.71 | 56.79 |
| | 4 | — | | 102.29 | | 0.84 | 56.79 | 54.62 |
| | 5 | — | | 101.53 | | 0.84 | 54.62 | 52.74 |
| | 6 | — | | 101.75 | | 0.84 | 52.74 | 50.59 |
| | 7 | — | | 103.55 | | 0.82 | 50.59 | 48.65 |
| | 8 | — | | 101.77 | | 0.84 | 48.65 | 46.74 |
| | 9 | — | | 104.17 | | 0.82 | 46.74 | 44.80 |
| | 10 | — | | 103.80 | | 0.82 | 44.80 | 42.85 |
| 2 | 1 | — | — | 104.22 | 100.77 | 0.82 | 57.72 | 55.74 |
| | 2 | — | | 101.51 | | 0.84 | 55.74 | 53.86 |
| | 3 | — | | 100.17 | | 0.85 | 53.86 | 51.76 |
| | 4 | — | | 100.43 | | 0.85 | 51.76 | 49.87 |
| | 5 | — | | 100.79 | | 0.85 | 49.87 | 47.74 |
| | 6 | — | | 101.25 | | 0.84 | 47.74 | 45.84 |
| | 7 | — | | 99.28 | | 0.86 | 45.84 | 43.76 |
| | 8 | — | | 99.84 | | 0.85 | 43.76 | 41.65 |
| | 9 | — | | 100.81 | | 0.85 | 41.65 | 39.76 |
| | 10 | — | | 99.40 | | 0.86 | 39.76 | 37.68 |

TABLE 13
Measurement results for pellets G4-B8

| | | | | | | | Piston | Piston |
|---|---|---|---|---|---|---|---|---|
| | Index | | | | | | position | position |
| Cylinder | number | MFRₙ | M̅F̅R̅ | MVRₙ | M̅V̅R̅ | Measurement | at start of | at end of |
| filling | of the | [g/10 | [g/10 | [cm³/10 | [cm³/10 | time | measurement | measurement |
| no. | measurement | min] | min] | min] | min] | [s] | [mm] | [mm] |
| 1 | 1 | — | — | 90.65 | 91.03 | 0.94 | 37.29 | 35.38 |
| | 2 | — | | 89.43 | | 0.95 | 35.38 | 33.28 |
| | 3 | — | | 89.87 | | 0.95 | 33.28 | 31.38 |
| | 4 | — | | 90.09 | | 0.95 | 31.38 | 29.28 |
| | 5 | — | | 91.12 | | 0.94 | 29.28 | 27.36 |
| | 6 | — | | 91.09 | | 0.94 | 27.36 | 25.44 |
| | 7 | — | | 91.85 | | 0.93 | 25.44 | 23.28 |
| | 8 | — | | 91.65 | | 0.93 | 23.28 | 21.35 |
| | 9 | — | | 93.12 | | 0.92 | 21.35 | 19.39 |
| | 10 | — | | 91.42 | | 0.93 | 19.39 | 17.24 |
| 2 | 1 | — | — | 93.47 | 94.22 | 0.91 | 64.38 | 62.38 |
| | 2 | — | | 95.07 | | 0.90 | 62.38 | 60.40 |
| | 3 | — | | 94.30 | | 0.91 | 60.40 | 58.43 |
| | 4 | — | | 95.51 | | 0.89 | 58.43 | 56.41 |
| | 5 | — | | 94.36 | | 0.91 | 56.41 | 54.42 |
| | 6 | — | | 95.07 | | 0.90 | 54.42 | 52.41 |
| | 7 | — | | 93.81 | | 0.91 | 52.41 | 50.44 |
| | 8 | — | | 94.80 | | 0.90 | 50.44 | 48.42 |
| | 9 | — | | 91.78 | | 0.93 | 48.42 | 46.52 |
| | 10 | — | | 94.02 | | 0.91 | 46.52 | 44.31 |

TABLE 14
Measurement results for comparative pellets VG1-B8

| | | | | | | | Piston | Piston |
|---|---|---|---|---|---|---|---|---|
| | Index | | | | | | position | position |
| Cylinder | number | MFRₙ | M̅F̅R̅ | MVRₙ | M̅V̅R̅ | Measurement | at start of | at end of |
| filling | of the | [g/10 | [g/10 | [cm³/10 | [cm³/10 | time | measurement | measurement |
| no. | measurement | min] | min] | min] | min] | [s] | [mm] | [mm] |
| 451 | 1 | 30.46 | 32.30 | 26.57 | 28.23 | 3.22 | 47.17 | 45.17 |
| | 2 | 30.64 | | 27.01 | | 3.16 | 45.17 | 43.15 |
| | 3 | 31.29 | | 27.41 | | 3.12 | 43.15 | 41.16 |
| | 4 | 31.77 | | 27.88 | | 3.06 | 41.16 | 39.20 |
| | 5 | 31.88 | | 27.75 | | 3.08 | 39.20 | 37.19 |
| | 6 | 32.53 | | 28.35 | | 3.01 | 37.19 | 35.19 |
| | 7 | 33.04 | | 28.80 | | 2.97 | 35.19 | 33.16 |
| | 8 | 33.34 | | 29.26 | | 2.92 | 33.16 | 31.18 |
| | 9 | 33.81 | | 29.49 | | 2.90 | 31.18 | 29.17 |
| | 10 | 34.19 | | 29.76 | | 2.87 | 29.17 | 27.15 |
| 2 | 1 | 30.18 | 32.18 | 26.42 | 28.14 | 3.23 | 49.68 | 47.70 |
| | 2 | 30.58 | | 26.75 | | 3.19 | 47.70 | 45.69 |
| | 3 | 31.22 | | 27.32 | | 3.13 | 45.69 | 43.70 |
| | 4 | 31.30 | | 27.50 | | 3.10 | 43.70 | 41.71 |
| | 5 | 31.99 | | 27.94 | | 3.06 | 41.71 | 39.68 |
| | 6 | 32.54 | | 28.53 | | 2.99 | 39.68 | 37.67 |
| | 7 | 32.69 | | 28.58 | | 2.99 | 37.67 | 35.67 |
| | 8 | 33.59 | | 29.14 | | 2.93 | 35.67 | 33.69 |
| | 9 | 33.75 | | 29.57 | | 2.89 | 33.69 | 31.68 |
| | 10 | 33.97 | | 29.72 | | 2.87 | 31.68 | 29.66 |

TABLE 15
Measurement results for comparative pellets VG2-B8

| | | | | | | | Piston | Piston |
|---|---|---|---|---|---|---|---|---|
| | Index | | | | | | position | position |
| Cylinder | number | MFRₙ | M̅F̅R̅ | MVRₙ | M̅V̅R̅ | Measurement | at start of | at end of |
| filling | of the | [g/10 | [g/10 | [cm³/10 | [cm³/10 | time | measurement | measurement |
| no. | measurement | min] | min] | min] | min] | [s] | [mm] | [mm] |
| 1 | 1 | 39.70 | 41.07 | 34.63 | 35.72 | 2.47 | 42.09 | 40.14 |
| | 2 | 40.20 | | 34.91 | | 2.45 | 40.14 | 38.10 |
| | 3 | 40.50 | | 35.23 | | 2.42 | 38.10 | 36.12 |
| | 4 | 40.56 | | 35.20 | | 2.42 | 36.12 | 34.14 |
| | 5 | 40.93 | | 35.59 | | 2.40 | 34.14 | 32.13 |
| | 6 | 41.39 | | 36.01 | | 2.37 | 32.13 | 30.11 |
| | 7 | 41.51 | | 35.68 | | 2.40 | 30.11 | 28.10 |
| | 8 | 41.56 | | 36.38 | | 2.35 | 28.10 | 26.15 |
| | 9 | 42.43 | | 36.51 | | 2.34 | 26.15 | 24.08 |
| | 10 | 41.95 | | 37.09 | | 2.30 | 24.08 | 22.19 |
| 2 | 1 | 39.92 | 41.00 | 34.69 | 35.65 | 2.46 | 52.50 | 50.56 |
| | 2 | 39.98 | | 35.04 | | 2.44 | 50.56 | 48.50 |
| | 3 | 40.20 | | 35.10 | | 2.43 | 48.50 | 46.53 |
| | 4 | 40.37 | | 35.08 | | 2.44 | 46.53 | 44.56 |
| | 5 | 40.93 | | 35.41 | | 2.41 | 44.56 | 42.48 |
| | 6 | 41.23 | | 35.98 | | 2.37 | 42.48 | 40.55 |
| | 7 | 41.47 | | 35.88 | | 2.38 | 40.55 | 38.53 |
| | 8 | 41.69 | | 36.27 | | 2.36 | 38.53 | 36.49 |
| | 9 | 41.85 | | 36.32 | | 2.35 | 36.49 | 34.53 |
| | 10 | 42.32 | | 36.75 | | 2.32 | 34.53 | 32.55 |

TABLE 16
Measurement results for comparative pellets VG3-B8

| | | | | | | | Piston | Piston |
|---|---|---|---|---|---|---|---|---|
| | Index | | | | | | position | position |
| Cylinder | number | MFRₙ | M̅F̅R̅ | MVRₙ | M̅V̅R̅ | Measurement | at start of | at end of |
| filling | of the | [g/10 | [g/10 | [cm³/10 | [cm³/10 | time | measurement | measurement |
| no. | measurement | min] | min] | min] | min] | [s] | [mm] | [mm] |
| 1 | 1 | 4.80 | 5.46 | 3.90 | 4.42 | 21.90 | 63.89 | 61.89 |
| | 2 | 4.89 | | 4.00 | | 21.33 | 61.89 | 59.89 |
| | 3 | 5.04 | | 4.05 | | 21.07 | 59.89 | 57.89 |
| | 4 | 5.15 | | 4.16 | | 20.52 | 57.89 | 55.89 |
| | 5 | 5.36 | | 4.33 | | 19.73 | 55.89 | 53.90 |
| | 6 | 5.54 | | 4.46 | | 19.16 | 53.90 | 51.89 |
| | 7 | 5.68 | | 4.58 | | 18.63 | 51.89 | 49.89 |
| | 8 | 5.98 | | 4.83 | | 17.69 | 49.89 | 47.89 |
| | 9 | 6.04 | | 4.88 | | 17.50 | 47.89 | 45.89 |
| | 10 | 6.18 | | 4.99 | | 17.11 | 45.89 | 43.89 |
| 2 | 1 | 5.21 | 5.95 | 4.21 | 4.80 | 20.29 | 56.97 | 54.97 |
| | 2 | 5.27 | | 4.26 | | 20.03 | 54.97 | 52.97 |
| | 3 | 5.43 | | 4.36 | | 19.59 | 52.97 | 50.97 |
| | 4 | 5.68 | | 4.58 | | 18.66 | 50.97 | 48.98 |
| | 5 | 5.92 | | 4.76 | | 17.96 | 48.98 | 46.97 |
| | 6 | 6.10 | | 4.92 | | 17.35 | 46.97 | 44.96 |
| | 7 | 6.26 | | 5.05 | | 16.92 | 44.96 | 42.97 |
| | 8 | 6.31 | | 5.09 | | 16.77 | 42.97 | 40.97 |
| | 9 | 6.57 | | 5.32 | | 16.05 | 40.97 | 38.97 |
| | 10 | 6.71 | | 5.42 | | 15.77 | 38.97 | 36.96 |

### EXAMPLE B9: DETERMINATION OF DENSITY

According to example B5 above, test specimens of the PK1-B5 type were produced, namely test specimens PK1-B9-01, PK1-B9-02, PK1-B9-03, PK1-B9-04 and PK1-B9-05. According to example B5 above, test specimens of the PK2-B5 type were produced, namely test specimens PK2-B9-01, PK2-B9-02, PK2-B9-03, PK2-B9-04 and PK2-B9-05. According to example B5 above, test specimens of the PK3-B5 type were produced, namely test specimens PK3-B9-01, PK3-B9-02, PK3-B9-03, PK3-B9-04 and PK3-B9-05. According to example B5 above, test specimens of the PK4-B5 type were produced, namely test specimens PK4-B9-01, PK4-B9-02, PK4-B9-03, PK4-B9-04 and PK4-B9-05.

According to the procedure in example B5 above, comparative test specimens of the VPK1-B5 type were produced, namely comparative test specimens VPK1-B9-01, VPK1-B9-02, VPK1-B9-03, VPK1-B9-04, VPK1-B9-05. According to the procedure in example B5 above, comparative test specimens of the VPK2-B5 type were produced, namely comparative test specimens VPK2-B9-01, VPK2-B9-02, VPK2-B9-03, VPK2-B9-04, VPK2-B9-05. According to the procedure in example B5 above, comparative test specimens of the VPK3-B5 type were produced, namely comparative test specimens VPK3-B9-01, VPK3-B9-02, VPK3-B9-03, VPK3-B9-04, VPK3-B9-05.

The density of the test specimens produced in example B9 and the density of the comparative test specimens produced in example B9 were determined by method A (immersion method) of DIN EN ISO 1183-1:2019. The immersion liquid used in the context of point 5.1.2 of DIN EN ISO 1183-1:2019 was freshly deionized water, to which a proportion of 0.1% ethanol was added as wetting agent to assist in the removal of air bubbles, the temperature of the immersion liquid was 27° C.±2° C. No correction with regard to buoyancy was made. For each sample, 5 individual measurements were conducted on different test specimens or comparative test specimens, each of the same composition. The results of the determinations of density are listed in tables 17 and 18.

In tables 17 and 18, the label “Density (mean)” means the arithmetic mean of individual density measurements in the context of point 7 f) of DIN EN ISO 1183-1:2019.

TABLE 17
Results of density determinations on test specimens

| | | Density | |
|---|---|---|---|
| | Test specimen in | (single | Density |
| Test specimen | individual | measurement) | (mean)^{[15]} |
| type | measurement | [g/cm³] | [g/cm³] |
| PK1-B5 | PK1-B9-01 | 1.3767 | 1.377 |
| | PK1-B9-02 | 1.3773 | |
| | PK1-B9-03 | 1.3763 | |
| | PK1-B9-04 | 1.3768 | |
| | PK1-B9-05 | 1.3783 | |
| PK2-B5 | PK2-B9-01 | 1.3811 | 1.382 |
| | PK2-B9-02 | 1.3822 | |
| | PK2-B9-03 | 1.3812 | |
| | PK2-B9-04 | 1.3819 | |
| | PK2-B9-05 | 1.3823 | |
| PK3-B5 | PK3-B9-01 | 1.2734 | 1.283 |
| | PK3-B9-02 | 1.2877 | |
| | PK3-B9-03 | 1.2826 | |
| | PK3-B9-04 | 1.2816 | |
| | PK3-B9-05 | 1.2877 | |
| PK4-B5 | PK4-B9-01 | 1.2942 | 1.292 |
| | PK4-B9-02 | 1.2914 | |
| | PK4-B9-03 | 1.2905 | |
| | PK4-B9-04 | 1.2919 | |
| | PK4-B9-05 | 1.2917 | |

TABLE 18
Results of density determinations on comparative test specimens

| | | Density | |
|---|---|---|---|
| Test | Test specimen in | (single | Density |
| specimen | individual | measurement) | (mean)^{[15]} |
| type | measurement | [g/cm³] | [g/cm³] |
| VPK1-B5 | VPK1-B9-01 | 1.3007 | 1.301 |
| | VPK1-B9-02 | 1.3004 | |
| | VPK1-B9-03 | 1.3015 | |
| | VPK1-B9-04 | 1.3009 | |
| | VPK1-B9-05 | 1.3011 | |
| VPK2-B5 | VPK2-B9-01 | 1.3170 | 1.316 |
| | VPK2-B9-02 | 1.3153 | |
| | VPK2-B9-03 | 1.3162 | |
| | VPK2-B9-04 | 1.3158 | |
| | VPK2-B9-05 | 1.3150 | |
| VPK3-B5 | VPK3-B9-01 | 1.3770 | 1.377 |
| | VPK3-B9-02 | 1.3775 | |
| | VPK3-B9-03 | 1.3766 | |
| | VPK3-B9-04 | 1.3775 | |
| | VPK3-B9-05 | 1.3778 | |

### EXAMPLE B10: DETERMINATION OF TENSILE PROPERTIES

According to example B5 above, test specimens of the PK1-B5 type were produced, namely test specimens PK1-B10-01, PK1-B10-02, PK1-B10-03, PK1-B10-04, PK1-B10-05, PK1-B10-06, PK1-B10-07, PK1-B10-08, PK1-B10-09 and PK1-B10-10. According to example B5 above, test specimens of the PK2-B5 type were produced, namely test specimens PK2-B10-01, PK2-B10-02, PK2-B10-03, PK2-B10-04, PK2-B10-05, PK2-B10-06, PK2-B10-07, PK2-B10-08, PK2-B10-09 and PK2-B10-10. According to example B5 above, test specimens of the PK3-B5 type were produced, namely test specimens PK3-B10-01, PK3-B10-02, PK3-B10-03, PK3-B10-04, PK3-B10-05, PK3-B10-06, PK3-B10-07, PK3-B10-08, PK3-B10-09 and PK3-B10-10. According to example B5 above, test specimens of the PK4-B5 type were produced, namely test specimens PK4-B10-01, PK4-B10-02, PK4-B10-03, PK4-B10-04, PK4-B10-05, PK4-B10-06, PK4-B10-07, PK4-B10-08, PK4-B10-09 and PK4-B10-10.

In accordance with the procedure in example B5 above, comparative test specimens of the VPK1-B5 type were produced, namely comparative test specimens VPK1-B10-01, VPK1-B10-02, VPK1-B10-03, VPK1-B10-04, VPK1-B10-05, VPK1-B10-06, VPK1-B10-07, VPK1-B10-08, VPK1-B10-09 and VPK1-B10-10. In accordance with the procedure in example B5 above, comparative test specimens of the VPK2-B5 type were produced, namely comparative test specimens VPK2-B10-01, VPK2-B10-02, VPK2-B10-03, VPK2-B10-04, VPK2-B10-05, VPK2-B10-06, VPK2-B10-07, VPK2-B10-08, VPK2-B10-09 and VPK2-B10-10. In accordance with the procedure in example B5 above, comparative test specimens of the VPK3-B5 type were produced, namely comparative test specimens VPK3-B10-01, VPK3-B10-02, VPK3-B10-03, VPK3-B10-04, VPK3-B10-05, VPK3-B10-06, VPK3-B10-07, VPK3-B10-08, VPK3-B10-09, VPK3-B10-10.

The tensile properties of the test specimens produced in example B10 and the tensile properties of the comparative test specimens produced in example B10 were determined in accordance with DIN EN ISO 527-2:2012.

Tensile modulus, tensile strength, tensile elongation, ultimate tensile stress, elongation at break and the dimensions of the test specimens used were each determined in accordance with DIN EN ISO 527-2:2012. In addition, the maximum force expended was determined. Tensile properties were determined on a Zwick Roell Z020 instrument and with a pneumatic sample holder of the 8497 30 kN type. The load cell was 20 kN. The test speed was 1 mm/min for the determination of the index in the elastic range and 50 mm/min for the determination of the index in the plastic range. The clamped length at the starting position was 115.00 mm and the measurement length was 75 mm. The test specimens were each used at room temperature 23° C. and test specimen temperature 23° C. and at a relative humidity of 50%.

The results of the respective determinations of the tensile properties are listed in tables 19 to 25.

TABLE 19
Determination of tensile properties on test specimens of the PK1-B5 type

| | Test | | | | Ultimate | | Nominal | Test | Test |
|---|---|---|---|---|---|---|---|---|---|
| | specimen in | | Tensile | Tensile | tensile | Elongation | elongation | specimen | specimen |
| | individual | Fmax | modulus | strength | stress | at break | at break | width | height |
| Type | measurement | [N] | [MPa] | [MPa] | [MPa] | % | % | [mm] | [mm] |
| PK1-B5 | PK1-B10-01 | 826.65 | 1640 | 19.8 | 19.8 | 2.69 | 2.73 | 10.14 | 4.12 |
| | PK1-B10-02 | 827.11 | 1640 | 19.8 | 19.8 | 2.82 | 2.85 | 10.13 | 4.11 |
| | PK1-B10-03 | 834.62 | 1650 | 20.0 | 20.0 | 2.77 | 2.82 | 10.14 | 4.12 |
| | PK1-B10-04 | 835.16 | 1650 | 20.0 | 20.0 | 2.81 | 2.86 | 10.14 | 4.12 |
| | PK1-B10-05 | 837.69 | 1640 | 20.0 | 20.0 | 2.80 | 2.84 | 10.15 | 4.12 |
| | PK1-B10-06 | 832.10 | 1630 | 19.9 | 19.9 | 2.83 | 2.85 | 10.13 | 4.11 |
| | PK1-B10-07 | 831.14 | 1640 | 20.0 | 20.0 | 2.84 | 2.89 | 10.12 | 4.11 |
| | PK1-B10-08 | 830.69 | 1650 | 20.0 | 20.0 | 2.81 | 2.85 | 10.12 | 4.1 |
| | PK1-B10-09 | 829.89 | 1650 | 20.0 | 20.0 | 2.83 | 2.87 | 10.12 | 4.11 |
| | PK1-B10-10 | 831.44 | 1650 | 20.0 | 20.0 | 2.69 | 2.74 | 10.12 | 4.11 |

TABLE 20
Determination of tensile properties on test specimens of the PK2-B5 type

| | Test | | | | Ultimate | | Nominal | Test | Test |
|---|---|---|---|---|---|---|---|---|---|
| | specimen in | | Tensile | Tensile | tensile | Elongation | elongation | specimen | specimen |
| | individual | Fmax | modulus | strength | stress | at break | at break | width | height |
| Type | measurement | [N] | [MPa] | [MPa] | [MPa] | % | % | [mm] | [mm] |
| PK2-B5 | PK2-B10-01 | 843.69 | 1930 | 20.2 | 20.2 | 2.31 | 2.35 | 10.14 | 4.11 |
| | PK2-B10-02 | 850.29 | 1920 | 20.3 | 20.3 | 2.28 | 2.33 | 10.15 | 4.12 |
| | PK2-B10-03 | 850.72 | 1930 | 20.4 | 20.4 | 2.34 | 2.39 | 10.14 | 4.12 |
| | PK2-B10-04 | 847.03 | 1930 | 20.3 | 20.3 | 2.33 | 2.38 | 10.14 | 4.11 |
| | PK2-B10-05 | 849.84 | 1930 | 20.3 | 20.3 | 2.36 | 2.41 | 10.14 | 4.12 |
| | PK2-B10-06 | 845.14 | 1920 | 20.3 | 20.3 | 2.34 | 2.39 | 10.13 | 4.11 |
| | PK2-B10-07 | 852.90 | 1920 | 20.5 | 20.5 | 2.33 | 2.38 | 10.12 | 4.11 |
| | PK2-B10-08 | 852.01 | 1940 | 20.5 | 20.5 | 2.33 | 2.38 | 10.13 | 4.11 |
| | PK2-B10-09 | 846.76 | 1940 | 20.4 | 20.4 | 2.27 | 2.32 | 10.12 | 4.11 |
| | PK2-B10-10 | 858.68 | 1920 | 20.6 | 20.6 | 2.33 | 2.37 | 10.13 | 4.11 |

TABLE 21
Determination of tensile properties on test specimens of the PK3-B5 type

| | Test | | | | Ultimate | | Nominal | Test | Test |
|---|---|---|---|---|---|---|---|---|---|
| | specimen in | | Tensile | Tensile | tensile | Elongation | elongation | specimen | specimen |
| | individual | Fmax | modulus | strength | stress | at break | at break | width | height |
| Type | measurement | [N] | [MPa] | [MPa] | [MPa] | % | % | [mm] | [mm] |
| PK3-B5 | PK3-B10-01 | 1043.75 | 4180 | 25.2 | 25.2 | 0.824 | 0.874 | 0.40 | 10.14 |
| | PK3-B10-02 | 1054.96 | 4170 | 25.5 | 25.5 | 0.844 | 0.890 | 0.41 | 10.14 |
| | PK3-B10-03 | 1051.04 | 4180 | 25.4 | 25.4 | 0.845 | 0.893 | 0.41 | 10.14 |
| | PK3-B10-04 | 1024.47 | 4160 | 24.8 | 24.8 | 0.824 | 0.874 | 0.39 | 10.14 |
| | PK3-B10-05 | 1056.32 | 4190 | 25.6 | 25.6 | 0.831 | 0.877 | 0.40 | 10.13 |
| | PK3-B10-06 | 1053.76 | 4210 | 25.6 | 25.6 | 0.840 | 0.889 | 0.41 | 10.13 |
| | PK3-B10-07 | 1047.14 | 4200 | 25.4 | 25.4 | 0.847 | 0.900 | 0.41 | 10.11 |
| | PK3-B10-08 | 1049.13 | 4170 | 25.5 | 25.5 | 0.835 | 0.884 | 0.40 | 10.12 |
| | PK3-B10-09 | 1038.07 | 4140 | 25.2 | 25.2 | 0.832 | 0.870 | 0.40 | 10.13 |

TABLE 22
Determination of tensile properties on test specimens of the PK4-B5 type

| | Test | | | | Ultimate | | Nominal | Test | Test |
|---|---|---|---|---|---|---|---|---|---|
| | specimen in | | Tensile | Tensile | tensile | Elongation | elongation | specimen | specimen |
| | individual | Fmax | modulus | strength | stress | at break | at break | width | height |
| Type | measurement | [N] | [MPa] | [MPa] | [MPa] | % | % | [mm] | [mm] |
| PK4-B5 | PK4-B10-01 | 1024.05 | 4290 | 24.8 | 24.8 | 0.817 | 0.870 | 10.14 | 4.08 |
| | PK4-B10-02 | 1025.57 | 4270 | 24.8 | 24.8 | 0.824 | 0.877 | 10.12 | 4.08 |
| | PK4-B10-03 | 1036.92 | 4290 | 25.1 | 25.1 | 0.823 | 0.876 | 10.14 | 4.08 |
| | PK4-B10-04 | 1040.23 | 4340 | 25.1 | 25.1 | 0.809 | 0.862 | 10.14 | 4.08 |
| | PK4-B10-05 | 1036.18 | 4350 | 25.1 | 25.1 | 0.808 | 0.863 | 10.13 | 4.08 |
| | PK4-B10-06 | 1030.79 | 4300 | 25.1 | 25.1 | 0.816 | 0.870 | 10.12 | 4.06 |
| | PK4-B10-07 | 1037.30 | 4310 | 25.3 | 25.3 | 0.830 | 0.883 | 10.11 | 4.06 |
| | PK4-B10-08 | 1027.24 | 4280 | 25.0 | 25.0 | 0.830 | 0.884 | 10.1 | 4.07 |
| | PK4-B10-09 | 1036.40 | 4320 | 25.1 | 25.1 | 0.809 | 0.861 | 10.14 | 4.07 |
| | PK4-B10-10 | 1029.08 | 4270 | 25.1 | 25.1 | 0.824 | 0.872 | 10.11 | 4.06 |

TABLE 23
Determination of tensile properties on comparative test specimens of the VPK1-B5 type

| | Test | | | | Ultimate | | Nominal | Test | Test |
|---|---|---|---|---|---|---|---|---|---|
| | specimen in | | Tensile | Tensile | tensile | Elongation | elongation | specimen | specimen |
| | individual | Fmax | modulus | strength | stress | at break | at break | width | height |
| Type | measurement | [N] | [MPa] | [MPa] | [MPa] | % | % | [mm] | [mm] |
| VPK1-B5 | VPK1-B10-01 | 795.44 | 808 | 19.1 | 19.1 | 4.89 | 4.94 | 10.13 | 4.12 |
| | VPK1-B10-02 | 774.64 | 786 | 18.6 | 18.6 | 4.68 | 4.73 | 10.13 | 4.12 |
| | VPK1-B10-03 | 809.68 | 810 | 19.4 | 19.4 | 4.81 | 4.85 | 10.13 | 4.12 |
| | VPK1-B10-04 | 807.12 | 804 | 19.4 | 19.4 | 4.98 | 5.03 | 10.12 | 4.12 |
| | VPK1-B10-05 | 806.99 | 809 | 19.3 | 19.3 | 4.86 | 4.91 | 10.13 | 4.12 |
| | VPK1-B10-06 | 806.28 | 792 | 19.4 | 19.4 | 4.90 | 4.95 | 10.11 | 4.11 |
| | VPK1-B10-07 | 797.14 | 804 | 19.2 | 19.2 | 4.75 | 4.79 | 10.12 | 4.1 |
| | VPK1-B10-08 | 799.78 | 798 | 19.2 | 19.2 | 4.89 | 4.92 | 10.11 | 4.11 |
| | VPK1-B10-09 | 797.42 | 793 | 19.2 | 19.2 | 5.01 | 5.04 | 10.12 | 4.11 |
| | VPK1-B10-10 | 796.21 | 801 | 19.2 | 19.2 | 4.62 | 4.67 | 10.11 | 4.11 |

TABLE 24
Determination of tensile properties on test specimens of the VPK2-B5 type

| | Test | | | | Ultimate | | Nominal | Test | Test |
|---|---|---|---|---|---|---|---|---|---|
| | specimen in | | Tensile | Tensile | tensile | Elongation | elongation | specimen | specimen |
| | individual | Fmax | modulus | strength | stress | at break | at break | width | height |
| Type | measurement | [N] | [MPa] | [MPa] | [MPa] | % | % | [mm] | [mm] |
| VPK2-B5 | VPK2-B10-01 | 804.42 | 835 | 19.3 | 19.3 | 4.97 | 5.01 | 10.1 | 4.12 |
| | VPK2-B10-02 | 801.01 | 832 | 19.2 | 19.2 | 4.62 | 4.64 | 10.11 | 4.12 |
| | VPK2-B10-03 | 800.42 | 833 | 19.2 | 19.0 | 5.68 | 5.72 | 10.11 | 4.12 |
| | VPK2-B10-04 | 796.04 | 834 | 19.1 | 18.3 | — | 5.57 | 10.11 | 4.12 |
| | VPK2-B10-05 | 797.70 | 836 | 19.3 | 18.3 | — | 5.40 | 10.1 | 4.1 |
| | VPK2-B10-06 | 798.72 | 834 | 19.2 | 18.7 | — | 5.51 | 10.11 | 4.11 |
| | VPK2-B10-07 | 795.59 | 831 | 19.2 | 19.2 | 4.90 | 4.94 | 10.1 | 4.11 |
| | VPK2-B10-08 | 790.13 | 836 | 19.1 | 19.0 | 5.36 | 5.41 | 10.09 | 4.1 |
| | VPK2-B10-09 | 790.84 | 834 | 19.1 | 19.1 | 4.85 | 4.89 | 10.1 | 4.11 |

TABLE 25
Determination of tensile properties in comparative test specimen type VPK3-B5-3

| | Test | | | | Ultimate | | Nominal | Test | Test |
|---|---|---|---|---|---|---|---|---|---|
| | specimen in | | Tensile | Tensile | tensile | Elongation | elongation | specimen | specimen |
| | individual | Fmax | modulus | strength | stress | at break | at break | width | height |
| Type | measurement | [N] | [MPa] | [MPa] | [MPa] | % | % | [mm] | [mm] |
| VPK3-B5 | VPK3-B10-01 | 1291.95 | 2710 | 31.1 | 31.1 | 2.41 | 2.46 | 10.1 | 4.11 |
| | VPK2-B10-02 | 1321.57 | 2750 | 31.8 | 31.8 | 2.40 | 2.46 | 10.11 | 4.11 |
| | VPK2-B10-03 | 1319.55 | 2740 | 31.7 | 31.7 | 2.46 | 2.51 | 10.1 | 4.12 |
| | VPK2-B10-04 | 1305.15 | 2740 | 31.5 | 31.5 | 2.44 | 2.49 | 10.09 | 4.11 |
| | VPK2-B10-05 | 1322.25 | 2750 | 31.9 | 31.9 | 2.49 | 2.54 | 10.1 | 4.11 |
| | VPK2-B10-06 | 1317.78 | 2740 | 31.9 | 31.9 | 2.43 | 2.47 | 10.09 | 4.1 |
| | VPK2-B10-07 | 1283.05 | 2710 | 31.0 | 31.0 | 2.38 | 2.44 | 10.09 | 4.1 |
| | VPK2-B10-08 | 1281.41 | 2710 | 31.0 | 31.0 | 2.39 | 2.44 | 10.08 | 4.1 |
| | VPK2-B10-09 | 1293.75 | 2710 | 31.3 | 31.3 | 2.39 | 2.44 | 10.09 | 4.1 |

### EXAMPLE B111: DETERMINATION OF FLEXURAL PROPERTIES

According to example B5 above, test specimens of the PK1-B5 type were produced, namely test specimens PK1-B11-01, PK1-B11-02, PK1-B11-03, PK1-B11-04 and PK1-B11-05. According to example B5 above, test specimens of the PK2-B5 type were produced, namely test specimens PK2-B11-01, PK2-B11-02, PK2-B11-03, PK2-B11-04 and PK2-B11-05. According to example B5 above, test specimens of the PK3-B5 type were produced, namely test specimens PK3-B11-01, PK3-B11-02, PK3-B11-03, PK3-B11-04 and PK3-B111-05. According to example B5 above, test specimens of the PK4-B5 type were produced, namely test specimens PK4-B11-01, PK4-B11-02, PK4-B11-03, PK4-B11-04 and PK4-B11-05.

According to the procedure in example B5 above, comparative test specimens of the VPK1-B5 type were produced, namely comparative test specimens VPK1-B11-01, VPK1-B11-02, VPK1-B11-03, VPK1-B11-04 and VPK1-B11-05. According to the procedure in example B5 above, comparative test specimens of the VPK2-B5 type were produced, namely comparative test specimens VPK2-B11-01, VPK2-B11-02, VPK2-B11-03, VPK2-B11-04 and VPK2-B11-05. According to the procedure in example B5 above, comparative test specimens of the VPK3-B5 type were produced, namely comparative test specimens VPK3-B111-01, VPK3-B11-02, VPK3-B11-03, VPK3-B11-04 and VPK3-B11-05.

The flexural properties of the test specimens produced in example B111 and the flexural properties of the comparative test specimens produced in example B11 were determined in accordance with method A of DIN EN ISO 178:2019, with an initial force of 0.1 MPa and a test speed of 2 mm/min.

Flexural properties were determined on a Zwick Roell Z2.5 kN TN tester. The load cell was 2.5 kN. The support separation was 64 mm. A sample support with a radius of 5 mm was used. The test specimens were each used at room temperature 23° C. and test specimen temperature 23° C. and at a relative humidity of 50%.

Flexural modulus of elasticity, flexural stress under conventional deflection, flexural strength, flexural strain at flexural strength, flexural stress at break and flexural strain at break were determined, in each case by method A of DIN EN ISO 178:2019 with the parameters specified above. In addition, the maximum force expended and the dimensions of the test specimens used were determined.

The results of the respective determinations of the flexural properties are listed in tables 26 and 27.

TABLE 26
Determination of flexural properties on test specimens of the PK1-B5, PK2-B5, PK3-B5 and PK4-B5 types

| | | | | Flexural | | Flexural | | | | |
|---|---|---|---|---|---|---|---|---|---|---|
| | Test | | Flexural | stress under | | strain at | Flexural | Flexural | Test | Test |
| | specimen in | | modulus of | conventional | Flexural | flexural | stress | strain | specimen | specimen |
| | individual | Fmax | elasticity | deflection | strength | strength | at break | at break | height | width |
| Type | measurement | [N] | [MPa] | [MPa] | [MPa] | % | [MPa] | % | [mm] | [mm] |
| PK1-B5 | PK1-B11-01 | 66.42 | 1660 | 36.2 | 37.4 | 4.4 | 37.4 | 4.4 | 4.1 | 10.13 |
| | PK1-B11-02 | 67.10 | 1640 | 36.1 | 37.9 | 4.8 | — | — | 4.1 | 10.11 |
| | PK1-B11-03 | 65.64 | 1630 | 35.8 | 36.8 | 4.3 | 36.8 | 4.3 | 4.11 | 10.13 |
| | PK1-B11-04 | 66.55 | 1630 | 35.8 | 37.6 | 4.7 | 37.6 | 4.7 | 4.1 | 10.12 |
| | PK1-B11-05 | 65.93 | 1640 | 35.8 | 37.1 | 4.4 | 37.1 | 4.4 | 4.11 | 10.11 |
| PK2-B5 | PK2-B11-01 | 68.11 | 1910 | 38.0 | 38.0 | 3.7 | 38.0 | 3.7 | 4.12 | 10.13 |
| | PK2-B11-02 | 67.56 | 1930 | 37.9 | 37.9 | 3.7 | 37.9 | 3.7 | 4.11 | 10.13 |
| | PK2-B11-03 | 67.38 | 1900 | 38.0 | 38.0 | 3.8 | 38.0 | 3.8 | 4.1 | 10.12 |
| | PK2-B11-04 | 67.94 | 1910 | 37.9 | 37.9 | 3.7 | 37.9 | 3.7 | 4.12 | 10.14 |
| PK3-B5 | PK3-B11-01 | 77.28 | 4480 | — | 44.6 | 1.5 | 44.6 | 1.5 | 4.05 | 10.13 |
| | PK3-B11-02 | 76.59 | 4330 | — | 43.6 | 1.5 | 43.6 | 1.5 | 4.08 | 10.13 |
| | PK3-B11-03 | 75.07 | 4230 | — | 42.9 | 1.4 | 42.9 | 1.4 | 4.07 | 10.13 |
| | PK3-B11-04 | 71.55 | 4350 | — | 41.3 | 1.4 | 41.3 | 1.4 | 4.05 | 10.13 |
| PK4-B5 | PK4-B11-01 | 70.32 | 4400 | — | 40.4 | 1.4 | 40.4 | 1.4 | 4.06 | 10.13 |
| | PK4-B11-02 | 73.68 | 4360 | — | 41.9 | 1.4 | 41.9 | 1.4 | 4.08 | 10.14 |
| | PK4-B11-03 | 74.42 | 4500 | — | 42.3 | 1.4 | 42.3 | 1.4 | 4.08 | 10.15 |
| | PK4-B11-04 | 68.27 | 4460 | — | 39.4 | 1.3 | 39.4 | 1.3 | 4.05 | 10.13 |

TABLE 27
Determination of flexural properties of comparative test specimens of the VPK1-B5, VPK2-B5 and VPK3-B5 types

| | | | | Flexural | | Flexural | | | | |
|---|---|---|---|---|---|---|---|---|---|---|
| | Test | | Flexural | stress under | | strain at | Flexural | Flexural | Test | Test |
| Test | specimen in | | modulus of | conventional | Flexural | flexural | stress | strain | specimen | specimen |
| specimen | individual | Fmax | elasticity | deflection | strength | strength | at break | at break | height | width |
| type | measurement | [N] | [MPa] | [MPa] | [MPa] | % | [MPa] | % | [mm] | [mm] |
| VPK1-B5 | VPK1-B11-01 | 43.00 | 769 | 20.7 | — | — | — | — | 4.11 | 10.11 |
| | VPK1-B11-02 | 42.99 | 745 | 20.5 | — | — | — | — | 4.11 | 10.13 |
| | VPK1-B11-03 | 42.93 | 755 | 20.6 | — | — | — | — | 4.11 | 10.11 |
| | VPK1-B11-04 | 42.91 | 757 | 20.5 | — | — | — | — | 4.11 | 10.14 |
| VPK2-B5 | VPK2-B11-01 | 46.06 | 793 | 22.1 | — | — | — | — | 4.09 | 10.1 |
| | VPK2-B11-02 | 46.49 | 800 | 22.2 | — | — | — | — | 4.1 | 10.12 |
| | VPK2-B11-03 | 46.85 | 806 | 22.4 | — | — | — | — | 4.1 | 10.12 |
| | VPK2-B11-04 | 46.39 | 754 | 22.1 | — | — | — | — | 4.13 | 10.11 |
| | VPK2-B11-05 | 46.00 | 783 | 21.9 | — | — | — | — | 4.11 | 10.13 |
| VPK3-B5 | VPK3-B11-01 | 84.97 | 2530 | — | 48.1 | 3.2 | 48.1 | 3.2 | 4.1 | 10.09 |
| | VPK3-B11-02 | 84.26 | 2510 | — | 47.4 | 3.2 | 47.4 | 3.2 | 4.11 | 10.11 |
| | VPK3-B11-03 | 84.30 | 2530 | — | 47.7 | 3.1 | 47.7 | 3.1 | 4.1 | 10.09 |
| | VPK3-B11-04 | 87.71 | 2530 | — | 49.4 | 3.4 | 49.4 | 3.4 | 4.11 | 10.09 |

### EXAMPLE B12: DETERMINATION OF CHARPY IMPACT RESISTANCE OF UNNOTCHED TEST SPECIMENS

According to example B5 above, test specimens of type PK1-B5 were produced, namely test specimens PK1-B12-01, PK1-B12-02, PK1-B12-03, PK1-B12-04, PK1-B12-05, PK1-B12-06, PK1-B12-07, PK1-B12-08, PK1-B12-09, PK1-B12-10, PK1-B12-11 and PK1-B12-12. According to example B5 above, test specimens of type PK2-B5 were produced, namely test specimens PK2-B12-01, PK2-B12-02, PK2-B12-03, PK2-B12-04, PK2-B12-05, PK2-B12-06, PK2-B12-07, PK2-B12-08, PK2-B12-09, PK2-B12-10, PK2-B12-11 and PK2-B12-12. According to example B5 above, test specimens of type PK3-B5 were produced, namely test specimens PK3-B12-01, PK3-B12-02, PK3-B12-03, PK3-B12-04, PK3-B12-05, PK3-B12-06, PK3-B12-07, PK3-B12-08, PK3-B12-09, PK3-B12-10, PK3-B12-11 and PK3-B12-12. According to example B5 above, test specimens of type PK4-B5 were produced, namely test specimens PK4-B12-01, PK4-B12-02, PK4-B12-03, PK4-B12-04, PK4-B12-05, PK4-B12-06, PK4-B12-07, PK4-B12-08, PK4-B12-09, PK4-B12-10, PK4-B12-11 and PK4-B12-12.

In accordance with the procedure in the above example B5, comparative test specimens of the VPK1-B5 type were produced, namely comparative test specimens VPK1-B12-01, VPK1-B12-02, VPK1-B12-03, VPK1-B12-04, VPK1-B12-05, VPK1-B12-06, VPK1-B12-07, VPK1-B12-08, VPK1-B12-09, VPK1-B12-10, VPK1-B12-11 and VPK1-B12-12. In accordance with the procedure in the above example B5, comparative test specimens of the VPK2-B5 type were produced, namely comparative test specimens VPK2-B12-01, VPK2-B12-02, VPK2-B12-03, VPK2-B12-04, VPK2-B12-05, VPK2-B12-06, VPK2-B12-07, VPK2-B12-08, VPK2-B12-09, VPK2-B12-10, VPK2-B12-11 and VPK2-B12-12. In accordance with the procedure in the above example B5, comparative test specimens of the VPK3-B5 type were produced, namely comparative test specimens VPK3-B12-01, VPK3-B12-02, VPK3-B12-03, VPK3-B12-04, VPK3-B12-05, VPK3-B12-06, VPK3-B12-07, VPK3-B12-08, VPK3-B12-09, VPK3-B12-10, VPK3-B12-11 and VPK3-B12-12.

The Charpy impact resistance of the test specimens produced in example B10 or B12 and the Charpy impact resistance of the comparative test specimens produced in example B10 or B12 were determined in accordance with DIN EN ISO 179-1:2010 according to method ISO 179-1/1eU. For this purpose, the type A test specimens were shortened to 80 mm+/−2 mm in accordance with DIN EN ISO 3167:2014 point 3 and then used. The Charpy impact resistance of unnotched test specimens was determined on a Zwick Roell HIT 25P instrument. The nominal work performed by the pendulum was 5 joules. The test specimens were each used at room temperature 23° C. and test specimen temperature 23° C. and at a relative humidity of 50%.

The results of the respective determinations of the Charpy impact resistance are listed in tables 28 to 34.

In each of tables 28 to 34:

“E_{c}” means the corrected work (in joules) which is absorbed in order to break the test specimen. The label “C” for the type of failure has the meaning according to DIN EN ISO 179-1:2010, namely that complete fracture, including hinge fracture, has occurred.

TABLE 28
Determination of Charpy impact resistance of
unnotched test specimens of the PK1-B5 type

| Test | Test specimen in | | Impact | |
|---|---|---|---|---|
| specimen | individual | E_{c} | resistance | Type of |
| type | measurement | [J] | [kJ/m²] | failure |
| PK1-B5 | PK1-B12-01 | 0.43 | 10.40 | C |
| | PK1-B12-02 | 0.55 | 13.11 | C |
| | PK1-B12-03 | 0.46 | 11.11 | C |
| | PK1-B12-04 | 0.44 | 10.54 | C |
| | PK1-B12-05 | 0.50 | 11.97 | C |
| | PK1-B12-06 | 0.48 | 11.40 | C |
| | PK1-B12-07 | 0.43 | 10.26 | C |
| | PK1-B12-08 | 0.49 | 11.82 | C |
| | PK1-B12-09 | 0.50 | 11.97 | C |
| | PK1-B12-10 | 0.54 | 12.97 | C |
| | PK1-B12-11 | 0.48 | 11.40 | C |
| | PK1-B12-12 | 0.46 | 11.11 | C |

TABLE 29
Determination of Charpy impact resistance of
unnotched test specimens of the PK2-B5 type

| Test | Test specimen in | | Impact | |
|---|---|---|---|---|
| specimen | individual | E_{c} | resistance | Type of |
| type | measurement | [J] | [kJ/m²] | failure |
| PK2-B5 | PK2-B12-01 | 0.50 | 12.00 | C |
| | PK2-B12-02 | 0.42 | 10.00 | C |
| | PK2-B12-03 | 0.42 | 10.00 | C |
| | PK2-B12-04 | 0.43 | 10.28 | C |
| | PK2-B12-05 | 0.46 | 11.14 | C |
| | PK2-B12-06 | 0.39 | 9.28 | C |
| | PK2-B12-07 | 0.46 | 11.00 | C |
| | PK2-B12-08 | 0.36 | 8.57 | C |
| | PK2-B12-09 | 0.48 | 11.57 | C |
| | PK2-B12-10 | 0.37 | 8.86 | C |
| | PK2-B12-11 | 0.42 | 10.14 | C |
| | PK2-B12-12 | 0.44 | 10.57 | C |

TABLE 30
Determination of Charpy impact resistance of
unnotched test specimens of the PK3-B5 type

| Test | Test specimen in | | Impact | |
|---|---|---|---|---|
| specimen | individual | E_{c} | resistance | Type of |
| type | measurement | [J] | [kJ/m²] | failure |
| PK3-B5 | PK3-B12-01 | 0.18 | 4.37 | C |
| | PK3-B12-02 | 0.20 | 4.79 | C |
| | PK3-B12-03 | 0.20 | 4.93 | C |
| | PK3-B12-04 | 0.19 | 4.65 | C |
| | PK3-B12-05 | 0.19 | 4.51 | C |
| | PK3-B12-06 | 0.18 | 4.37 | C |
| | PK3-B12-07 | 0.20 | 4.79 | C |
| | PK3-B12-08 | 0.20 | 4.79 | C |
| | PK3-B12-09 | 0.21 | 5.08 | C |
| | PK3-B12-10 | 0.20 | 4.79 | C |
| | PK3-B12-11 | 0.20 | 4.79 | C |

TABLE 31
Determination of Charpy impact resistance of
unnotched test specimens of the PK4-B5 type

| Test | Test specimen in | | Impact | |
|---|---|---|---|---|
| specimen | individual | E_{c} | resistance | Type of |
| type | measurement | [J] | [kJ/m²] | failure |
| PK4-B5 | PK4-B12-01 | 0.20 | 4.80 | C |
| | PK4-B12-02 | 0.21 | 5.09 | C |
| | PK4-B12-03 | 0.20 | 4.80 | C |
| | PK4-B12-04 | 0.13 | 3.10 | C |
| | PK4-B12-05 | 0.15 | 3.52 | C |
| | PK4-B12-06 | 0.19 | 4.52 | C |
| | PK4-B12-07 | 0.14 | 3.38 | C |
| | PK4-B12-08 | 0.19 | 4.52 | C |
| | PK4-B12-09 | 0.19 | 4.52 | C |
| | PK4-B12-10 | 0.19 | 4.66 | C |
| | PK4-B12-11 | 0.19 | 4.52 | C |
| | PK4-B12-12 | 0.13 | 3.10 | C |

TABLE 32
Determination of Charpy impact resistance of unnotched
comparative test specimens of the VPK1-B5 type

| | Comparative test | | | |
|---|---|---|---|---|
| | specimen in | | Impact | |
| Comparative test | individual | E_{c} | resistance | Type of |
| specimen type | measurement | [J] | [kJ/m²] | failure |
| VPK1-B5 | VPK1-B12-01 | 0.79 | 18.97 | C |
| | VPK1-B12-02 | 0.72 | 17.38 | C |
| | VPK1-B12-03 | 0.75 | 18.10 | C |
| | VPK1-B12-04 | 0.76 | 18.39 | C |
| | VPK1-B12-05 | 0.85 | 20.42 | C |
| | VPK1-B12-06 | 0.71 | 17.09 | C |
| | VPK1-B12-07 | 0.78 | 18.68 | C |
| | VPK1-B12-08 | 0.81 | 19.55 | C |
| | VPK1-B12-09 | 0.75 | 17.96 | C |
| | VPK1-B12-10 | 0.82 | 19.70 | C |
| | VPK1-B12-11 | 0.73 | 17.67 | C |

TABLE 33
Determination of Charpy impact resistance of unnotched
comparative test specimens of the VPK2-B5 type

| | Comparative test | | | |
|---|---|---|---|---|
| | specimen in | | Impact | |
| Comparative test | individual | E_{c} | resistance | Type of |
| specimen type | measurement | [J] | [kJ/m²] | failure |
| VPK2-B5 | VPK2-B12-01 | 0.59 | 14.18 | C |
| | VPK2-B12-02 | 0.64 | 15.47 | C |
| | VPK2-B12-03 | 0.68 | 16.48 | C |
| | VPK2-B12-04 | 0.67 | 16.05 | C |
| | VPK2-B12-05 | 0.64 | 15.33 | C |
| | VPK2-B12-06 | 0.64 | 15.33 | C |
| | VPK2-B12-07 | 0.67 | 16.20 | C |
| | VPK2-B12-08 | 0.63 | 15.18 | C |
| | VPK2-B12-09 | 0.65 | 15.62 | C |
| | VPK2-B12-10 | 0.70 | 16.77 | C |
| | VPK2-B12-11 | 0.64 | 15.47 | C |
| | VPK2-B12-12 | 0.62 | 14.90 | C |

TABLE 34
Determination of Charpy impact resistance of unnotched
comparative test specimens of VPK3-B5 type

| | Comparative test | | | |
|---|---|---|---|---|
| | specimen in | | Impact | |
| Comparative test | individual | E_{c} | resistance | Type of |
| specimen type | measurement | [J] | [kJ/m²] | failure |
| VPK3-B5 | VPK3-B12-01 | 0.67 | 16.27 | C |
| | VPK3-B12-02 | 0.58 | 13.95 | C |
| | VPK3-B12-03 | 0.61 | 14.82 | C |
| | VPK3-B12-04 | 0.65 | 15.69 | C |
| | VPK3-B12-05 | 0.67 | 16.12 | C |
| | VPK3-B12-06 | 0.63 | 15.25 | C |
| | VPK3-B12-07 | 0.59 | 14.24 | C |
| | VPK3-B12-08 | 0.67 | 16.27 | C |
| | VPK3-B12-09 | 0.64 | 15.54 | C |
| | VPK3-B12-10 | 0.66 | 15.98 | C |
| | VPK3-B12-11 | 0.64 | 15.54 | C |

### EXAMPLE B13: AEROBIC QUANTITATIVE DISINTEGRATION TEST IN COMPOST AT ROOM TEMPERATURE

The purpose of this test was to evaluate the disintegration of a material at ambient temperature in a 80/20 mixture of <10 mm of ripe compost and freshly ground vegetable, garden and fruit waste (VGF). In domestic composting, the high temperatures (>50° C.) that are attained by industrial composting processes are usually not attained. Therefore, a material must have sufficient digestion at room temperature before it can be approved for home composting.

### Subject of the Test

Test plaques of the TESTPLATTE9-B5 type (see example B5A above)
Thickness: 0.40 mm±0.02 mm
Length and width: 2.5 cm each
Basis weight: 519 g/m²±14 g/m²

Storage conditions: room temperature in the dark

### Procedure/Standards Followed

The test was conducted in accordance with ISO 20200 Plastics—Determination of the degree of disintegration of plastic materials under simulated composting conditions in a laboratory-scale test (2015), with the following variances compared to ISO 20200 (2015):
The subject of the test is neither dried nor soaked in distilled water prior to commencement.
Incubation at 28° C.±2° C. to simulate the conditions of domestic composting;
Rather than 1 kg of synthetic solid waste per reactor, a mixture of 1 kg of the <10 mm fraction of mature compost and VGF per reactor was used;
Once per week, the decomposition was visually monitored and the humidity conditions were assessed and adjusted as needed, rather than the monitoring process stipulated by ISO 20200 (2015).
The compost is not dried before screening. The dry matter of the cleaned sample is determined.

The changes stipulated in the following standard specifications are taken into account:
AS 5810 Biodegradable plastics—Biodegradable plastics suitable for home composting (2010);
NF T 51-800 Plastics—Specifications for plastics suitable for home composting (2015).

### Analytical Methods:

Total solids content: Total solids content was determined by drying at 105° C. for at least 14 hours and weighing. Total solids content is expressed as a percentage of the wet weight.

Basis weight: After an acclimatization time of 24 hours at 30% relative humidity and 24 hours at 23° C. and 50% relative humidity (ISO 187), the determination of basis weight was conducted in accordance with ISO 536 Paper and board—determination of grammage (2019). Round pieces were cut with an automatic cutting machine and weighed with an analytical balance.

pH: pH was measured with a commercially available pH meter after calibration with standard buffer solutions (pH=4.00, pH=7.00 and pH=10.00). Before inserting the electrode, the sample was diluted with distilled water in a ratio of 5:1 (5 parts demineralized water versus 1 part sample) and mixed thoroughly.

Thickness: After an acclimatization time of 24 hours at 23° C. and 50% relative humidity, 10 points were measured on the test specimen. The measurement was conducted with a universal table micrometer (accuracy of 0.1 μm) in accordance with ISO 534 Paper and board—determination of thickness, density and specific volume (2011).

Total nitrogen: The determination of total nitrogen after dry combustion was conducted by the Dumas method. The sample was weighed out in tin foil. Depending on the matrix, the sample was first dried and/or (cryogenically) ground. The tin foil containing the sample was burnt in a high-temperature furnace at 980° C. with addition of pure oxygen (O2). The resulting gas mixture, consisting of water, carbon dioxide, nitrogen oxides and nitrogen, was conducted onward by a helium carrier gas. The nitrogen oxides were reduced at a copper surface to elemental nitrogen, and the water and carbon dioxide were separated off. During the analysis, the carrier gas passed through the entire system and was continuously measured with a thermal conductivity detector (TCD). At the end of the analysis, however, the TCD measures a mixture of carrier gas and N₂. This difference in gas composition produces a measurable difference in voltage for the TCD, which was then used to calculate the nitrogen content of the sample.

Volatile solids/ash: The volatile solids and ash content was determined by heating the dried sample at 550° C. for at least 4 hours and weighing. The results are reported as a percentage of the dry matter.

Determination of weight: Two types of balance were used during the test: A Sartorius AC 210 S with internal calibration (max. 200 g; d=0.1 mg) for the determination of dry matter and volatile components. A Sartorius CPA 12001 S (max. 12 100 g, d=0.1 g) is used for the weighing of the test specimen and the various components of the inoculum.

### Test Setup

Three reactors with dimensions of 30 cm×20 cm×13 cm (L, B, H) were used for quantitative evaluation of the disintegration of Otura® Homecompostable oat fiber compound. The reactors contained an 80/20 mixture of <10 mm of ripe compost and freshly ground vegetable, garden and fruit waste (VGF) and 1.0% by weight test plaques (subject of the test, as defined above).

The ripe compost was a mixture of ripe VGF (vegetable, garden and fruit waste) and green compost. The VGF compost was obtained from the organic fraction of municipal solid waste and further stabilized and aerated in a pilot composting plant in the laboratory under controlled conditions to obtain a fully mature compost. The age of the VGF compost was 18 weeks. The green compost was obtained from garden waste, tree pruning, tree roots and tree stumps and stabilized on a large scale in a composting plant. The compost was mixed in a ratio of 50% VGF compost and 50% green compost.

For determination and quantitative evaluation of the digestion of the test specimen, the 1.0% test specimen concentration was used. The exact test setup of the quantitative test is shown in table 35.

TABLE 35
Test setup

Reactor number

| Composition | Reactor 1 | Reactor 2 | Reactor 3 |
|---|---|---|---|
| Ripe compost [g] | 800.0 | 800.0 | 800.0 |
| Freshly ground | 200.0 | 200.0 | 200.0 |
| vegetable, garden and | | | |
| fruit waste [g] | | | |
| Test plaques | 10.0 | 10.0 | 10.0 |
| (subject of the test) | | | |
| Total amount of | 1010.0 | 1010.0 | 1010.0 |
| reactor contents [g] | | | |
| Proportion of test | 1.0 | 1.0 | 1.0 |
| plaques (subject of | | | |
| the test) in the | | | |
| inoculum [w/w %] | | | |

### Biowaste Analyses

The features of the inoculum are listed in table 36. The inoculum was characterized by an optimal C/N ratio and an optimal moisture content.

TABLE 36
Inoculum features

| Feature | Inoculum |
|---|---|
| Total solids content [%] | 47.3 |
| Moisture content [%] | 52.7 |
| Volatile solids [% of total solids] | 44.7 |
| Ash [% of total solids] | 55.3 |
| Total nitrogen [g/kg of total solids] | 21.2 |
| C/N | 11 |
| pH | 6.9 |

### Visual Perceptions

During the composting process, the contents of the reactors were mixed weekly and water was added as needed to ensure optimum moisture conditions. The disintegration of the test plaques (subject of the tests) was carefully examined during the test.

The breakdown of the test plaques (subject of the tests) took place very quickly during the test. Even after an incubation period of 1 week at room temperature, some test plaques (subject of the tests) began to break down into pieces of different size, while most of the test plaques (subject of the tests) were still fully intact. In the subsequent week, there was a distinct decrease in the size and presence of the test material in the composting reactors. After composting for two weeks, only a few small pieces of the test plaques (subject of the tests) could be removed from the composting reactors. It was found that the remaining pieces were fragile. The decay progressed, and after composting for just 3.0 weeks (=end of the test) all parts of the test material had disappeared completely, and no parts of the test material could be taken from the composting reactors. Since Otura® achieved complete disintegration in the test plaques examined (subject of the tests), the test was ended after composting for 3.0 weeks rather than the maximum test duration of 180 days.

### Screening—Digestion

At the end of the experiment (after 3.0 weeks), the contents of each reactor were screened with a vibrating screen above 2 mm in order to obtain the non-disintegrated residues of the test material in the >2 mm fraction. In the 3 repetitions, there was no test material in the >2 mm fraction. This corresponds to an average degree of disintegration of 100.0% for the test plaques examined (subject of the tests). The degree of comminution of the three repetitions did not differ by more than 20%, and so the validity requirement of ISO 20200 (2015) is met.

The French standard NF T51-800 Plastics—Specifications for plastics suitable for home composting (2015) and the Australian standard AS 5810 Biodegradable plastics—Biodegradable plastics suitable for home composting (2010) stipulate that a material has shown sufficient disintegration for home composting if, after 180 days of composting, at least 90% of the test material has been reduced to a size of <2 mm in a quantitative test in accordance with ISO 20200 (2015) at ambient temperature (20° C.-30° C.).

Since complete disintegration was achieved after 3.0 weeks for the test plaques examined (subject of the tests), it can be concluded that the 90% disintegration criterion according to NF T51-800 (2015) and AS 5810 (2010) has been achieved.

### Chemical Analyses

Table 37 shows the results of the chemical analyses at the end of the test. A comparable volatile solids content was measured for the different repeats, and normal pH values were found. The C/N ratio of the various repetitions varied between 7 and 8.

TABLE 37
Chemical analysis of the reactor contents after the end of the test

Reactor number

| Composition | Reactor 1 | Reactor 2 | Reactor 3 |
|---|---|---|---|
| Total solids content | 63.2 | 59.5 | 61.7 |
| [%] | | | |
| Moisture content | 36.8 | 40.35 | 38.3 |
| [%] | | | |
| Volatile solids [% of | 44.8 | 46.1 | 42.0 |
| total solids] | | | |
| Ash [% of total | 55.2 | 53.9 | 58.0 |
| solids] | | | |
| Total nitrogen [g/kg | 26.9 | 29.1 | 28.2 |
| of total solids] | | | |
| C/N | 8 | 8 | 7 |
| pH | 7.7 | 7.8 | 7.8 |

### EXAMPLE 14: FURTHER COMPOSTING STUDIES

The procedure in example 13 above, the aerobic quantitative disintegration in compost at room temperature of test plaques (subject of the tests) of the TESTPLATTE1-B5 type (see example B5 above) was examined (thickness: 0.40 mm±0.02 mm; length and width: 2.5 cm each; basis weight: 799 g/m²±14 g/m²). The result showed that the test plaques are compostable.

1. An oat composite article comprising:
polymer material; and
oat fibers,
wherein the oat composite article is compostable.

2. The oat composite article as claimed in claim 1, wherein the oat composite article is industrially compostable and/or home-compostable and/or wherein the oat composite article is recyclable.

3. The oat composite article of claim 1, wherein the polymer material is selected from the group consisting of:
polyhydroxyalkanoate,
polybutylene succinate,
polybutylene succinate-co-adipate,
natural resins,
starch,
cellulose with a lignin content of less than 5% by weight,
polybutylene adipate terephthalate,
polycaprolactone,
polylactides,
cellulose acetate,
waxes, and
mixtures thereof.

4. The oat composite article of claim 1,
wherein the oat fibers present in the oat composite article have a proportion of lignocellulose in the range from 60% by weight to 90% by weight, based in each case on the dry matter of the oat fibers present in the oat composite article, and/or
wherein the oat fibers present in the oat composite article have a proportion of lignin in the range from 10% by weight to 30% by weight based in each case on the dry matter of the oat fibers present in the oat composite article, and/or
wherein the oat fibers present in the oat composite article have a proportion of hemicellulose in the range from 20% by weight to 40% by weight based in each case on the dry matter of the oat fibers present in the oat composite article, and/or
wherein the hemicellulose present in the oat composite article has a proportion of xylose in the range from 15% by weight to 31% by weight, preferably in the range from 27.3% by weight to 28.9% by weight, based in each case on the dry matter of the hemicellulose present in the oat composite article, and/or
wherein the hemicellulose present in the oat composite article has a proportion of arabinose in the range from 2.6% by weight to 4.0% by weight based in each case on the dry matter of the hemicellulose present in the oat composite article, and/or
wherein the hemicellulose present in the oat composite article has a ratio of arabinose to xylose in the range from 0.05 to 0.5, and/or
wherein the hemicellulose present in the oat composite article has a proportion of mannose of less than 0.03% by weight, based in each case on the dry matter of the hemicellulose present in the oat composite article, and/or
wherein the oat fibers present in the oat composite article have a proportion of p-hydroxybenzaldehyde in the range from 50 μg·g⁻¹ to 250 μg·g⁻¹, based in each case on the dry matter of the oat fibers present in the oat composite article, and/or
wherein the oat fibers present in the oat composite article have a proportion of ferulic acid in the range from 1000 μg·g⁻¹ to 3000 μg·g⁻¹, based in each case on the dry matter of the oat fibers present in the oat composite article, and/or
wherein the oat fibers present in the oat composite article have a proportion of proteins of less than 3% by weight, based in each case on the dry matter of the oat fibers present in the oat composite article, and/or
wherein the oat fibers present in the oat composite article have a proportion of lipids of less than 2% by weight, based in each case on the dry matter of the oat fibers present in the oat composite article.

5. The oat composite article of claim 1,
wherein the oat fibers present in the oat composite article have a number-weighted average length in the range from 100 μm to 300 μm and/or
wherein the oat fibers present in the oat composite article have a number-weighted average thickness in the range from 30 μm to 200 μm, and/or
wherein the oat fibers present in the oat composite article have a number-weighted average convexity in the range from 0.6 to 0.95, and/or
wherein the oat fibers present in the oat composite article have a number-weighted average form factor in the range from 1.0 to 1.5, and/or
wherein the oat fibers present in the oat composite article have a number-weighted average Feret aspect ratio in the range from 0.3 to 0.7.

6. The oat composite article of claim 1,
wherein the proportion of oat fibers in the oat composite article is in the range from 5% by weight to 45% by weight based in each case on the total mass of the oat composite article.

7. The oat composite article of claim 1, additionally comprising one, two, three or more substances based on the total mass of the oat composite article.

8. The oat composite article of claim 1;
wherein the oat composite article has a melt mass flow rate, determined in accordance with ISO 1133-2 using method B and using parameters of 190° C. and 5 kg, in the range from 15 g/10 min to 25 g/10 min, and/or
wherein the oat composite article has a melt volume flow rate, determined in accordance with ISO 1133-2 using method B and using parameters of 190° C. and 5 kg, in the range from 10 cm³/10 min to 105 cm³/10 min, and/or
wherein the oat composite article has a density, determined by method A of DIN EN ISO 1183-1, in the range from 1.2 g·cm⁻³ to 1.5 g·cm⁻³, and/or
wherein the oat composite article has a flexural modulus of elasticity, determined by method A of DIN EN ISO 178:2019 with an initial force of 0.1 MPa and a test speed of 2 mm/min, in the range from 1500 MPa to 5000 MPa, and/or
wherein the oat composite article has a tensile strength, determined in accordance with DIN EN ISO 527-2, in the range from 15 MPa to 30 MPa, and/or
wherein the oat composite article has a tensile elongation, determined in accordance with DIN EN ISO 527-2, in the range from 0.7% to 3.0%, and/or
wherein the oat composite article has a flexural stress under conventional deflection, determined by method A of DIN EN ISO 178, with an initial force of 0.1 MPa and a test speed of 2 mm/min, in the range from 30 MPa to 40 MPa, and/or
wherein the oat composite article has a flexural strain at flexural strength, determined by method A of DIN EN ISO 178, with an initial force of 0.1 MPa and a test speed of 2 mm/min, in the range from 0.5% to 6%, and/or
wherein the oat composite article has a Charpy impact resistance of the unnotched test specimen, determined in accordance with DIN EN ISO 179-1:2010 by the method of ISO 179-1/1eU, in the range from 4 kJ·m⁻² to 20 kJ·m⁻².

9. The oat composite article of claim 1, wherein
the oat composite article has an intrinsic odor of roasted aromas.

10. The oat composite article of claim 1 wherein
the oat composite article complies with the requirements of Commission Regulation (EU) No 10/2011 of 14 Jan. 2011 on plastic materials and articles intended to come into contact with food.

11. The oat composite article of claim 1, wherein the oat composite article is storable without mold formation at temperatures in the range between 0° C. and 25° C. and at additionally defined humidity in the range from 0% to 10% relative humidity over a period of at least 12 months.

12-14. (canceled)

15. A process for producing an oat composite article selected from the group consisting of:
oat composite,
pelletized oat composite,
dried pelletized oat composite, and
oat composite molding,
comprising the following steps for production of the article:
producing or providing,
a polymer material, and, spatially separately therefrom,
oat fibers,
melting the polymer material produced or provided so as to result in a molten polymer material, and
compounding the molten polymer material with at least the oat fibers produced or provided in a predetermined quantitative ratio so as to result in the oat composite.

16. The process of claim 15 for production of an article selected from the group consisting of:
pelletized oat composite,
dried pelletized oat composite, and
oat composite molding,
comprising the following steps for production of the article:
producing an oat composite,
pelletizing the oat composite so as to result in pelletized oat composite.

17. The process of claim 16 for production of an article selected from the group consisting of:
dried pelletized oat composite, and
oat composite molding,
comprising the following steps for production of the article:
producing a pelletized oat composite,
drying the pelletized oat composite so as to result in dried pelletized oat composite.

18. The process of claim 16 for production of an oat composite molding, comprising the following steps for production of the article:
producing a pelletized oat composite by a process,
melting the pelletized oat composite so as to result in molten oat composite, and
injection molding the molten oat composite so as to result in an oat composite molding.

19. The process of claim 15, wherein
the compounding is effected within a temperature range from 180° C. to 230° C., and/or
wherein the polymer material is selected from the group consisting of:
polyhydroxyalkanoate,
polybutylene succinate,
polybutylene succinate-co-adipate,
natural resins,
starch,
cellulose with a lignin content of less than 5% by weight,
polybutylene adipate terephthalate,
polycaprolactone,
polylactides,
cellulose acetate,
waxes, and
mixtures thereof.

20. The process of claim 18 for production of an oat composite molding, wherein
the melting and processing in the injection molding operation continues until immediately prior to contact with a casting mold and/or a water bath within a temperature range from 80° C. to 230° C., and/or
the casting mold in the injection molding operation immediately prior to contact with the molten oat composite is at a temperature in the range from 15° C. to 50° C.

21. The process of claim 15 for production of an oat composite article, comprising the following steps:
providing oat hulls and/or oat husks;
cleaning the oat hulls and/or oat husks so as to result in cleaned oat hulls and/or cleaned oat husks;
drying the cleaned oat hulls and/or the cleaned oat husks so as to result in dried cleaned oat hulls and/or dried cleaned oat husks;
grinding the dried cleaned oat hulls and/or dried cleaned oat husks so as to result in ground oat hulls and/or ground oat husks; and
screening the ground oat hulls and/or the ground oat husks so as to result in oat fibers and a residue on the screen.

22. The process for producing an oat composite article of claim 21, wherein
the oat hulls and/or oat husks are cleaned at least in part by boiling in water at 100° C., followed by squeezing, and/or
wherein the drying is conducted in the form of an indirect drying operation, preferably in the form of an indirect drying operation on a belt dryer or in a drying cabinet, and/or
wherein the drying is conducted in such a way that the resulting dried cleaned oat hulls and/or dried cleaned oat husks have a water content of less than 7% by weight, and/or
wherein the dried cleaned oat hulls and/or dried cleaned oat husks used in the grinding operation have a water content at the start of grinding of less than 7% by weight and/or
wherein the grinding is conducted with an impact disk mill, and/or
wherein, in the screening of the ground oat hulls and/or the ground oat husks, a screen with a mesh size of 300 micrometers or less.

23. The process for producing an oat composite article of claim 15, wherein:
the compounding is effected exclusively between the polymer material and the oat fibers without addition of any further substances, such that the resulting oat composite consists exclusively of the polymer material produced or provided and the oat fibers produced or provided, or
in addition to the oat fibers produced or provided, further substances are added to the molten polymer material as additive, and these are also present in the course of subsequent compounding.

24. The process for producing an oat composite article of claim 15, wherein:
the compounding is effected exclusively between the polymer material and the oat fibers without addition of any further substances, such that the resulting oat composite consists exclusively of the polymer material produced or provided and the oat fibers produced or provided, and
in the compounding of the molten polymer material with the oat fibers produced or provided in a predetermined quantitative ratio so as to result in the oat composite,
the predetermined quantitative ratio is selected such that it corresponds to a proportion of oat fibers of 5% by weight to 45% by weight, based in each case on the combined total mass of the molten polymer material used in the compounding operation and the oat fibers used in the compounding operation.

25. The process of claim 15, wherein:
in addition to the oat fibers produced or provided, one, two, three or more further substances are added to the molten polymer material as additive, and these are also present in the course of subsequent compounding,
in the compounding of the molten polymer material with at least the oat fibers produced or provided in a predetermined quantitative ratio so as to result in the oat composite, the predetermined quantitative ratio is selected such that it corresponds to a proportion of oat fibers of 5% by weight to 45% by weight, based in each case on the combined total mass of the molten polymer material used in the compounding operation and the oat fibers used in the compounding operation.

26. The process of claim 15, wherein the polymer material used for production of an oat composite article has
a density determined by method A of ISO 1183-1 in the range from 1 g·cm³ to 2 g·cm³, and/or
a melt mass flow rate, determined in accordance with ISO 1133-2 using method B and using parameters of 190° C. and 5 kg, in the range from 2 g/10 min to 50 g/10 min, and/or
a melting point, determined in accordance with ISO 3146, in the range from 70° C. to 140° C.

27. The process of claim 15,
wherein the oat fibers used for production of the oat composite article have a proportion of lignocellulose in the range from 60% by weight to 90% by weight, based in each case on the dry matter of the oat fibers used, and/or
wherein the oat fibers used for production of the oat composite article have a proportion of lignin in the range from 10% by weight to 30% by weight, based in each case on the dry matter of the oat fibers used, and/or
wherein the oat fibers used for production of the oat composite article have a proportion of hemicellulose in the range from 20% by weight to 40% by weight, based in each case on the dry matter of the oat fibers used, and/or
wherein the hemicellulose in the oat fibers used for production of the oat composite article has a proportion of xylose in the range from 15% by weight to 31% by weight, based in each case on the dry matter of the hemicellulose present in the oat fibers used, and/or
wherein the hemicellulose in the oat fibers used for production of the oat composite article has a proportion of arabinose in the range from 2.6% by weight to 4.0% by weight, based in each case on the dry matter of the hemicellulose present in the oat fibers used, and/or
wherein the ratio of arabinose to xylose in the hemicellulose in the oat fibers used for production of the oat composite article is in the range from 0.05 to 0.5, and/or
wherein the hemicellulose in the oat fibers used for production of the oat composite article has a proportion of mannose of less than 0.03% by weight, based in each case on the dry matter of the hemicellulose present in the oat fibers used, and/or
wherein the oat fibers used for production of the oat composite article have a proportion of p-hydroxybenzaldehyde in the range from 50 μg·g⁻¹ to 250 μg·g⁻¹, based in each case on the dry matter of the oat fibers used, and/or
wherein the oat fibers used for production of the oat composite article have a proportion of ferulic acid in the range from 1000 μg·g⁻¹ to 3000 μg·g⁻¹, based in each case on the dry matter of the oat fibers used, and/or
wherein the oat fibers used for production of the oat composite article have a proportion of proteins of less than 3% by weight, based in each case on the dry matter of the oat fibers used, and/or
wherein the oat fibers used for production of the oat composite article have a proportion of lipids of less than 2% by weight based in each case on the dry matter of the oat fibers used.

28. The process of claim 15,
wherein the oat fibers used for production of the oat composite article have a number-weighted average length in the range from 100 μm to 300 μm, and/or
wherein the oat fibers used for production of the oat composite article have a number-weighted average thickness in the range from 30 μm to 200 μm, and/or
wherein the oat fibers used for production of the oat composite article have a number-weighted average convexity in the range from 0.6 to 0.95, and/or
wherein the oat fibers used for production of the oat composite article have a number-weighted average form factor in the range from 1.0 to 1.5, and/or
wherein the oat fibers used for production of the oat composite article have a number-weighted average Feret aspect ratio in the range from 0.3 to 0.7.

29. A kit for production of an oat composite article, at least comprising, in the form of spatially separate components:
a polymer material,
oat fibers.
